(19) United States
(12) Patent Application Publication
(10) Pub. No.: US 2021/0238470 A1
(43) Pub. Date: Aug. 5, 2021

(54) ALKOXYLATE EMULSIONS

(71) Applicants: BOARD OF REGENTS, THE UNIVERSITY OF TEXAS SYSTEM, Austin, TX (US); HARCROS CHEMICALS, INC., Kansas City, KS (US)

(72) Inventors: Upali WEERASOORIYA, Austin, TX (US); Kishore K. MOHANTY, Austin, TX (US); Krishna PANTHI, Cedar Park, TX (US); Himanshu SHARMA, Austin, TX (US); Pinaki GHOSH, Austin, TX (US); Ryosuke OKUNO, Austin, TX (US); Kwang Hoon BAEK, Austin, TX (US); Gayan Aruna ABEYKOON, Austin, TX (US)

(21) Appl. No.: 17/045,031

(22) PCT Filed: Apr. 4, 2019
(86) PCT No.: PCT/US2019/025873

§ 371 Date: Oct. 2, 2020

Related U.S. Application Data
(60) Provisional application No. 62/732,234, filed on Sep. 17, 2018.
(60) Provisional application No. 62/659,238, filed on Apr. 18, 2018.
(60) Provisional application No. 62/652,600, filed on Apr. 4, 2018.

(51) Int. Cl. C09K 8/584; E21B 43/16; C09K 8/26

(52) U.S. Cl. CPC C09K 8/584; C09K 8/26; E21B 43/16

(57) ABSTRACT

Provided herein are compounds, compositions, and methods having application in the field of enhanced oil recovery (EOR). In particular, the compounds, compositions, and methods provided can be used for the recovery of a large range of crude oil compositions from challenging reservoirs.

### CROSS-REFERENCE TO RELATED APPLICATIONS

This application claims the benefit of U.S. Provisional Application No. 62/652,600, filed Apr. 4, 2018, U.S. Provisional Application No. 62/659,238, filed Apr. 18, 2018, and U.S. Provisional Application No. 62/732,234, filed Sep. 17, 2018, each of which is hereby incorporated by reference in its entirety.

### FIELD

This application relates to alkoxylate emulsions, particularly alkoxylate emulsions for use in recovery of a hydrocarbon material.

### BACKGROUND

Enhanced Oil Recovery (EOR) refers to techniques for increasing the amount of unrefined petroleum, or crude oil that may be extracted from an oil reservoir (e.g., an oil field). Using EOR, 40-60% of the reservoir's original oil can typically be extracted compared with only 20-40% using primary and secondary recovery (e.g., by water injection or natural gas injection). Enhanced oil recovery may also be referred to as improved oil recovery or tertiary oil recovery (as opposed to primary and secondary oil recovery).

Enhanced oil recovery may be achieved by a variety of methods including miscible gas injection (which includes carbon dioxide flooding), chemical injection (which includes polymer flooding, alkaline flooding, and surfactant flooding), microbial injection, or thermal recovery (which includes cyclic steam, steam flooding, and fire flooding). The injection of various chemicals, usually as dilute aqueous solutions, has been used to improve oil recovery. Injection of alkaline or caustic solutions into reservoirs with oil that has organic acids naturally occurring in the oil (also referred to herein as “unrefined petroleum acids”) will result in the production of soap that may lower the interfacial tension enough to increase production. Injection of a dilute solution of a water-soluble polymer to increase the viscosity of the injected water can increase the amount of oil recovered from geological formations. Aqueous solutions of surfactants such as petroleum sulfonates may be injected to lower the interfacial tension or capillary pressure that impedes oil droplets from moving through a reservoir. Special formulations of oil, water and surfactant microemulsions have also proven useful. Such formulations often include cosolvent compounds to increase the solubility of the solutes in the presence of oil and decrease the viscosity of an emulsion. However, cosolvents typically have the undesirable consequence of also increasing interfacial tension. Further, application of these methods is usually limited by the cost of the chemicals and their adsorption and loss onto the rock of the oil containing formation.

Therefore, there is a need in the art for cost effective methods for enhanced oil recovery using chemical injection. Provided herein are methods and compositions addressing these and other needs in the art.

### SUMMARY

Provided herein are compounds and compositions having application in the field of enhanced oil recovery (EOR). In particular, the compounds and compositions provided can be used for the recovery of a large range of a hydrocarbon material in contact with a solid material, converting a hydrocarbon material into a surfactant, reducing the viscosity of a hydrocarbon material, or transporting a hydrocarbon material.

For example, provided herein are aqueous compositions comprising a compound defined by Formula I

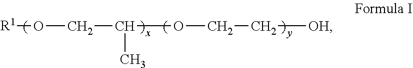

wherein R¹ is C₄-C₁₀ alkyl, preferably unsubstituted C₆-C₁₀ alkyl or unsubstituted phenyl; x is an integer from 2 to 10; y is an integer from 3 to 60 or from 3 to 40. In some embodiments, R¹ can be 2-ethylhexyl, butyl, or isobutyl; x can be an integer from 2 to 10 (e.g., from 2 to 5, or from 2 to 4); and y can be an integer from 3 to 60 or from 3 to 40 (e.g., from 3 to 8, or from 3 to 6). In some embodiments, R¹ can be unsubstituted phenyl; x can be an integer from 2 to 10 (e.g., from 2 to 8, or from 4 to 4); and y can be an integer from 3 to 60 or from 3 to 40 (e.g., from 5 to 40, from 5 to 30, or from 5 to 20).

In some embodiments, y and x are in a ratio of greater than 1:1, such as from 1.1:1 to 30:1, from 1.1:1 to 20:1, from 1.2:1 to 10:1, or from 1.5:1 to 5:1. In some embodiments, the sum of x and y (x+y) is from 5 to 70, from 5 to 50, or from 5 to 30, or from 5 to 25.

Also provided are aqueous composition comprising a compound defined by Formula II

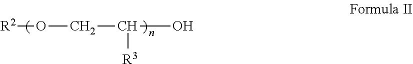

wherein R² is a substituted or unsubstituted C₄-C₂₀ polyalkylamine, R³, for each occurrence, is independently hydrogen or methyl; and n is an integer from 2 to 30 or from 2 to 60.

In some embodiments, the compound can be defined by Formula IIa

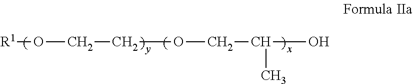

wherein R² is a substituted or unsubstituted C₄-C₂₀ polyalkylamine; x is an integer from 2 to 20; y is an integer from 0 to 15; and wherein x is greater than y.

In some embodiments, R² can be an unsubstituted C₄-C₁₆ polyalkylamine (e.g., a C₄-C₁₆ polyalkylenediamine, a C₄-C₁₆ polyalkylenetriamine, a C₄-C₁₆ polyalkylenetetramine, or a C₄-C₁₆ polyalkylenepentamine). In certain embodiments, R² can be diisopropylamine, di-ethylenetriamine, tri-ethylenetetramine, tetra-ethylenepentamine, di-propylenetriamine, tri-propylenetetramine, or tetra-propylenepentamine.

Also provided are emulsion compositions comprising a hydrocarbon material and an aqueous composition described herein.

### DESCRIPTION OF DRAWINGS

FIG. 1 is a graph showing polymer solution viscosity at 368 K. 0.22 wt % Flopaam 3630S was used for polymer flooding and surface active agent-improved polymer flooding. The target viscosity of polymer solution was about 70 cp at an estimated shear rate for the injection rate.

FIG. 2 are images showing emulsion phase behavior with new surface active agents at 368 K. Phenol-4PO-20EO and Phenol-7PO-30EO resulted in desired o/w emulsions.

FIG. 3 is a graph showing CMC (critical micelle concentration) of phenol-4PO-20EO. The IFT was measured by the pendant drop method.

FIG. 4 is an image showing schematic of the experimental set-up for oil displacements.

FIG. 5 is a graph showing oil displacement results: the cumulative oil recovery after 2 PVI was 30% for water flooding, 62% for polymer flooding and 84% for surface active agent-improved polymer flooding.

FIG. 6 show images of emulsion phase behavior of phenol compounds with bitumen.

FIG. 7 show images of emulsion phase behavior of bitumen compositions comprising CaCl₂ and phenol compounds.

FIG. 8 is a bar graph showing bulk foam study of a blend of 0.5% C₁₄₋₁₆-AOS and CH₃O-60PO-20EO-SO₃Na at 60° C.

FIG. 9 is a graph showing emulsion phase behavior with two component surfactant blend comprising 0.5% CH₃O-21PO-10EO-SO₃ and 0.5% C₁₉₋₂₃-IOS at 30% oil and 40° C.

FIG. 10 shows a core flood study of a blend of 0.5% C₁₉-C₂₃ IOS and 0.5% CH₃O-21PO-10EO-SCb prepared and mixed with SP core flood.

FIGS. 11A-11C shows GC-MS analysis of hydrocarbon fraction of surfactants or surfactant blends in brine and hydrocarbon blend at ambient temperature. The surfactants tested included C₁₃-7PO-SO⁻₃ (TDA), CH₃O-21PO-10EO-SO⁻₃ (MeO), and TDA+MeO in a 1:1 blend. The hydrocarbon blend composition comprised pf C₅, C₆, C₇, C₈, C₁₀, C₁₂, C₁₄ equimolar composition.

FIGS. 12A-12B shows aqueous stability and phase behavior of a three component surfactant blend in hard brine at 80° C. FIG. 12A shows the aqueous stability of 0.5% C₁₅-C₁₈ IOS, 0.5% C₂₈-45PO-30EO-COO⁻ in sea water/formation brine. FIG. 12B shows the aqueous stability of 0.5% C₁₅-C₁₈ IOS, 0.33% C₂₈-45PO-30EO-COO⁻, and 0.17% 2EH-40PO-40EO-COO⁻ in sea water/formation brine.

FIG. 13 shows stability formulations with hard brine. Formulation at 80° C. includes 0.3% C₁₅-C₁₈IOS, 0.2% C₁₉-C₂₃IOS, 0.5% IBA-2EO, 0.5% C₁₈-35PO-30EO-SO₄ in brine (500 ppm Ca²⁺, 1250 ppm Mg²⁺, 58000 TDS. Formulation at 100° C. includes 0.5% C₁₉-C₂₃ IOS, 0.5% TDA-45PO-20EO-SO₄, 0.5% Phenol-2EO in brine (500 ppm Ca²⁺, 1250 ppm Mg²⁺, 28000 TDS.

FIG. 14 shows aqueous stability with blends of surfactants.

FIG. 15 shows hardness tolerance results for different blends of surfactants.

FIG. 16 shows surface tension results for CH3-60PO-15EO-SO4, C20-24 IOS and the blend of two surfactants.

FIG. 17 shows bulk foam stability results.

FIG. 18 shows surfactant phase behavior results using the blend of CH3-60PO-15EO-SO4 and C20-24 IOS with an inactive crude oil at 40° C.

FIG. 19 shows surface tension measurement for Amino-30(PO) compound in DI water.

FIG. 20 shows results of ACP formulation developed using N-30PO compounds at different oil-water ratio.

FIG. 21 shows aqueous stability for surfactant blends at various temperatures. The blends comprise C₁₄-C₁₆ AOS and CH₃O-60PO-20EO-SO₃Na.

FIG. 22 shows hardness tolerance of surfactant blends comprising C₁₄-C₁₆ AOS and CH₃O-60PO-20EO-SO₃Na at high salinity.

FIGS. 23A and 23B show bulk foam study of C₁₄-C₁₆ AOS alone (FIG. 23A) surfactant blends comprising C₁₄-C₁₆ AOS and CH₃O-60PO-20EO-SO₃Na (FIG. 23B) at 60° C.

### DETAILED DESCRIPTION

### Definitions

Unless otherwise indicated, the abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e., unbranched) or branched chain which may be fully saturated, mono- or polyunsaturated (e.g., oleic, linoleic, and linolenic) and can include di- and multivalent radicals, having the number of carbon atoms designated (e.g., C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, n-nonyl, n-decyl, n-undecyl, n-dodecyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred. A “lower alkyl” or “lower alkylene” is a shorter chain alkyl or alkylene group, generally having eight or fewer carbon atoms.

The term “aryl” means, unless otherwise stated, a polyunsaturated, aromatic, hydrocarbon substituent which can be a single ring or multiple rings (preferably from 1 to 3 rings) which are fused together (i.e., a fused ring aryl) or linked covalently. A fused ring aryl refers to multiple rings fused together wherein at least one of the fused rings is an aryl ring. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. Thus, the term “heteroaryl” includes fused ring heteroaryl groups (i.e., multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. Similarly, a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

The term “oxo” as used herein means an oxygen that is double bonded to a carbon atom.

Where a substituent of a compound provided herein is “R-substituted” (e.g., R²-substituted), it is meant that the substituent is substituted with one or more of the named R groups (e.g., R²) as appropriate. In some embodiments, the substituent is substituted with only one of the named R groups.

Each R-group as provided in the formulae provided herein can appear more than once. Where an R-group appears more than once each R group can be optionally different.

The term “contacting” as used herein, refers to materials or compounds being sufficiently close in proximity to react or interact. For example, in methods of contacting an unrefined petroleum material, a hydrocarbon material bearing formation, and/or a well bore, the term “contacting” can include placing a compound (e.g., a surfactant) or an aqueous composition (e.g., chemical, surfactant or polymer) within a hydrocarbon material-bearing formation using any suitable manner known in the art (e.g., pumping, injecting, pouring, releasing, displacing, spotting or circulating the chemical into a well, well bore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain, (i) Paraffin-based crude oils contain higher molecular weight paraffins, which are solid at room temperature, but little or no asphaltic (bituminous) matter. They can produce high-grade lubricating oils, (ii) Asphaltene based crude oils contain large proportions of asphaltic matter, and little or no paraffin. Some are predominantly naphthenes and so yield lubricating oils that are sensitive to temperature changes than the paraffin-based crudes, (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid or naphthenic acid) or their precursors such as esters or lactones. These reactive crude oils can generate soaps (e.g., or naphthenic carboxylates) when reacted with alkali. More terms used interchangeably for crude oil throughout this disclosure are hydrocarbon material or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic (e.g., naphthenic acid) components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{o} = \frac{{V}_{o}}{{V}_{s}}$$

where σₒ is the oil solubilization ratio, Vₒ is the volume of oil solubilized, and Vₛ is the volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{w} = \frac{{V}_{w}}{{V}_{s}}$$

where σ_{w} is the water solubilization ratio, V_{w} is the volume of oil solubilized, and Vₛ is the volume of surfactant.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

σₒ=σ_{w}=σ*

where σ* is the optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g., precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “aqueous solution or aqueous formulation” refers to a solution in which the solvent is water. The term “emulsion, emulsion solution or emulsion formulation” refers to a mixture of two or more liquids which are normally immiscible. Anon-limiting example for an emulsion is a mixture of oil and water.

The term “cosolvent,” as used herein, refers to a compound having the ability to increase the solubility of a solute (e.g., a surfactant as disclosed herein) in the presence of an unrefined petroleum acid. In some embodiments, the cosolvents provided herein have a hydrophobic portion (alkyl or aryl chain), a hydrophilic portion (e.g., an alcohol) and optionally an alkoxy portion. Cosolvents as provided herein include alcohols (e.g., C₁-C₆ alcohols, C₁-C₆ diols), alkoxy alcohols (e.g., C₁-C₆ alkoxy alcohols, C₁-C₆ alkoxy diols, and phenyl alkoxy alcohols), glycol ether, glycol and glycerol. The term “alcohol” is used according to its ordinary meaning and refers to an organic compound containing an —OH groups attached to a carbon atom. The term “diol” is used according to its ordinary meaning and refers to an organic compound containing two —OH groups attached to two different carbon atoms. The term “alkoxy alcohol” is used according to its ordinary meaning and refers to an organic compound containing an alkoxy linker attached to a —OH group

A “microemulsion” as referred to herein is a thermodynamically stable mixture of oil, water, and a stabilizing agents such as a surfactant or a cosolvent that may also include additional components such as alkali agents, polymers (e.g., water-soluble polymers) and a salt. In contrast, a “macroemulsion” as referred to herein is a thermodynamically unstable mixture of oil and water that may also include additional components. An “emulsion” as referred to herein may be a microemulsion or a macroemulsion.

Compounds

Provided herein are compounds and compositions for use in enhanced oil recovery. In some aspects, the compounds described herein can be defined by Formula I below

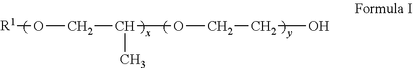

wherein R¹ is unsubstituted C₄-C₁₀ alkyl such as unsubstituted C₆-C₁₀ alkyl or unsubstituted phenyl; x is an integer from 2 to 10; and y is an integer from 3 to 60, preferably from 3 to 40.

In some embodiments of Formula I, x can be at least 2 (e.g., at least 3, at least 4, at least 5, at least 6, at least 7, at least 8, at least 9, or 10). In some embodiments of Formula I, x can be 10 or less (e.g., 9 or less, 8 or less, 7 or less, 6 or less, 5 or less, 4 or less, or 3 or less). The integer x can range from any of the minimum values described above to any of the maximum values described above. For example, x can be an integer from 2 to 10 (e.g., an integer from 2 to 8, an integer from 4 to 10, an integer from 4 to 8, or an integer from 4 to 7).

In some embodiments of Formula I, y can be at least 3 (e.g., at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 45, at least 50, at least 55, or at least 60). In some embodiments of Formula I, y can be 60 or less (e.g., less than 60, 55 or less 50 or less, 45 or less, 40 or less, 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, or 3 or less). The integer y can range from any of the minimum values described above to any of the maximum values described above. For example, y can be an integer from 3 to 60 (e.g., an integer from 3 to 50, an integer from 3 to 40, an integer from 3 to 35, an integer from 3 to 30, an integer from 3 to 20, an integer from 5 to 35, an integer from 5 to 30, an integer from 5 to 20, an integer from 5 to 15, an integer from 5 to 10, an integer from 7 to 40, or an integer from 7 to 30).

In embodiments of Formula I, the sum of x and y (x+y) can vary. For example, in some embodiments, the sum of x and y (x+y) can be at least 5 (e.g., at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 55, at least 60, or at least 70). In some embodiments of Formula I, the sum of x and y (x+y) can be 70 or less (e.g., 65 or less, 60 or less, 55 or less, 50 or less, 49 or less, 48 or less, 47 or less, 46 or less, 45 or less, 44 or less, 43 or less, 42 or less, 41 or less, 40 or less, 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, or 3 or less). The sum of x and y (x+y) can range from any of the minimum values described above to any of the maximum values described above. For example, the sum of x and y (x+y) can range from 5 to 70 (e.g., from 5 to 65, from 5 to 60, from 5 to 50, from 5 to 40, from 5 to 30, from 5 to 25, or from 7 to 25).

In some embodiments of Formula I, y can be greater than x. For example, the ratio of y:x is greater than 1:1, such as from 1.1:1 to 30:1, from 1.1:1 to 20:1, from 1.1:1 to 15:1, or from 1.1:1 to 10:1, or from 1.1:1 to 8:1, or from 1.1:1 to 5:1, or from 1.2:1 to 10:1, or from 1.2:1 to 4:1, or from 1.2:1 to 3:1, or from 1.2:1 to 2.5:1, or from 1.2:1 to 2:1, or from 1.5:1 to 4:1, or from 1.5:1 to 3:1, or from 1.5:1 to 2.5:1, or from 1.5:1 to 2:1. In some embodiments of Formula I, y and x are equal. In certain cases, y can be an integer from 3 to 40 and x can be an integer from 2 to 10.

In some embodiments of Formula I, R¹ can be an unsubstituted C₄-C₁₀ alkyl such as unsubstituted C₆-C₁₀ alkyl group. For example, R¹ can be an unsubstituted C₄ alkyl group, unsubstituted C₅ alkyl group, unsubstituted C₆ alkyl group, an unsubstituted C₇ alkyl group, an unsubstituted C₈ alkyl group, an unsubstituted C₉ alkyl group, or an unsubstituted C₁₀ alkyl group. In some embodiments, R¹ can be a C₇-C₁₀ alkyl group. In some embodiments, R¹ can be a C₅-C₁₀ alkyl group. In some embodiments, R¹ can be a C₆-C₅ alkyl group. In some embodiments, R¹ can be a C₇-C₈ alkyl group. In each of these cases, the alkyl group can be branched or unbranched (i.e., linear). In each of these embodiments, the alkyl group can be saturated or unsaturated. In certain of these embodiments, the alkyl group can be branched and saturated. For example, in certain embodiments of Formula I, R¹ can be a branched, saturated C₄-C₁₀ or C₆-C₁₀ alkyl group (e.g., a 2-ethylhexyl, a butyl, an isobutyl group).

In some embodiments of Formula I, R¹ can be an unsubstituted phenyl.

In other aspects, the compounds described herein can be defined by Formula II below

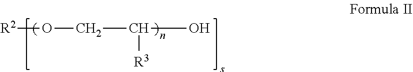

where R² is a substituted or unsubstituted C₄-C₂₀ polyalkylamine; R³, for each occurrence, is independently hydrogen or methyl; and n is an integer from 2 to 60 or from 2 to 35, s is 1 to 4, or 1 to 3. The n R³ radicals are each independently ethoxy or propoxy groups. The ethoxy or propoxy groups may, if both types of groups are present, be arranged randomly, alternately or in block structure. Preference is given to a block structure in which the propoxy and ethoxy groups are in fact arranged in the R²-propoxy block-ethoxy block sequence or R²-ethoxy block-propoxy block sequence. In some embodiments of Formula II, n includes at least 1, or at least 2 propoxy groups. Additionally preferably, the number of propoxy groups is greater than or equal to that of the ethoxy groups.

In some embodiments of Formula II, n can be at least 2 (e.g., at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 55, or at least 60). In some embodiments of Formula I, n can be 60 or less (e.g., 55 or less, 50 or less, 49 or less, 48 or less, 47 or less, 46 or less, 45 or less, 44 or less, 43 or less, 42 or less, 41 or less, 40 or less, 39 or less, 38 or less, 37 or less, 36 or less, 35 or less, 34 or less, 33 or less, 32 or less, 31 or less, or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, or 3 or less). The integer n can range from any of the minimum values described above to any of the maximum values described above. For example, n can be an integer from 2 to 60 or from 2 to 35 (e.g., an integer from 3 to 60, an integer from 3 to 50, an integer from 3 to 35, an integer from 3 to 30, an integer from 3 to 28, an integer from 3 to 25, an integer from 3 to 20, an integer from 5 to 35, an integer from 5 to 30, an integer from 5 to 28, an integer from 5 to 25, an integer from 5 to 20, an integer from 5 to 15, an integer from 5 to 10, an integer from 7 to 30, or an integer from 7 to 25).

In some embodiments of Formula II, R² can be a substituted or unsubstituted amine or a substituted or unsubstituted C₄-C₁₆ polyalkylamine. The polyalkylamine can include a polyalkylenediamine, a polyalkylenetriamine, a polyalkylenetetramine, a polyalkylenepentamine, a polyalkylenehexamine, a polyalkyleneheptamine, a polyalkyleneoctamine, a polyalkylenenonamine, or a mixture thereof. Each alkyl group in the polyalkylamine can be an unsubstituted C₁-C₆ alkylene group. For example, each alkyl group in the polyalkylamine can be an unsubstituted C₁ alkylene group, an unsubstituted C₂ alkylene group, an unsubstituted C₃ alkylene group, an unsubstituted C₄ alkylene group, an unsubstituted C₅ alkylene group, or an unsubstituted C₆ alkylene group. In some embodiments, each alkyl group in the polyalkylamine can be a C₂-C₄ alkylene group. In some embodiments, each alkyl group in the polyalkylamine can be a C₂-C₃ alkylene group. In some embodiments of Formula II, the polyalkylamine, R² can include two or more alkyleneamine groups. For example, the polyalkylamine can include a di-alkylenepolyamine, tri-alkylenepolyamine, tetra-alkylenepolyamine, penta-alkylenepolyamine, hexa-alkylenepolyamine, hepta-alkylenepolyamine, octa-alkylenepolyamine, nona-alkylenepolyamine, or a combination thereof. In some embodiments of Formula II, the alkylene groups together in R² can comprise 4 carbon atoms or greater, 5 carbon atoms or greater, 6 carbon atoms or greater, 7 carbon atoms or greater, 8 carbon atoms or greater, 9 carbon atoms or greater, 10 carbon atoms or greater, 11 carbon atoms or greater, 12 carbon atoms or greater, 13 carbon atoms or greater, 14 carbon atoms or greater, 15 carbon atoms or greater, 16 carbon atoms or greater, 17 carbon atoms or greater, 18 carbon atoms or greater, 19 carbon atoms or greater, or 20 carbon atoms or greater. In some embodiments, the alkylene groups together can comprise from 4 to carbon atoms (e.g., from 4 to 18 carbon atoms, from 4 to 16 carbon atoms, from 4 to 12 carbon atoms, from 4 to 10 carbon atoms, from 6 to 18 carbon atoms, from 6 to 16 carbon atoms, from 6 to 12 carbon atoms, from 6 to 10 carbon atoms, or from 6 to 8 carbon atoms). For example, in certain embodiments of Formula II, the polyalkylamine, R² can be selected from a C₄-C₁₆ polyalkylenediamine, a C₄-C₁₆ polyalkylenetriamine, a C₄-C₁₆ polyalkylenetetramine, or a C₄-C₁₆ polyalkylenepentamine. In certain examples of Formula II, R² can be selected from diisopropylamine, di-ethylenetriamine, tri-ethylenetetramine, tetra-ethylenepentamine, di-propylenetriamine, tri-propylenetetramine, or tetra-propylenepentamine. For example, R² can be selected from the formulas below:

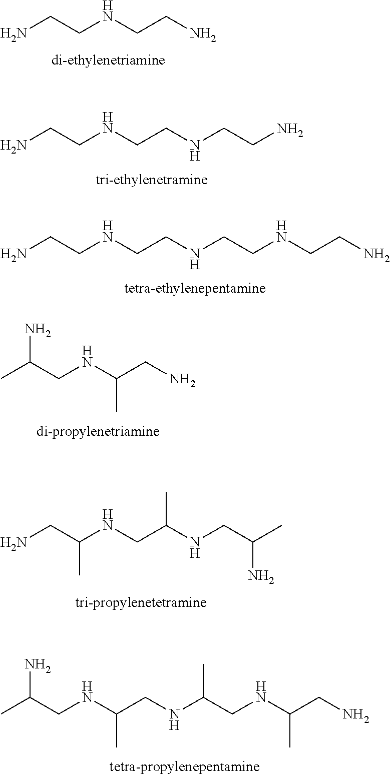

certain embodiments of Formula II, R² can be selected from an unsubstituted amine, an alkylamine, or a polyamine.

In certain embodiments of Formula II, the compound can have a structure of Formula IIa.

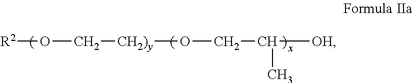

wherein R² is a substituted or unsubstituted C₄-C₂₀ polyalkylamine; x is an integer from 2 to 60, from 2 to 40 or from 2 to 20; y is an integer from 0 to 40 or from 0 to 15; and wherein x is greater than y.

In some embodiments of Formula IIa, x can be at least 2 (e.g., at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 55, or at least 60). In some embodiments of Formula IIa, x can be 60 or less (e.g., 55 or less, 50 or less, 49 or less, 48 or less, 47 or less, 46 or less, 45 or less, 44 or less, 43 or less, 42 or less, 41 or less, or less, 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, or 3 or less). The integer x can range from any of the minimum values described above to any of the maximum values described above. For example, x can be an integer from 2 to 20 (e.g., an integer from 2 to 18, an integer from 3 to 20, an integer from 4 to 20, or an integer from 4 to 10).

In some embodiments of Formula IIa, y can be 0 or at least 1 (e.g., at least 2, at least 3, at least 4, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, or at least 40). In some embodiments of Formula IIa, y can be 40 or less (e.g., 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, 1 or less, or 0). The integer y can range from any of the minimum values described above to any of the maximum values described above. For example, y can be an integer from 0 to 15 (e.g., an integer from 0 to 10, an integer from 1 to 15, an integer from 1 to 10, an integer from 2 to 15, an integer from 2 to 10, an integer from 3 to 15, or an integer from 3 to 10).

In embodiments of Formula IIa, the sum of x and y (x+y) can vary. For example, in some embodiments, the sum of x and y (x+y) can be at least 2 (e.g., at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 55, or at least 60). In some embodiments of Formula IIa, the sum of x and y (x+y) can be 60 or less (e.g., 55 or less, 50 or less, 49 or less, 48 or less, 47 or less, 46 or less, 45 or less, 44 or less, 43 or less, 42 or less, 41 or less, 40 or less, 39 or less, 38 or less, 37 or less, 36 or less, 35 or less, 34 or less, 33 or less, 32 or less, 31 or less, 30 or less, 29 or less, 28 or less, 27 or less, 26 or less, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, or 3 or less). The sum of x and y (x+y) can range from any of the minimum values described above to any of the maximum values described above. For example, the sum of x and y (x+y) can range from 2 to 35 (e.g., from 3 to 35, from 5 to 30, from 5 to 25, or from 5 to 20).

In some embodiments of Formula IIa, y can be greater than x. For example, the ratio of y:x is greater than 1:1, such as from 1.1:1 to 30:1, from 1.1:1 to 25:1, from 1.1:1 to 20:1, from 1.1:1 to 15:1, or from 1.1:1 to 10:1, or from 1.1:1 to 8:1, or from 1.1:1 to 5:1, or from 1.2:1 to 10:1, or from 1.2:1 to 4:1, or from 1.2:1 to 3:1, or from 1.2:1 to 2.5:1, or from 1.2:1 to 2:1, or from 1.5:1 to 4:1, or from 1.5:1 to 3:1, or from 1.5:1 to 2.5:1, or from 1.5:1 to 2:1. In some embodiments of Formula IIa, x can be greater than y. For example, the ratio of x:y is greater than 1:1, such as from 1.1:1 to 20:1, from 1.1:1 to 15:1, or from 1.1:1 to 10:1, or from 1.1:1 to 8:1, or from 1.1:1 to 5:1, or from 1.2:1 to 10:1, or from 1.2:1 to 4:1, or from 1.2:1 to 3:1, or from 1.2:1 to 2.5:1, or from 1.2:1 to 2:1, or from 1.5:1 to 4:1, or from 1.5:1 to 3:1, or from 1.5:1 to 2.5:1, or from 1.5:1 to 2:1. In some embodiments of Formula IIa, y and x are equal. In certain cases, y can be an integer from 0 to 15 and x can be an integer from 2 to 20.

In other aspects, the compounds described herein can be defined by Formula VII or IX below

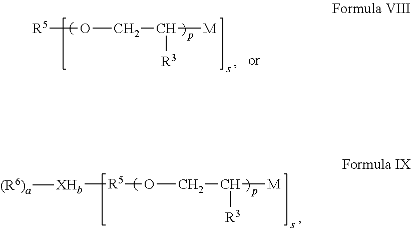

wherein R³, for each occurrence, is independently hydrogen, methyl or ethyl; R⁵ is substituted or unsubstituted C₁-C₈ alkyl, a polyol, an amine, or a polyamine; R⁶ is substituted or unsubstituted C₁-C₆ alkyl; X is CH or N; M is hydrogen or an ionic group; p is an integer from 7 to 250; and a+b+s=4; a=0-3; b=0-3; s=1-4.

In embodiments for Formula VIII or Formula IX, R⁵ can be linear, cyclic or branched, saturated or unsaturated alkyl, optionally substituted with 1 primary or secondary —OH group. In some cases, R⁵ may not contain a traditional size hydrophobe. Instead, the total number of carbon atoms in R⁵ can be from 1 to 8, but may be 1, 2, 3, 4, 5, 6, 7 or 8 or any range therebetween. For example, the R⁵ group may comprise 1-7, 1-6, 1-5, 1-4, 1-3 or 1-2 carbons. For example, R⁵ can be selected from the group consisting of methyl, ethyl, n-propyl, isopropyl, n-butyl, isobutyl, t-butyl, sec-butyl, pentyl, hexyl, heptyl and octyl and their isomers. In some examples, R⁵ is methyl. In other examples, R⁵ is branched C₅ to C₈. In further examples, R⁵ can be selected from the group consisting of propanol dimer alcohol, methylpentyl, and ethyhexyl.

In embodiments for Formula VIII or Formula IX, R⁵ can be a polyol. The polyol can be selected from the group consisting of diols, ethylene glycol, propylene glycol, diethylene glycol, glycerol, pentaerythritol, di- and trihydroxymethyl alkanes, buanediols, 1-3 propanediols, alkyl glucosides, butyl glucosides, sorbitols, polymers of the foregoing, polyglycerols, alkyl polyglucosides, polysaccharides, starches, CMC, cyclodextrins, poloxamers, pluronics and reverse Pluronics; wherein alkyl groups of said polyols preferably comprising Ci to C₅ linear, cyclic, or branched alkyl groups, preferably phenol.

In embodiments for Formula VIII or Formula IX, R⁶ can be linear C₁-C₈ alkyl. In some cases, the total number of carbon atoms in R⁶ can be from 1 to 8, but may be 1, 2, 3, 4, 5, 6, 7 or 8 or any range therebetween. For example, the R⁶ group may comprise 1-7, 1-6, 1-5, 1-4, 1-3 or 1-2 carbons. For example, R⁶ can be selected from the group consisting of methyl, ethyl, n-propyl, isopropyl, n-butyl, isobutyl, t-butyl, sec-butyl, pentyl, hexyl, heptyl and octyl and their isomers. In some examples, R⁶ is methyl. In some examples, R⁶ is CH₃CH₂—.

In certain embodiments, the total carbon atoms in a R⁶ₐ—XH_{b}—(R⁵) group is equal to or less than 8, that is, R⁵ and R⁶ are independently C₁ to C₈ alkyl, with a combined total of 8 or fewer carbons. Exemplary compounds include CH₃CH₂—CH—(CH₂—O—POx-EOy)₃ from trimethylol propane. In certain embodiments of Formula VIII or Formula IX, alkyleneoxy group defined by p preferably comprise propyleneoxy (PO) and ethyleneoxy (EO) groups. The PO and EO groups may be in PO blocks, EO blocks, PO-EO blocks, EO-PO blocks, other repeating blocks and/or in random order. One or more PO groups, or all PO groups, may be replaced by BO. Preferably the compounds comprise a block of PO groups, followed by a block of EO groups. In certain embodiments of Formula VIII or Formula IX, the number of PO groups is an integer from 7-100 and the number of EO groups is an integer from 0-250, and at least one of the following is true: p≥25, or R5 is C1-C6.

In certain embodiments of Formula VIII or Formula IX, the number of PO and/or BO groups is an integer from 7-90, from 7-80, from 7-70, from 7-60, from 7-50, from 7-40, from 7-30, from 7-20, from 7-15, from 90-100, from 80-100, from 70-100, from 60-100, from 50-100, from 40-100, from 30-100, from 20-100, from 15-100, from 10-100, from 5-100, from 15-25, from 25-35, from 35-45, from 45-55, from 55-65, from 65-75, from 75-85, from 85-95, or any values or ranges therebetween.

In certain embodiments of Formula VIII or Formula IX, the number of EO groups is an integer from 0-250, from 0-230, from 0-210, from 0-190, from 0-170, from 0-150, from 0-130, from 0-110, from 0-90, from 0-70, from 0-50, from 0-30, from 0-15, from 230-250, from 210-250, from 190-250, from 170-250, from 150-250, from 130-250, from 110-250, from 90-250, from 70-250, from 50-250, from 30-250, from 15-250, from 10-250, from 5-250, 5-25, from 25-45, from 45-65, from 65-85, from 85-105, from 105-125, from 125-145, from 145-165, from 165-185, from 185-205, from 205-225, from 225-250.

In certain embodiments of Formula VIII or Formula IX, p is an integer from from 7-250, from 7-230, from 7-210, from 7-190, from 7-170, from 7-150, from 7-130, from 7-110, from 7-100, from 7-90, from 7-70, from 7-50, from 7-30, from 7-15, from 15-250, from 10-250, from 25-100, from 25-65, from 25-85, or from 30-100.

In embodiments for Formula VIII, the compound can have a structure of Formula Villa,

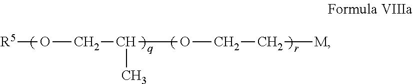

wherein R⁵ is substituted or unsubstituted C₁-C₈ alkyl; q is an integer from 27 to 100; r is an integer from 0 to 100; and M is hydrogen or an ionic group.

In embodiments for Formula Villa, q is greater than or equal to r. For example, q can be an integer from 7 to 100 and r is an integer from 0 to 60. In other examples, q can be an integer from 7 to 60 and r is an integer from 0 to 40. In further examples, q can be an integer from 7 to 40 and r is an integer from 0 to 20. In even further examples, q can be an integer from 7 to 21 and r is an integer from 0 to 15.

In embodiments for Formula Villa, when M is H, the compound comprises at least one EO group, that is, r is at least 1.

M is preferably selected from the group consisting of H, sulfate, carboxylate, and sulfonate, optionally substituted with one hydroxyl group. M can include a monovalent, divalent or trivalent cation. For example, M can include a metal cation such as sodium or postassium, or in some cases, ammonium cation. It should be understood that the oxygen of the EO or PO group may contribute to the sulfate group, such that unless otherwise specified.

In certain embodiments, if there is no EO group, M is not H. Preferably, if there are 5 or more, 7 or more or 21 or more PO groups without an EO group, M is not H. The ionic group can provide hydrophilicity to the compounds.

Aqueous Compositions

The compounds described herein can be used in EOR formulations to impart many beneficial properties generally afforded by cosolvents. For example, the compounds can provide for faster equilibration, low microemulsion viscosity, and improved aqueous stability. In particular, the compounds described herein can impart one or more of these desirable properties (e.g., lower microemulsion viscosity) without increasing interfacial tension. The compounds described herein can be used in EOR formulations to impart many beneficial properties generally afforded by an alkali agent. For example, the compounds can provide for increased pH. Thus, the compounds described herein can be incorporated into EOR formulations to increase aqueous stability, increase pH, speed up equilibration, broaden the low interfacial tension region, decrease microemulsion viscosity, reduce surfactant retention, and combinations thereof. As the compounds described herein can perform the multiple roles of surfactant, alkali agent, and cosolvent in EOR formulations, the compounds described herein can be used to prepare EOR formulations with lower amounts of cosolvent, surfactant, and alkali agents (or even EOR formulations that are free or substantially free from cosolvents, surfactant, or alkali agent). This improves the efficiency of the EOR process since cosolvents also partition into excess water and oil phases and whereas surfactants stay almost entirely in the membrane phase. The overall chemical cost of the EOR formulations may also be lowered.

Accordingly, also provided are aqueous compositions for use in EOR that comprise the compounds described herein (e.g., a compound of Formula I, II, VIII, or IX). For example, provided herein are aqueous composition that comprise a compound described herein (e.g., a compound of Formula I, II, VIII, or IX) and water. Additional components, including viscosity-enhancing water-soluble polymers, alkali agents, surfactants additional cosolvents, and combinations thereof, can be present in the aqueous compositions. Additional components can be selected depending on whether the compositions are formulated for use in conjunction with, for example, an Alkaline Surfactant Polymer (ASP)-type CEOR process, an Alkaline Cosolvent Polymer (ACP)-type CEOR process, or Surfactant Polymer (SP)-type CEOR process.

In some embodiments, the aqueous composition can further comprise a surfactant. A surfactant, as used herein, is a compound within the aqueous composition that functions as a surface active agent when the aqueous composition is in contact with a crude oil (e.g., an unrefined petroleum). The surfactant can act to lower the interfacial tension and/or surface tension of the unrefined petroleum. In some embodiments, the surfactant and the compound of Formula I, II, VIII, or IX are present in synergistic surface active amounts. A “synergistic surface active amount,” as used herein, means that a compound of Formula I, II, VIII, or IX and the surfactant are present in amounts in which the oil surface activity (interfacial tension lowering effect and/or surface tension lowering effect on crude oil when the aqueous composition is added to the crude oil) of the compound and surfactant combined is greater than the additive oil surface activity of the surfactant individually and the compound individually. In some cases, the oil surface activity of the compound and surfactant combination is 10%, 20%, 30%, 40%, 50%, 60%, 70%, 80%, 90% or 100% more than the additive oil surface activity of the surfactant individually and the compound individually. In some embodiments, the oil surface activity of the compound and surfactant combination is 2, 3, 4, 5, 6, 7, 8, 9 or 10 times more than the additive oil surface activity of the surfactant individually and the compound individually.

In another embodiment, the compound and surfactant are present in a surfactant stabilizing amount. A “surfactant stabilizing amount” means that the compound and the surfactant are present in an amount in which the surfactant degrades at a slower rate in the presence of the compound than in the absence of the compound, and/or the compound degrades at a slower rate in the presence of the surfactant than in the absence of the surfactant. The rate of degradation may be 10%, 20%, 30%, 40%, 50%, 60%, 70%, 80%, 90% or 100% slower. In some embodiments, the rate of degradation is 2, 3, 4, 5, 6, 7, 8, 9 or 10 times slower.

In another embodiment, the compound and surfactant are present in a synergistic solubilizing amount. A “synergistic solubilizing amount” means that the compound and the surfactant are present in an amount in which the compound is more soluble in the presence of the surfactant than in the absence of the surfactant, and/or the surfactant is more soluble in the presence of the compound than in the absence of the compound. The solubilization may be 10%, 20%, 30%, 40%, 50%, 60%, 70%, 80%, 90% or 100% higher. In some embodiment, the solubilization is 2, 3, 4, 5, 6, 7, 8, 9 or 10 times higher. In some embodiments, the compound is present in an amount sufficient to increase the solubility of the surfactant in the aqueous composition relative to the absence of the compound. In other words, in the presence of a sufficient amount of the compound, the solubility of the surfactant in the aqueous composition is higher than in the absence of the compound. In other embodiments, the surfactant is present in an amount sufficient to increase the solubility of the compound in the aqueous composition relative to the absence of the surfactant. Thus, in the presence of a sufficient amount of the surfactant the solubility of the compound in the aqueous solution is higher than in the absence of the surfactant.

In some embodiments, a single type of surfactant is in the aqueous composition. In other embodiments, a surfactant can comprise a blend of surfactants (e.g., a combination of two or more surfactants). The surfactant blend can comprise a mixture of a plurality of surfactant types. For example, the surfactant blend can include at least two surfactant types, at least three surfactant types, at least four surfactant types, at least five surfactant types, at least six surfactant types, or more. In some embodiments, the surfactant blend can include from two to six surfactant types (e.g., from two to five surfactant types, from two to four surfactant types, from two to three surfactant types, from three to six surfactant types, or from three to five surfactant types). The surfactant types can be independently different (e.g., anionic or cationic surfactants; two anionic surfactants having a different hydrocarbon chain length but are otherwise the same; a sulfate and a sulfonate surfactant that that the same hydrocarbon chain length and are otherwise the same, etc.). Therefore, a person having ordinary skill in the art will immediately recognize that the terms “surfactant” and “surfactant type(s)” have the same meaning and can be used interchangeably.

In some embodiments, the surfactant can comprise an anionic surfactant, a non-ionic surfactant, a zwitterionic surfactant, a cationic surfactant, or a combination thereof. In some embodiments, the surfactant can comprise an anionic surfactant, a non-ionic surfactant, or a combination thereof. In some embodiments, the surfactant can comprise a plurality of anionic surfactants. In some embodiments, the surfactant can comprise a zwitterionic surfactant. “Zwitterionic” or “zwitterion” as used herein refers to a neutral molecule with a positive (or cationic) and a negative (or anionic) electrical charge at different locations within the same molecule. Examples of zwitterionic surfactants include without limitation betains and sultains.

The surfactant can be any appropriate surfactant useful in the field of enhanced oil recovery. For example, in some embodiments, the surfactant can comprise an internal olefin sulfonate (IOS), an alpha olefin sulfonate (AOS), an alkyl aryl sulfonate (ARS), an alkane sulfonate, a petroleum sulfonate, an alkyl diphenyl oxide (di)sulfonate, an alcohol sulfate, an alkoxy sulfate, an alkoxy sulfonate, an alcohol phosphate, an alkoxy phosphate, a sulfosuccinate ester, an alcohol ethoxylate, an alkyl phenol ethoxylate, a quaternary ammonium salt, a betaine or sultaine. The surfactant as provided herein, can also be a soap.

In embodiments, the surfactant can comprise an anionic surfactant. For example, the surfactant can comprise an anionic surfactant selected from the group consisting of alkoxy carboxylate surfactants, alkoxy sulfate surfactants, alkoxy sulfonate surfactants, alkyl sulfonate surfactants, aryl sulfonate surfactants, olefin sulfonate surfactants, and combinations thereof. In embodiments, the anionic surfactant can comprise an anionic surfactant blend. Where the anionic surfactant is an anionic surfactant blend, the aqueous composition includes a plurality (i.e., more than one) type of anionic surfactant.

In some embodiments, the surfactant can comprise an alkoxy carboxylate surfactant. An “alkoxy carboxylate surfactant” as provided herein is a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In some embodiments, the surfactant can comprise an alkoxy carboxylate surfactant defined by Formula III or Formula IV

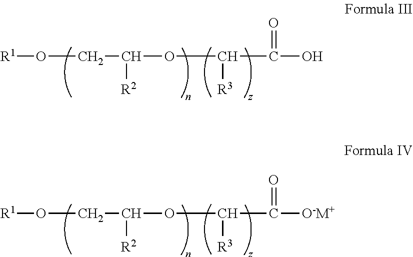

wherein R¹ is substituted or unsubstituted C₈-C₁₅₀ alkyl or substituted or unsubstituted aryl; R² is independently hydrogen or unsubstituted C₁-C₆ alkyl; R³ is independently hydrogen or unsubstituted C₁-C₆ alkyl; n is an integer from 2 to 210; z is an integer from 1 to 6; and M⁺ is a cation.

In embodiments of Formula III or IV, R¹ is unsubstituted linear or branched C₈-C₃₆ alkyl. In embodiments of Formula III or IV, R¹ is (C₆H₅—CH₂CH₂)₃C₆H₂— (TSP), (C₆H₅—CH₂CH₂)₂C₆H₃— (DSP), (C₆H₅—CH₂CH₂)₁C₆H₄— (MSP), or substituted or unsubstituted naphthyl. In embodiments of Formula III or IV, the alkoxy carboxylate is C₂₈-25PO-25EO-carboxylate (i.e., unsubstituted C₂₈ alkyl attached to 25 —CH₂—CH(methyl)-O-linkers, attached in turn to 25 —CH₂—CH₂—O— linkers, attached in turn to —COO⁻ or acid or salt thereof including metal cations such as sodium).

In some embodiments, the surfactant can comprise an alkoxy sulfate surfactant. An alkoxy sulfate surfactant as provided herein is a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In embodiments, the alkoxy sulfate surfactant can be defined by the formula below

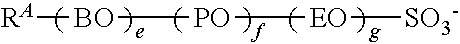

or acid or salt thereof, wherein R^{A} is C₈-C₃₆ alkyl group; BO represents —CH₂—CH(ethyl)-O—; PO represents —CH₂—CH(methyl)-O—; EO represents —CH₂—CH₂—O—; and e, f and g are each independently integers from 0 to 50, with the proviso that at least one of e, f, and g is not zero. In embodiments, the alkoxy sulfate surfactant can be C₁₅-13PO-sulfate (i.e., an unsubstituted C₁₅ alkyl attached to 13 —CH₂—CH(methyl)-O— linkers, in turn attached to —SO₃⁻ or acid or salt thereof including metal cations such as sodium). In embodiments, the alkoxy sulfate surfactant can be C₁₃-13PO-sulfate (i.e., an unsubstituted C₁₃ alkyl attached to 13 —CH₂—CH(methyl)-O— linkers, in turn attached to —SO₃⁻ or acid or salt thereof including metal cations such as sodium).

In some embodiments, the surfactant can comprise an alkoxy sulfate surfactant defined by Formula V

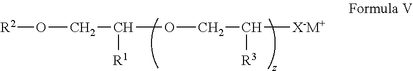

wherein R¹ and R² are independently a substituted or unsubstituted C₈-C₁₅₀ alkyl group or a substituted or unsubstituted aryl group; R³ is independently hydrogen or unsubstituted C₁-C₆ alkyl; z is an integer from 2 to 210; X⁻ is

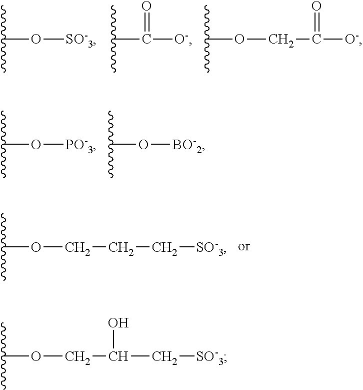

and M⁺ is a cation.

In some embodiments of Formula V, R¹ is a branched unsubstituted C₈-C₁₅₀ group. In embodiments of Formula V, R¹ is branched or linear unsubstituted C₁₂-C₁₀₀ alkyl, (C₆H₅—CH₂CH₂)₃C₆H₂— (TSP), (C₆H₅—CH₂CH₂)₂C₆H₃— (DSP), (C₆H₅—CH₂CH₂)₁C₆H₄— (MSP), or substituted or unsubstituted naphthyl. In embodiments of Formula V, the alkoxy sulfate is C₁₆-C₁₆-epoxide-15PO-10EO-sulfate (i.e., a linear unsubstituted C₁₆ alkyl attached to an oxygen, which in turn is attached to a branched unsubstituted C₁₆ alkyl, which in turn is attached to 15 —CH₂—CH(methyl)-O— linkers, in turn attached to 10 —CH₂—CH₂—O— linkers, in turn attached to —SO₃⁻ or acid or salt thereof including metal cations such as sodium).

In some embodiments, the alkoxy sulfate surfactant provided herein can be an aryl alkoxy sulfate surfactant. An aryl alkoxy surfactant as provided herein is an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In embodiments of Formula V, the aryl alkoxy sulfate surfactant is (C₆H₅—CH₂CH₂)₃C₆H₂-7PO-10EO-sulfate (i.e., tri-styrylphenol attached to 7 —CH₂—CH(methyl)-O— linkers, in turn attached to 10 —CH₂—CH₂—O— linkers, in turn attached to —SO₃⁻ or acid or salt thereof including metal cations such as sodium).

In some embodiments, the surfactant can comprise an unsubstituted alkyl sulfate and/or an unsubstituted alkyl sulfonate surfactant. An alkyl sulfate surfactant as provided herein is a surfactant having an alkyl group attached to —O—SO₃⁻ or acid or salt thereof including metal cations such as sodium. An alkyl sulfonate surfactant as provided herein is a surfactant having an alkyl group attached to —SO₃⁻ or acid or salt thereof including metal cations such as sodium. In some embodiments, the surfactant can comprise an unsubstituted aryl sulfate surfactant or an unsubstituted aryl sulfonate surfactant. An aryl sulfate surfactant as provided herein is a surfactant having an aryl group attached to —O—SO₃⁻ or acid or salt thereof including metal cations such as sodium. An aryl sulfonate surfactant as provided herein is a surfactant having an aryl group attached to —SO₃⁻ or acid or salt thereof including metal cations such as sodium. In some embodiments, the surfactant can comprise an alkyl aryl sulfonate. Non-limiting examples of alkyl sulfate surfactants, aryl sulfate surfactants, alkyl sulfonate surfactants, aryl sulfonate surfactants and alkyl aryl sulfonate surfactants useful in the embodiments provided herein are alkyl aryl sulfonates (ARS) (e.g., alkyl benzene sulfonate (ABS) such as a C₈-C₃₀ ABS), alkane sulfonates, petroleum sulfonates, and alkyl diphenyl oxide (di)sulfonates. Additional surfactants useful in the embodiments provided herein are alcohol sulfates, alcohol phosphates, alkoxy phosphate, sulfosuccinate esters, alcohol ethoxylates, alkyl phenol ethoxylates, quaternary ammonium salts, betains and sultains.

In some embodiments, the surfactant can comprise an olefin sulfonate surfactant. In embodiments, the olefin sulfonate surfactant can be an internal olefin sulfonate (IOS) or an alpha olefin sulfonate (AOS). In embodiments, the olefin sulfonate surfactant can be a C₁₀-C₃₀ (IOS). In embodiments, the olefin sulfonate surfactant is C₁₅-C₁₈ IOS. In embodiments, the olefin sulfonate surfactant is C₁₉-C₂₈ IOS. Where the olefin sulfonate surfactant is C₁₅-C₁₈ IOS, the olefin sulfonate surfactant can be a mixture (combination) of C₁₅, C₁₆, C₁₇ and C₁₈ alkene, wherein each alkene is attached to a —SO₃⁻ or acid or salt thereof including metal cations such as sodium. Likewise, where the olefin sulfonate surfactant is C₁₉-C₂₈ IOS, the olefin sulfonate surfactant can be a mixture (combination) of C₁₉, C₂₀, C₂₁ C₂₂, C₂₃, C₂₄, C₂₅, C₂₆, C₂₇ and C₂₈ alkene, wherein each alkene is attached to a —SO₃⁻ or acid or salt thereof including metal cations such as sodium. In embodiments, the olefin sulfonate surfactant is C₁₉-C₂₃ IOS. As mentioned above, the aqueous composition provided herein may include a plurality of surfactants (i.e., a surfactant blend). In some embodiments, the surfactant blend can comprise a first olefin sulfonate surfactant and a second olefin sulfonate surfactant. In embodiments, the first olefin sulfonate surfactant can be a C₁₅-C₁₈ IOS and the second olefin sulfonate surfactant can be a C₁₉-C₂₈ IOS.

In some embodiments, the surfactant can comprise a surfactant defined by Formula VI

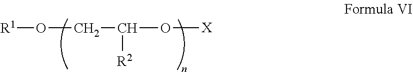

wherein R¹ is an R⁴-substituted or unsubstituted C₈-C₂₀ alkyl group, an R³-substituted or unsubstituted aryl group, or an R³-substituted or unsubstituted cycloalkyl group; R² is independently hydrogen or methyl; R³ is independently an R⁴-substituted or unsubstituted C₁-C₁₅ alkyl group, an R⁴-substituted or unsubstituted aryl group, or an R⁴-substituted or unsubstituted cycloalkyl group; R⁴ is independently an unsubstituted aryl group or an unsubstituted cycloalkyl group; n is an integer from 25 to 115; X is X is —SO₃⁻M⁺, —SO₃H, —CH₂C(O)O⁻M⁺, —CH₂C(O)OH; and M⁺ is a cation.

In some embodiments of Formula VI, the symbol n is an integer from 25 to 115. In some embodiments of Formula VI, the symbol n is an integer from 30 to 115. In some embodiments of Formula VI, the symbol n is an integer from 35 to 115. In some embodiments of Formula VI, the symbol n is an integer from 40 to 115. In some embodiments of Formula VI, the symbol n is an integer from 45 to 115. In some embodiments of Formula VI, the symbol n is an integer from 50 to 115. In some embodiments of Formula VI, the symbol n is an integer from 55 to 115. In some embodiments of Formula VI, the symbol n is an integer from 60 to 115. In some embodiments of Formula VI, the symbol n is an integer from 65 to 115. In some embodiments of Formula VI, the symbol n is an integer from 70 to 115. In some embodiments of Formula VI, the symbol n is an integer from 75 to 115. In some embodiments of Formula VI, the symbol n is an integer from 80 to 115. In some embodiments of Formula VI, the symbol n is an integer from 30 to 80. In some embodiments of Formula VI, the symbol n is an integer from 35 to 80. In some embodiments of Formula VI, the symbol n is an integer from 40 to 80. In some embodiments of Formula VI, the symbol n is an integer from 45 to 80. In some embodiments of Formula VI, the symbol n is an integer from 50 to 80. In some embodiments of Formula VI, the symbol n is an integer from 55 to 80. In some embodiments of Formula VI, the symbol n is an integer from 60 to 80. In some embodiments of Formula VI, the symbol n is an integer from 65 to 80. In some embodiments of Formula VI, the symbol n is an integer from 70 to 80. In some embodiments of Formula VI, the symbol n is an integer from 75 to 80. In some embodiments of Formula VI, the symbol n is an integer from 30 to 60. In some embodiments of Formula VI, the symbol n is an integer from 35 to 60. In some embodiments of Formula VI, the symbol n is an integer from 40 to 60. In some embodiments of Formula VI, the symbol n is an integer from 45 to 60. In some embodiments of Formula VI, the symbol n is an integer from 50 to 60. In some embodiments of Formula VI, the symbol n is an integer from 55 to 60. In embodiments of Formula VI, n is 25. In embodiments of Formula VI, n is 50. In embodiments of Formula VI, n is 55. In embodiments of Formula VI, n is 75.

In some embodiments of Formula VI, R¹ is R⁴-substituted or unsubstituted C₈-C₂₀ alkyl. In embodiments of Formula VI, R¹ is R⁴-substituted or unsubstituted C₁₂-C₂₀ alkyl. In embodiments of Formula VI, R¹ is R⁴-substituted or unsubstituted C₁₃-C₂₀ alkyl. In embodiments of Formula VI, R¹ is R⁴-substituted or unsubstituted C₁₃ alkyl. In embodiments of Formula VI, R¹ is unsubstituted C₁₃ alkyl. In other related embodiments, R¹ is a unsubstituted tridecyl (i.e., a C₁₃H₂₇— alkyl radical derived from tridecylalcohol). In yet embodiments, R¹ is R⁴-substituted or unsubstituted C₁₅-C₂₀ alkyl. In embodiments of Formula VI, R¹ is R⁴-substituted or unsubstituted C₁₈ alkyl. In embodiments of Formula VI, R¹ is unsubstituted C₁₈ alkyl. In other related embodiments, R¹ is an unsubstituted oleyl (i.e., a C₁₇H₃₃CH₂— radical derived from oleyl alcohol).

In some embodiments of Formula VI, R¹ can be R⁴-substituted or unsubstituted alkyl. In embodiments of Formula VI, R¹ is R⁴-substituted or unsubstituted C₈-C₂₀ alkyl. In embodiments of Formula VI, R¹ is R⁴-substituted or unsubstituted C₁₀-C₂₀ alkyl. In embodiments of Formula VI, R¹ is R⁴-substituted or unsubstituted C₁₂-C₂₀ alkyl. In embodiments of Formula VI, R¹ is R⁴-substituted or unsubstituted C₁₃-C₂₀ alkyl. In embodiments of Formula VI, R¹ is R⁴-substituted or unsubstituted C₁₄-C₂₀ alkyl. In embodiments of Formula VI, R¹ is R⁴-substituted or unsubstituted C₁₆-C₂₀ alkyl. In embodiments of Formula VI, R¹ is R⁴-substituted or unsubstituted C₈-C₁₅ alkyl. In embodiments of Formula VI, R¹ is R⁴-substituted or unsubstituted C₁₀-C₁₅ alkyl. In embodiments of Formula VI, R¹ is R⁴-substituted or unsubstituted C₁₂-C₁₅ alkyl. In embodiments of Formula VI, R¹ is R⁴-substituted or unsubstituted C₁₃-C₁₅ alkyl. In related embodiments, the alkyl is a saturated alkyl. In other related embodiments, R¹ is R⁴-substituted or unsubstituted C₁₃ alkyl. In other related embodiments, R¹ is unsubstituted C₁₃ alkyl. In other related embodiments, R¹ is a tridecyl (i.e., a —C₁₃H₂₇— alkyl radical derived from tridecylalcohol). In other related embodiments, R¹ is R⁴-substituted or unsubstituted C₁₈ alkyl. In other related embodiments, R¹ is unsubstituted C₁₈ alkyl. In other related embodiments, R¹ is an oleyl (i.e., a C₁₇H₃₃CH₂— radical derived from oleyl alcohol). In other related embodiments, n is as defined in an embodiment above (e.g., n is at least 40, or at least 50, e.g., 55 to 85).

In some embodiments of Formula VI, R¹ can be a linear or branched unsubstituted C₈-C₂₀ alkyl group. In embodiments of Formula VI, R¹ is branched unsubstituted C₈-C₂₀ alkyl. In embodiments of Formula VI, R¹ is linear unsubstituted C₈-C₂₀ alkyl. In embodiments of Formula VI, R¹ is branched unsubstituted C₈-C₁₈ alkyl. In embodiments of Formula VI, R¹ is branched unsubstituted C₈-C₁₈ alkyl. In embodiments of Formula VI, R¹ is linear unsubstituted C₈-C₁₈ alkyl. In embodiments of Formula VI, R¹ is branched unsubstituted C₁₈ alkyl. In other related embodiments, R¹ is an oleyl (i.e., a C₁₇H₃₃CH₂— radical derived from oleyl alcohol). In embodiments of Formula VI, R¹ is linear or branched unsubstituted C₈-C₁₆ alkyl. In embodiments of Formula VI, R¹ is branched unsubstituted C₈-C₁₆ alkyl. In embodiments of Formula VI, R¹ is linear unsubstituted C₈-C₁₆ alkyl. In embodiments of Formula VI, R¹ is linear or branched unsubstituted C₈-C₁₄ alkyl. In embodiments of Formula VI, R¹ is branched unsubstituted C₈-C₁₄ alkyl. In embodiments of Formula VI, R¹ is linear unsubstituted C₈-C₁₄ alkyl. In other related embodiments, R¹ is branched unsubstituted C₁₃ alkyl. In other related embodiments, R¹ is a tridecyl (i.e., a —C₁₃H₂₇— alkyl radical derived from tridecylalcohol). In embodiments of Formula VI, R¹ is linear or branched unsubstituted C₈-C₁₂ alkyl. In embodiments of Formula VI, R¹ is branched unsubstituted C₈-C₁₂ alkyl. In embodiments of Formula VI, R¹ is linear unsubstituted C₈-C₁₂ alkyl. In other related embodiments, n is as defined in an embodiment above (e.g., n is at least 40, or at least 50, e.g., 55 to 85).

In some embodiments of Formula VI where R¹ is a linear or branched unsubstituted alkyl (e.g., branched unsubstituted C₁₀-C₂₀ alkyl), the alkyl can be a saturated alkyl (e.g., a linear or branched unsubstituted saturated alkyl or branched unsubstituted C₁₀-C₂₀ saturated alkyl). A “saturated alkyl,” as used herein, refers to an alkyl consisting only of hydrogen and carbon atoms that are bonded exclusively by single bonds. Thus, in embodiments of Formula VI, R¹ may be linear or branched unsubstituted saturated alkyl. In embodiments of Formula VI, R¹ is branched unsubstituted C₁₀-C₂₀ saturated alkyl. In embodiments of Formula VI, R¹ is linear unsubstituted C₁₀-C₂₀ saturated alkyl. In embodiments of Formula VI, R¹ is branched unsubstituted C₁₂-C₂₀ saturated alkyl. In embodiments of Formula VI, R¹ is linear unsubstituted C₁₂-C₂₀ saturated alkyl. In embodiments of Formula VI, R¹ is branched unsubstituted C₁₂-C₁₆ saturated alkyl. In embodiments of Formula VI, R¹ is linear unsubstituted C₁₂-C₁₆ saturated alkyl. In some further embodiments, R¹ is linear unsubstituted C₁₃ saturated alkyl.

In some embodiments of Formula VI where R¹ is a linear or branched unsubstituted alkyl (e.g., branched unsubstituted C₁₀-C₂₀ alkyl), the alkyl can be an unsaturated alkyl (e.g., a linear or branched unsubstituted unsaturated alkyl or branched unsubstituted C₁₀-C₂₀ unsaturated alkyl). An “unsaturated alkyl,” as used herein, refers to an alkyl having one or more double bonds or triple bonds. An unsaturated alkyl as provided herein can be mono- or polyunsaturated and can include di- and multivalent radicals. Thus, in embodiments of Formula VI, R¹ may be linear or branched unsubstituted unsaturated alkyl. In embodiments of Formula VI, R¹ is branched unsubstituted C₁₀-C₂₀ unsaturated alkyl. In embodiments of Formula VI, R¹ is linear unsubstituted C₁₀-C₂₀ unsaturated alkyl. In embodiments of Formula VI, R¹ is branched unsubstituted C₁₂-C₂₀ unsaturated alkyl. In embodiments of Formula VI, R¹ is linear unsubstituted C₁₂-C₂₀ unsaturated alkyl. In embodiments of Formula VI, R¹ is branched unsubstituted C₁₂-C₁₈ unsaturated alkyl. In embodiments of Formula VI, R¹ is linear unsubstituted C₁₂-C₁₈ unsaturated alkyl. In embodiments of Formula VI, R¹ is linear unsubstituted C₁₈ unsaturated alkyl. In embodiments of Formula VI, R¹ is branched unsubstituted C₁₈ unsaturated alkyl. In one embodiment, R¹ is linear unsubstituted C₁₈ mono-unsaturated alkyl. In another embodiment, R¹ is linear unsubstituted C₁₈ poly-unsaturated alkyl. In one embodiment, R¹ is branched unsubstituted C₁₈ mono-unsaturated alkyl. In another embodiment, R¹ is branched unsubstituted C₁₈ poly-unsaturated alkyl.

In some embodiments of Formula VI, R¹ can be R⁴-substituted or unsubstituted C₈-C₂₀ (e.g., C₁₂-C₁₈) alkyl, R³-substituted or unsubstituted C₅-C₁₀ (e.g., C₅-C₆) aryl or R³-substituted or unsubstituted C₃-C₈ (e.g., C₅-C₇) cycloalkyl. R³ can be independently R⁴-substituted or unsubstituted C₁-C₁₅ (e.g., C₈-C₁₂) alkyl, R⁴-substituted or unsubstituted C₅-C₁₀ (e.g., C₅-C₆) aryl or R⁴-substituted or unsubstituted C₃-C₈ (e.g., C₅-C₇) cycloalkyl. Thus, in embodiments of Formula VI, R³ is R⁴-substituted or unsubstituted C₁-C₁₅ alkyl, R⁴-substituted or unsubstituted C₅-C₁₀ aryl or R⁴-substituted or unsubstituted C₃-C₈ cycloalkyl. R⁴ can be independently unsubstituted C₅-C₁₀ (e.g., C₅-C₆) aryl or unsubstituted C₃-C₈ (e.g., C₅-C₇) cycloalkyl. Thus, in embodiments of Formula VI, R⁴ is independently unsubstituted C₅-C₁₀ aryl or unsubstituted C₃-C₈ cycloalkyl.

In some embodiments, the surfactant can comprise a surfactant defined by Formula VII

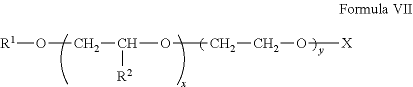

wherein R¹ and X are defined as above (e.g., in Formula VI); y is an integer from 5 to 40; and x is an integer from 35 to 50.

In embodiments of Formula VII, y is 10 and x is 45. In embodiments of Formula VII, R¹ is C₁₃ alkyl. In embodiments of Formula VII, y is 30 and x is 45. In some other embodiments, R¹ is unsubstituted unsaturated C₁₈ alkyl. In embodiments of Formula VII, R¹ is linear unsubstituted C₁₈ unsaturated alkyl. In embodiments of Formula VII, R¹ is branched unsubstituted C₁₈ unsaturated alkyl. In one embodiment, R¹ is linear unsubstituted C ix mono-unsaturated alkyl. In another embodiment, R¹ is linear unsubstituted C₁₈ poly-unsaturated alkyl. In one embodiment, R¹ is branched unsubstituted C₁₈ mono-unsaturated alkyl. In another embodiment, R¹ is branched unsubstituted C ix poly-unsaturated alkyl.

In some embodiments of Formula VII where R¹ is unsubstituted C₁₃ alkyl, n is 55, X is —SO₃⁻M⁺, and M⁺ is a divalent cation (e.g., Na²⁺). In embodiments of Formula VII, x is 45 and y Is 10. In some embodiments of the compound of Formula VII where R¹ is unsubstituted C₁₈ unsaturated alkyl, n is 75, X is —CH₂C(O)O⁻M⁺, and M⁺ is a monovalent cation (e.g., Na⁺). In embodiments of Formula VII, x is 45 and y is 30.

Suitable surfactants are disclosed, for example, in U.S. Pat. Nos. 3,811,504, 3,811,505, 3,811,507, 3,890,239, 4,463,806, 6,022,843, 6,225,267, and 7,629,299; International Patent Application Publication Nos. WO/2008/079855, WO/2012/027757 and WO/2011/094442; as well as U.S. Patent Application Publication Nos. 2005/0199395, 2006/0185845, 2006/018486, 2009/0270281, 2011/0046024, 2011/0100402, 2011/0190175, 2007/0191633, 2010/004843. 2011/0201531, 2011/0190174, 2011/0071057, 2011/0059873, 2011/0059872, 2011/0048721, 2010/0319920, 2010/0292110, and 2013/0281327, all of which are incorporated herein by reference in their entirety. Additional suitable surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE IX89, conference contribution for the SPE Symposium on Improved Oil Recovery Annual Meeting, Tulsa, Okla., Apr. 24-26, 2006.

A person having ordinary skill in the art will immediately recognize that a number of surfactants are commercially available as blends of related molecules (e.g., IOS and ABS surfactants). Thus, where a surfactant is present within a composition provided herein, a person of ordinary skill would understand that the surfactant might be a blend of a plurality of related surfactant molecules (as described herein and as generally known in the art).

In some embodiments, the surfactant concentration is from about 0.05% w/w to about 10% w/w. In other embodiments, the surfactant concentration in the aqueous composition is from about 0.25% w/w to about 10% w/w. In other embodiments, the surfactant concentration in the aqueous composition is about 0.5% w/w. In other embodiments, the surfactant concentration in the aqueous composition is about 1.0% w/w. In other embodiments, the surfactant concentration in the aqueous composition is about 1.25% w/w. In other embodiments, the surfactant concentration in the aqueous composition is about 1.5% w/w. In other embodiments, the surfactant concentration in the aqueous composition is about 1.75% w/w. In other embodiments, the surfactant concentration in the aqueous composition is about 2.0% w/w. In other embodiments, the surfactant concentration in the aqueous composition is about 2.5% w/w. In other embodiments, the surfactant concentration in the aqueous composition is about 3.0% w/w. In other embodiments, the surfactant concentration in the aqueous composition is about 3.5% w/w. In other embodiments, the surfactant concentration in the aqueous composition is about 4.0% w/w. In other embodiments, the surfactant concentration in the aqueous composition is about 4.5% w/w. In other embodiments, the surfactant concentration in the aqueous composition is about 5.0% w/w. In other embodiments, the surfactant concentration in the aqueous composition is about 5.5% w/w. In other embodiments, the surfactant concentration in the aqueous composition is about 6.0% w/w. In other embodiments, the surfactant concentration in the aqueous composition is about 6.5% w/w. In other embodiments, the surfactant concentration in the aqueous composition is about 7.0% w/w. In other embodiments, the surfactant concentration in the aqueous composition is about 7.5% w/w. In other embodiments, the surfactant concentration in the aqueous composition is about 8.0% w/w. In other embodiments, the surfactant concentration in the aqueous composition is about 9.0% w/w. In other embodiments, the surfactant concentration in the aqueous composition is about 10% w/w.

In certain embodiments, the aqueous composition does not include a surfactant other than the compound of Formula I, II, VIII, or IX.

In some embodiments, the total concentration of the compound of Formula I, II, VIII, or IX in the aqueous composition is from about 0.25% w/w to about 10% w/w. In other embodiments, the total concentration of the compound of Formula I, II, VIII, or IX in the aqueous composition is at least about 0.5% w/w. In other embodiments, the total concentration of the compound of Formula I, II, VIII, or IX in the aqueous composition is at least about 1.0% w/w. In other embodiments, the total concentration of the compound of Formula I, II, VIII, or IX in the aqueous composition is at least about 1.25% w/w. In other embodiments, the total concentration of the compound of Formula I, II, VIII, or IX in the aqueous composition is at least about 1.5% w/w. In other embodiments the total concentration of the compound of Formula I, II, VIII, or IX in the aqueous composition is at least about 1.75% w/w. In other embodiments, the total concentration of the compound of Formula I, II, VIII, or IX is at least about 2.0% w/w. In other embodiments, the total concentration of the compound of Formula I, II, VIII, or IX in the aqueous composition is at least about 2.5% w/w. In other embodiments, the total concentration of the compound of Formula I, II, VIII, or IX in the aqueous composition is at least about 3.0% w/w. In other embodiments, the total concentration of the compound of Formula I, II, VIII, or IX in the aqueous composition is at least about 3.5% w/w. In other embodiments, the total concentration of the compound of Formula I, II, VIII, or IX is at least about 4.0% w/w. In other embodiments, the total concentration of the compound of Formula I, II, VIII, or IX in the aqueous composition is at least about 4.5% w/w. In other embodiments, the total concentration of the compound of Formula I, II, VIII, or IX in the aqueous composition is at least about 5.0% w/w. In other embodiments, the total concentration of the compound of Formula I, II, VIII, or IX in the aqueous composition is at least about 5.5% w/w. In other embodiments, the total concentration of the compound of Formula I, II, VIII, or IX in the aqueous composition is at least about 6.0% w/w. In other embodiments the total concentration of the compound of Formula I, II, VIII, or IX in the aqueous composition is at least about 6.5% w/w. In other embodiments, the total concentration of the compound of Formula I, II, VIII, or IX in the aqueous composition is at least about 7.0% w/w. In other embodiments, the total concentration of the compound of Formula I, II, VIII, or IX is at least about 7.5% w/w. In other embodiments, the total surfactant concentration in the aqueous composition is about 8.0% w/w. In other embodiments, the total concentration of the compound of Formula I, II, VIII, or IX in the aqueous composition is at least about 9.0% w/w. In other embodiments, the total concentration of the compound of Formula I, II, VIII, or IX in the aqueous composition is about 10% w/w.

In some embodiments, the total concentration of the compound of Formula I, II, VIII, or IX and one or more surfactants within the aqueous compositions is from about 0.05% w/w to about 10% w/w. In other embodiments, the total concentration of the compound of Formula I, II, VIII, or IX and one or more surfactants in the aqueous composition is from about 0.25% w/w to about 10% w/w. In other embodiments, the total concentration of the compound of Formula I, II, VIII, or IX and one or more surfactants in the aqueous composition is about 0.5% w/w. In other embodiments, the total concentration of the compound of Formula I, II, VIII, or IX and one or more surfactants in the aqueous composition is about 1.0% w/w. In other embodiments, the total concentration of the compound of Formula I, II, VIII, or IX and one or more surfactants in the aqueous composition is about 1.25% w/w. In other embodiments, the total concentration of the compound of Formula I, II, VIII, or IX and one or more surfactants in the aqueous composition is about 1.5% w/w. In other embodiments, the total concentration of the compound of Formula I, II, VIII, or IX and one or more surfactants in the aqueous composition is about 1.75% w/w. In other embodiments, the total concentration of the compound of Formula I, II, VIII, or IX and one or more surfactants in the aqueous composition is about 2.0% w/w. In other embodiments, the total concentration of the compound of Formula I, II, VIII, or IX and one or more surfactants in the aqueous composition is about 2.5% w/w. In other embodiments, the total concentration of the compound of Formula I, II, VIII, or IX and one or more surfactants in the aqueous composition is about 3.0% w/w. In other embodiments, the total concentration of the compound of Formula I, II, VIII, or IX and one or more surfactants in the aqueous composition is about 3.5% w/w. In other embodiments, the total concentration of the compound of Formula I, II, VIII, or IX and one or more surfactants in the aqueous composition is about 4.0% w/w. In other embodiments, the total concentration of the compound of Formula I, II, VIII, or IX and one or more surfactants in the aqueous composition is about 4.5% w/w. In other embodiments, the total concentration of the compound of Formula I, II, VIII, or IX and one or more surfactants in the aqueous composition is about 5.0% w/w. In other embodiments, the total concentration of the compound of Formula I, II, VIII, or IX and one or more surfactants in the aqueous composition is about 5.5% w/w. In other embodiments, the total concentration of the compound of Formula I, II, VIII, or IX and one or more surfactants in the aqueous composition is about 6.0% w/w. In other embodiments, the total concentration of the compound of Formula I, II, VIII, or IX and one or more surfactants in the aqueous composition is about 6.5% w/w. In other embodiments, the total concentration of the compound of Formula I, II, VIII, or IX and one or more surfactants in the aqueous composition is about 7.0% w/w. In other embodiments, the total concentration of the compound of Formula I, II, VIII, or IX and one or more surfactants in the aqueous composition is about 7.5% w/w. In other embodiments, the total concentration of the compound of Formula I, II, VIII, or IX and one or more surfactants in the aqueous composition is about 8.0% w/w. In other embodiments, the total concentration of the compound of Formula I, II, VIII, or IX and one or more surfactants in the aqueous composition is about 9.0% w/w. In other embodiments, the total concentration of the compound of Formula I, II, VIII, or IX and one or more surfactants in the aqueous composition is about 10% w/w.

In some embodiments, the aqueous compositions can further include a viscosity enhancing water-soluble polymer. In some embodiments, the water-soluble polymer may be a biopolymer such as xanthan gum or scleroglucan, a synthetic polymer such as polyacryamide, hydrolyzed polyarcrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In some embodiments, the polymer is polyacrylamide (PAM), partially hydrolyzed polyacrylamides (HPAM), and copolymers of 2-acrylamido-2-methylpropane sulfonic acid or sodium salt or mixtures thereof, and polyacrylamide (PAM) commonly referred to as AMPS copolymer and mixtures of the copolymers thereof. In one embodiment, the viscosity enhancing water-soluble polymer is polyacrylamide or a co-polymer of polyacrylamide. In one embodiment, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶ Daltons. In some other further embodiment, the viscosity enhancing water-soluble polymer has a molecular weight of approximately about 18×10⁶ Daltons. Non-limiting examples of commercially available polymers useful for the invention including embodiments provided herein are Florpaam 3330S and Florpaam 3360S. Molecular weights of the polymers may range from about 10,000 Daltons to about 20,000,000 Daltons. In some embodiments, the viscosity enhancing water-soluble polymer is used in the range of about 500 to about 5000 ppm concentration, such as from about 1000 to 2000 ppm (e.g., in order to match or exceed the reservoir oil viscosity under the reservoir conditions of temperature and pressure).

In certain embodiments, the aqueous composition does not include a viscosity enhancing polymer.

In some embodiments, the aqueous compositions can further include an alkali agent. An alkali agent as provided herein can be a basic, ionic salt of an alkali metal (e.g., lithium, sodium, potassium) or alkaline earth metal element (e.g., magnesium, calcium, barium, radium). Examples of suitable alkali agents include, for example, NaOH, KOH, LiOH, Na₂CO₃, NaHCO₃, Na-metaborate, Na silicate, Na orthosilicate, Na acetate or NH₄OH. The aqueous composition may include seawater, or fresh water from an aquifer, river or lake. In some embodiments, the aqueous composition includes hard brine water or soft brine water. In some further embodiments, the water is soft brine water. In some further embodiments, the water is hard brine water. Where the aqueous composition includes soft brine water, the aqueous composition can further include an alkaline agent. In soft brine water the alkaline agent can provide for enhanced soap generation from the active oils, lower surfactant adsorption to the solid material (e.g., rock) in the reservoir and increased solubility of viscosity enhancing water soluble polymers.

The alkali agent can be present in the aqueous composition at a concentration from about 0.1% w/w to about 10% w/w. The combined amount of alkali agent and compound provided herein (e.g., compound of Formula I, II, VIII, or IX) present in the aqueous composition provided herein can be approximately equal to or less than about 10% w/w. In some embodiments, the total concentration of alkali agent (i.e., the total amount of alkali agent within the aqueous compositions and emulsion compositions provided herein) in is from about 0.05% w/w to about 5% w/w. In other embodiments, the total alkali agent concentration in the aqueous composition is from about 0.25% w/w to about 5% w/w. In other embodiments, the total alkali agent concentration in the aqueous composition is about 0.5% w/w. In other embodiments, the total alkali agent concentration in the aqueous composition is about 0.75% w/w. In other embodiments, the total alkali agent concentration in the aqueous composition is about 1% w/w. In other embodiments, the total alkali agent concentration in the aqueous composition is about 1.25% w/w. In other embodiments, the total alkali agent concentration in the aqueous composition is about 1.50% w/w. In other embodiments, the total alkali agent concentration in the aqueous composition is about 1.75% w/w. In other embodiments, the total alkali agent concentration in the aqueous composition is about 2% w/w. In other embodiments, the total alkali agent concentration in the aqueous composition is about 2.25% w/w. In other embodiments, the total alkali agent concentration in the aqueous composition is about 2.5% w/w. In other embodiments, the total alkali agent concentration in the aqueous composition is about 2.75% w/w. In other embodiments, the total alkali agent concentration in the aqueous composition is about 3% w/w. In other embodiments, the total alkali agent concentration in the aqueous composition is about 3.25% w/w. In other embodiments, the total alkali agent concentration in the aqueous composition is about 3.5% w/w. In other embodiments, the total alkali agent concentration in the aqueous composition is about 3.75% w/w. In other embodiments, the total alkali agent concentration in the aqueous composition is about 4% w/w. In other embodiments, the total alkali agent concentration in the aqueous composition is about 4.25% w/w. In other embodiments, the total alkali agent concentration in the aqueous composition is about 4.5% w/w. In other embodiments, the total alkali agent concentration in the aqueous composition is about 4.75% w/w. In other embodiments, the total alkali agent concentration in the aqueous composition is about 5.0% w/w. In some embodiments, the alkali agent can be present in the aqueous compositions in an effective amount to afford an aqueous composition having a pH of from 9 to 12 (e.g., from 9.5 to 12, from 10 to 12, or from 10.5 to 11.5).

In certain embodiments, the aqueous composition does not include an alkali agent other than the compound of Formula I, II, VIII, or IX.

In some embodiments, the aqueous compositions can further include a cosolvent. In embodiments, the cosolvent is an alcohol, alcohol ethoxylate, glycol ether, glycols, or glycerol. The aqueous compositions provided herein may include more than one cosolvent. Thus, in embodiments, the aqueous composition includes a plurality of different cosolvents. Where the aqueous composition includes a plurality of different cosolvents, the different cosolvents can be distinguished by their chemical (structural) properties. For example, the aqueous composition may include a first cosolvent, a second cosolvent and a third cosolvent, wherein the first cosolvent is chemically different from the second and the third cosolvent, and the second cosolvent is chemically different from the third cosolvent. In embodiments, the plurality of different cosolvents includes at least two different alcohols (e.g., a C₁-C₆ alcohol and a C₁-C₄ alcohol). In embodiments, the aqueous composition includes a C₁-C₆ alcohol and a C₁-C₄ alcohol. In embodiments, the plurality of different cosolvents includes at least two different alkoxy alcohols (e.g., a C₁-C₆ alkoxy alcohol and a C₁-C₄ alkoxy alcohol). In embodiments, the aqueous composition includes a C₁-C₆ alkoxy alcohol and a C₁-C₄ alkoxy alcohol. In embodiments, the plurality of different cosolvents includes at least two cosolvents selected from the group consisting of alcohols, alkyl alkoxy alcohols and phenyl alkoxy alcohols. For example, the plurality of different cosolvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g., an alcohol) and optionally an alkoxy (ethoxylate or propoxylate) portion. Thus, in embodiments, the cosolvent is an alcohol, alkoxy alcohol, glycol ether, glycol or glycerol. Suitable cosolvents are known in the art, and include, for example, surfactants described in U.S. Patent Application Publication No. 2013/0281327 which is hereby incorporated herein in its entirety

In some embodiments, a cosolvent can be present in an amount sufficient to increase the solubility of the compound of Formula I, II, VIII, or IX in the aqueous phase realtive to the absence of the cosolvent. In other words, in the presence of a sufficient amount of the cosolvent, the solubility of the compound of Formula I, II, VIII, or IX in the aqueous phase is higher than in the absence of the cosolvent. In embodiments, the cosolvent can be present in an amount sufficient to increase the solubility of the surfactant in the aqueous phase relative to the absence of the cosolvent. Thus, in the presence of a sufficient amount of the cosolvent the solubility of the surfactant in the aqueous phase can be higher than in the absence of the cosolvent. In embodiments, the cosolvent can be present in an amount sufficient to decrease the viscosity of an emulsion formed from the composition relative to the absence of the cosolvent.

In other embodiments, the aqueous composition can be substantially free of cosolvents other than a compound of Formula I, II, VIII, or IX (e.g., the composition can include less than 0.05% by weight cosolvents, based on the total weight of the composition).

In some embodiments, the aqueous composition can further include a gas. For instance, the gas may be combined with the aqueous composition to reduce its mobility by decreasing the liquid flow in the pores of the solid material (e.g., rock). In some embodiments, the gas may be supercritical carbon dioxide, nitrogen, natural gas or mixtures of these and other gases.

In some embodiments, the aqueous composition can have a pH of at least 7 (e.g., a pH of at least 7.5, a pH of at least 8, a pH of at least 8.5, a pH of at least 9, a pH of at least 9.5, a pH of at least 10, a pH of at least 10.5, a pH of at least 11, a pH of at least 11.5, or a pH of at least 12.5). In some embodiments, the aqueous composition can have a pH of 13 or less (e.g., a pH of 12.5 or less, a pH of 12 or less, a pH of 11.5 or less, a pH of 11 or less, a pH of 10.5 or less, a pH of 10 or less, a pH of 9.5 or less, a pH of 9 or less, a pH of 8.5 or less, a pH of 8 or less, or a pH of 7.5 or less). The aqueous composition can have a pH ranging from any of the minimum values described above to any of the maximum values described above. For example, the aqueous composition can have a pH of from 7 to 13 (e.g., from 10 to 12, or from 10.5 to 11.5).

In some embodiments, the aqueous composition can have a salinity of less than 50,000 ppm. In other embodiments, the aqueous composition has a salinity of less than 25,000 ppm, less than 20,000 ppm, less than 15,000 ppm, less than 10,000 ppm, less than 7500 ppm, or less than 5,000 ppm. The total range of salinity (total dissolved solids in the brine) can be from 100 ppm to saturated brine (about 260,000 ppm). The aqueous composition may include seawater, brine or fresh water from an aquifer, river or lake. The aqueous combination may further include salt to increase the salinity. In some embodiments, the salt is NaCl, KCl, CaCl₂, MgCl₂, CaSO₄, Na acetate or Na₂CO₃.

In some embodiments, the aqueous composition can have a temperature of at least 20° C. (e.g., at least 30° C., at least 40° C., at least 50° C., at least 60° C., at least 70° C., at least 80° C., at least 90° C., at least 100° C., or at least 110° C.). The aqueous composition can have a temperature of 120° C. or less (e.g., 110° C. or less, 100° C. or less, 90° C. or less, 80° C. or less, 70° C. or less, 60° C. or less, 50° C. or less, 40° C. or less, or 30° C. or less). In some embodiments, the aqueous composition can have a temperature of greater than 120° C. The aqueous composition can have a temperature ranging from any of the minimum values described above to any of the maximum values described above. For example, the aqueous composition can have a temperature of from 20° C. to 120° C. (e.g., from 50° C. to 120° C., or from 80° C. to 120° C.).

In some embodiments, the aqueous composition can have a viscosity of between 20 mPas and 100 mPas at 20° C. The viscosity of the aqueous solution may be increased from 0.3 mPas to 1, 2, 10, 20, 100 or even 1000 mPas by including a water-soluble polymer. As mentioned above, the apparent viscosity of the aqueous composition may be increased with a gas (e.g., a foam forming gas) as an alternative to the water-soluble polymer.

Also provided are emulsions comprising (i) a compound of Formula I, II, VIII, or IX or an aqueous composition described herein and (ii) unrefined petroleum. In some embodiments, the emulsion composition can be a microemulsion. A “microemulsion” as referred to herein is a thermodynamically stable mixture of oil, water and surfactants that may also include additional components such as cosolvents, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the surfactant forms aggregates (e.g., micelles) where the hydrophilic part of the surfactant molecule(s) contacts the aqueous phase of the emulsion and the lipophilic part contacts the oil phase of the emulsion. Thus, in some embodiments, the surfactant(s) form part of the aqueous part of the emulsion. And in other embodiments, the surfactant(s) form part of the oil phase of the emulsion. In yet another embodiment, the surfactant(s) form part of an interface between the aqueous phase and the oil phase of the emulsion.

In other embodiments, the oil and water solubilization ratios are insensitive to the combined concentration of divalent metal cations (e.g., Ca²⁺ and Mg²⁺) within the emulsion composition. In other embodiments, the oil and water solubilization ratios are insensitive to the salinity of the water or to all of the specific electrolytes contained in the water. The term “insensitive” used in the context of this paragraph means that the solubilization ratio tends not to change (e.g., tends to remain constant) as the concentration of divalent metal cations and/or salinity of water changes. In some embodiments, the change in the solubilization ratios are less than 5%, 10%, 20%, 30%, 40%, or 50% over a divalent metal cation concentration range of 10 ppm, 100 ppm, 1000 ppm or 10,000 ppm. In another embodiment, the change in the solubilization ratios are less than 5%, 10%, 20%, 30%, 40%, or 50% over a salinity concentration range of 10 ppm, 100 ppm, 1000 ppm or 10,000 ppm.

Methods

In another aspect, a method of displacing a hydrocarbon material in contact with a solid material is provided. The method includes contacting a hydrocarbon material with a compound as described herein (e.g. a compound of Formula I, II, VIII, or IX), wherein the hydrocarbon material is in contact with a solid material. The hydrocarbon material is allowed to separate from the solid material thereby displacing the hydrocarbon material in contact with the solid material.

In other embodiments, the hydrocarbon material is unrefined petroleum (e.g., in a petroleum reservoir). In some further embodiments, the unrefined petroleum is a light oil. A “light oil” as provided herein is an unrefined petroleum with an API gravity greater than 30. In some further embodiments, the unrefined petroleum is a heavy oil. A “heavy oil” as provided herein is an unrefined petroleum with an API gravity less than 20. In some embodiments, the API gravity of the unrefined petroleum is less than 30. In other embodiments, the API gravity of the unrefined petroleum is less than 25. In some embodiments, the API gravity of the unrefined petroleum is less than 20. In other embodiments, the API gravity of the unrefined petroleum is less than 15. In some embodiments, the API gravity of the unrefined petroleum is less than 14. In other embodiments, the API gravity of the unrefined petroleum is less than 13. In some embodiments, the API gravity of the unrefined petroleum is less than 12. In other embodiments, the API gravity of the unrefined petroleum is less than 11. In other embodiments, the API gravity of the unrefined petroleum is less than 10. In other embodiments, the API gravity of the unrefined petroleum is less than 9. In other embodiments, the API gravity of the unrefined petroleum is less than 8. In some other embodiments, the API gravity of the unrefined petroleum is between 5 and 100, such as between 5 and 50, between 5 and 25, between 5 and 20, or between 5 and 15. In some embodiments, the hydrocarbon material is unrefined petroleum such as bitumen. Bitumen is regarded as a highly viscous oil having an API gravity in the range of about 5 to about 10.

In some embodiments, the hydrocarbon material is unrefined petroleum having a viscosity of at least 50 cp, at least 250 cp, such as at least 275 cp, at least 300 cp, at least 325 cp, at least 350 cp, at least 375 cp, at least 400 cp, at least 425 cp, at least 450 cp, at least 475 cp, at least 500 cp, at least 550 cp, at least 600 cp, at least 650 cp, at least 700 cp, at least 750 cp, at least 800 cp, at least 850 cp, at least 900 cp, at least 950 cp, at least 1000 cp, at least 1050 cp, at least 1100 cp, at least 1150 cp, at least 1200 cp, at least 1250 cp, at least 1500 cp, at least 2000 cp, at least 2500 cp, at least 3000 cp, at least 3500 cp, at least 4000 cp, at least 5000 cp, at least 6000 cp, at least 7000 cp, at least 8000 cp, at least 9000 cp, at least 10000 cp, at least 15000 cp, at least 20000 cp, at least 25000 cp, at least 30000 cp, at least 35000 cp, at least 40000 cp, at least 45000 cp, or at least 50000 cp. In some embodiments, the hydrocarbon material is unrefined petroleum having a viscosity of less than 50000 cp, less than 40000 cp, less than 30000 cp, less than 25000 cp, less than 20000 cp, less than 15000 cp, less than 10000 cp, less than 9000 cp, less than 8000 cp, less than 7000 cp, less than 6000 cp, less than 5000 cp, less than 4000 cp, less than 3500 cp, less than 3000 cp, less than 2500 cp, less than 2000 cp, less than 1500 cp, less than 1250 cp, less than 1000 cp, less than 900 cp, less than 800 cp, less than 750 cp, less than 700 cp, less than 650 cp, less than 600 cp, or less than 550 cp. In some embodiments, the hydrocarbon material is unrefined petroleum having a viscosity of from 50 to 100000 cp, from 50 to 50000 cp, from 300 to 10000 cp, from 300 to 5000 cp, from 300 to 1000 cp, from 400 to 1000 cp, from 400 to 450 cp, or from 500 to 700 cp. In general, heavy oil has a viscosity in-situ reservoir ranging from 50 to 50,000 cp.

In some embodiments, the hydrocarbon material is unrefined petroleum having a density of at least 500 kg/m³, such as at least 600 kg/m³, at least 650 kg/m³, at least 700 kg/m³, at least 750 kg/m³, at least 800 kg/m³, at least 850 kg/m³, at least 900 kg/m³, at least 950 kg/m³, at least 1000 kg/m³, at least 1050 kg/m³, or at least 1100 kg/m³. In some embodiments, the hydrocarbon material is unrefined petroleum having a density of less than 1000 kg/m³, less than 900 kg/m³, less than 800 kg/m³, less than 750 kg/m³, less than 700 kg/m³, less than 650 kg/m³, less than 600 kg/m³, or less than 550 kg/m³. In some embodiments, the hydrocarbon material is unrefined petroleum having a density of from 500 to 1000 kg/m³, from 600 to 1000 kg/m³, from 650 to 1000 kg/m³, from 750 to 1000 kg/m³, from 750 to 950 kg/m³, or from 800 to 900 kg/m³.

In some embodiments, the hydrocarbon material is unrefined petroleum having a total acid number (as measured in units of mg KOH/g-oil) of 10 or less, 9 or less, 8 or less, 7 or less, 6 or less, 5 or less, 4 or less, 3 or less, or 2 or less. The unrefined petroleum can have a total acid number (as measured in units of mg KOH/g) of 0.5 or more, 1 or more, 2 or more, 3 or more, 4 or more, 5 or more, 6 or more, 7 or more, 8 or more, 9 or more, or 10 or more. For example, the total acid number can be from 0.5 to 10, from greater than 1 to 10, from 2 to 10, from 3 to 10, from 3 to 7 or from 4 to 7.

In some examples, the hydrocarbon material includes a heavy oil having a total acid number of greater than 1 mg-KOH/g-oil (e.g., approximately 5 mg-KOH/g-oil), and a reservoir viscosity of greater than 250 cp (e.g., (about 500 cp). In these embodiments, the method can include an Alkaline Surfactant Polymer (ASP)-type process, an Alkaline Cosolvent Polymer (ACP)-type process, or Surfactant Polymer (SP)-type process, or a combination for recovery of the heavy oil from a reservoir. For example, heavy oil recovery by polymer flooding can be substantially enhanced by ultra-low interfacial tension (IFT) caused by the in-situ generation of natural surfactants through the reaction of acidic oil components with a compound of Formula I, II, VIII, or IX described herein. In this process, injection of a slug (e.g., 0.2, 0.3, 0.4, from 0.2 to 2 pore-volumes) of a compound of Formula I, II, VIII, or IX solution is followed by polymer with a salinity gradient.

In some examples, the hydrocarbon material can include bitumen. The methods can be conducted at 368 K or less, at which bitumen has a viscosity of about 276 cp at 368 K. The SARA composition of bitumen is 24.5 wt % saturates, 36.6 wt % aromatics, 21.1 wt % resins, and 17.8 wt % asphaltenes (n-pentane insoluble). The acid number of bitumen is about 3 mg-KOH/g-oil or greater.

The solid material may be a natural solid material (i.e., a solid found in nature such as rock). The natural solid material may be found in a petroleum reservoir. In some embodiments, the method is an enhanced oil recovery method. Enhanced oil recovery methods are well known in the art. A general treatise on enhanced oil recovery methods is Basic Concepts in Enhanced Oil Recovery Processes edited by M. Baviere (published for SCI by Elsevier Applied Science, London and New York, 1991). For example, in an enhanced oil recovery method, the displacing of the unrefined petroleum in contact with the solid material is accomplished by contacting the unrefined with a compound provided herein, wherein the unrefined petroleum is in contact with the solid material. The unrefined petroleum may be in an oil reservoir. The compound or composition provided herein can be pumped into the reservoir in accordance with known enhanced oil recovery parameters. The compound can be pumped into the reservoir as part of the aqueous compositions provided herein and, upon contacting the unrefined petroleum, form an emulsion composition provided herein.

In some embodiments, the natural solid material can be rock or regolith. The natural solid material can be a geological formation such as elastics or carbonates. The natural solid material can be either consolidated or unconsolidated material or mixtures thereof. The hydrocarbon material may be trapped or confined by “bedrock” above or below the natural solid material. The hydrocarbon material may be found in fractured bedrock or porous natural solid material. In other embodiments, the regolith is soil.

In some embodiments, an emulsion forms after the contacting step. The emulsion thus formed can be the emulsion described above. In some embodiments, the method includes allowing an unrefined petroleum acid within the unrefined petroleum material to enter into the emulsion, thereby converting the unrefined petroleum acid into a surfactant. In other words, where the unrefined petroleum acid converts into a surfactant it is mobilized and therefore separates from the solid material.

In another aspect, a method of converting (e.g., mobilizing) an unrefined petroleum acid into a surfactant is provided. The method includes contacting a petroleum material with an aqueous composition thereby forming an emulsion in contact with the petroleum material, wherein the aqueous composition includes the compound described herein (e.g. a compound of Formula I, II, VIII, or IX) and optionally a surfactant. Thus, in some embodiments, the aqueous composition is the aqueous composition described above. An unrefined petroleum acid within the unrefined petroleum material is allowed to enter into the emulsion, thereby converting the unrefined petroleum acid into a surfactant. In some embodiments, the reactive petroleum material is in a petroleum reservoir. In some embodiments, as described above and as is generally known in the art, the unrefined petroleum acid is a naphthenic acid. In some embodiments, as described above and as is generally known in the art, the unrefined petroleum acid is a mixture of naphthenic acid. In some embodiments, the aqueous composition further includes an alkali agent.

In another aspect, a method of reducing the viscosity of a hydrocarbon material such as an unrefined petroleum acid is provided. The method includes contacting the hydrocarbon material with an aqueous composition thereby forming an emulsion in contact with the hydrocarbon material, wherein the aqueous composition includes the compound described herein (e.g. a compound of Formula I, II, VIII, or IX) and optionally a surfactant. Thus, in some embodiments, the aqueous composition is the aqueous composition described above. In some embodiments, the hydrocarbon material such as unrefined petroleum (including heavy and extra heavy crude oil in its natural form) can have a density from about 7 to about 14 degrees API, and a viscosity from about 50 to about 10⁶ cP or from about 500 to about 10⁶ cP or from about 10³ to about 10⁶ cP at 25 degrees centigrade. Due to the relatively low API gravity and high viscosity of crude oil, it takes an extraordinary amount of energy to pump the crude oil in its natural form, if it can be pumped at all. The methods disclosed herein provides methods of making oil-in-water emulsions to lower the viscosity of the crude oil to make it more pumpable, thus requiring less energy during transport. The methods disclosed herein can reduce the viscosity of an unrefined petroleum, such as crude oil by at least 5%, at least 10%, at least 15%, at least 20%, at least 25%, or at least 30%.

In another aspect, a method of transporting a hydrocarbon material such as unrefined petroleum in a transport vessel comprising contacting the hydrocarbon material with an aqueous composition comprising an effective amount of a compound having a structure of Formula I or Formula II to form a mixture, and transporting the mixture in the transport vessel from a first point to a second point is provided. A “transport vessel” as used herein, refers to a container used for transporting oil, typically large amounts of oil (e.g. at least hundreds of gallons, at least thousands of gallons, at least millions of gallons or at least billions of gallons). A transport vessel includes a storage vessel contained within a petroleum tanker (oil tankers), barge, truck or a train. A transport vessel also includes a petroleum pipeline (oil pipeline). Accordingly, a method of transporting a hydrocarbon material through a pipeline comprising contacting the hydrocarbon material with an aqueous composition comprising an effective amount of a compound having a structure of Formula I or Formula II to form a mixture, and pumping the mixture through the pipeline from a first point to a second point along the pipeline is provided.

In some embodiments, the mixture comprising the hydrocarbon material and aqueous composition can be in the form of an emulsion, such as a microemulsion. After the emulsion reaches its destination for further processing, the emulsion is separated or broken. In some embodiments, to break the emulsion, an emulsion breaker is added to the emulsion. The emulsion breaker can include a salt of a divalent cation, such as calcium chloride. The emulsion breaks, separating part or almost all the water content. The separated emulsion can then be stored or sent to a separation tank for further processing and separation.

In another aspect, a method of making a compound as described herein (e.g. a compound of Formula I, II, VIII, or IX) is provided. The methods can include contacting a suitable alcohol precursor for compound of Formula I, II, VIII, or IX (e.g., phenol or a C₆-C₁₀ alcohol) with a propylene oxide thereby forming a first alkoxylated hydrophobe. The first alkoxylated hydrophobe can subsequently be contacted with an ethylene oxide thereby forming a second alkoxylated hydrophobe. The second alkoxylated hydrophobe can then be contacted with one or more anionic functional groups thereby forming a compound of Formula I. In some embodiments, the contacting is performed at an elevated temperature.

By way of non-limiting illustration, examples of certain embodiments of the present disclosure are given below.

### EXAMPLES

The examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, percents associated with components of compositions are percents by weight, based on the total weight of the composition including the components, temperature is in ° C. or is at ambient temperature, and pressure is at or near atmospheric.

### Example 1: Application of New Surface Active Agents with Cosolvent Character for Heavy Oil Recovery

Abstract. A new class of ultra-short hydrophobe surface active non-ionics (SANI) with cosolvent character was investigated as a sole additive to conventional polymer flooding for heavy oil recovery. No alkali was used for emulsification. The surface active agents tested are composed of a short hydrophobe (phenol in this example) extended by a small number of propylene oxide (PO) and sufficient ethylene oxide (EO) units to achieve aqueous stability: phenol-xPO-yEO. Results are presented for the selection of ultra-short hydrophobe surface active agents, aqueous stability, emulsion phase behavior, and oil-displacement through a glass-bead pack at 368 K.

Results show that 2 wt % phenol-4PO-20EO was able to reduce the interfacial tension between oil and NaCl brine to 0.39 dynes/cm, in comparison to 11 dynes/cm with no surface active agent, at 368 K. Water flooding, 70-cp polymer flooding, and surface active agent-improved polymer flooding were conducted for displacement of 276-cp oil through a glass-bead pack that represents the clean-sand faces of a heavy oil reservoir in Alberta, Canada. The oil recovery at 2 pore-volumes of injection was 84% with the surface active agent-improved polymer flooding, which was 54% and 22% greater than the water flooding and the polymer flooding, respectively. Results suggest a new opportunity of enhanced heavy oil recovery by adding a slug of one non-ionic surface active agent with cosolvent character to conventional polymer flooding.

Introduction: The U.S. Geological Survey estimated that there exist more than 3,300 billion bbls of heavy oil and 5,500 billion bbls of bitumen resources in the world, and that approximately 34% of the total heavy oil and bitumen resources are distributed in North America (USGS 2007). The efficiency of heavy oil recovery is strongly affected by the viscosity of in-situ reservoir oil typically ranging from 50 to 50,000 cp (Bryan and Kantzas 2007). Canadian extra-heavy oil or bitumen is even more viscous (Baek et al. 2018a). Widely-used recovery methods for heavy oil include cyclic steam stimulation and steam-assisted gravity drainage. However, these methods may be inefficient and/or impractical for shallow and/or thin reservoirs, including many heavy oil reservoirs in Alaska and Canada (Liu et al. 2006; Bryan and Kantzas 2007).

Polymer flooding is another method that has been widely used for heavy oil recovery, in which the displacing phase with an increased viscosity improves conformance control under reservoir heterogeneity and lowers the mobility ratio for oil displacement. Field pilots of polymer flooding include East Bodo (Wassmuth et al. 2009), Suffield Caen (Liu et al. 2012), and Seal (Murphy Oil Corporation 2016) in Canada. A large-scale polymer flooding was successfully conducted in Pelican Lake in Canada (Delamaide et al. 2014a). In the Pelican Lake case, the incremental oil recovery after polymer flooding was 10-25% of the original oil in place (OOIP), in which heavy oil of 800-10,000 cp was displaced by polymer of 20-25 cp (Delamaide et al. 2014b). Polymer flooding was performed in an offshore heavy oil field in Bohai Bay in China (Kang et al. 2011). After 3 years of polymer flooding, however, the incremental oil recovery was reported to be approximately 4%. Thereafter, surfactant-polymer (SP) flooding was implemented (Lu et al. 2015).

Heavy oils typically contain acidic hydrocarbon components, part of which can be used as natural surfactants after the mixing and reaction with alkalis, such as sodium carbonate, sodium hydroxide, ethanolamine, ammonium hydroxide (Baek et al. 2018b; Fu et al. 2016; Sharma et al. 2015). Therefore, alkali-surfactant-polymer (ASP) flooding has been studied for heavy oil recovery. ASP flooding is designed to achieve Winsor Type III microemulsion phase behavior (Winsor 1948) during the oil displacement, with in-situ natural surfactants, synthetic surfactants, cosolvent, and other additives (Lake et al. 2014; Sheng 2014). An optimal ASP flooding achieves a high displacement efficiency by microemulsion phase behavior with ultra-low interfacial tension (IFT), and a high volumetric sweep efficiency by use of polymer.

Conventional screening criteria indicate that ASP flooding can be used effectively when the oil viscosity is below 200 cp (Sheng 2013). Sheng (2014) reported 32 field projects of ASP flooding, most of which were in China (19 projects) with oil viscosities lower than 50 cp. ASP flooding, however, has been also studied for more viscous oil. Laboratory experimental results show a substantial incremental oil recovery by ASP flooding for oils with viscosities from 320 cp to 500 cp (Aitkulov et al. 2017; Kumar and Mohanty 2010; Shamekhi et al. 2013), 2,000-cp oil (Zhang et al. 2012) and 16,000-cp oil (Shamekhi et al. 2013). ASP floods for heavy oil in Canada include Taber South (Husky), Crowsnest (Husky), Shuffield (Cenovus), and Mooney (BlackPearl). The ASP flooding resulted in an incremental recovery of 11.1% of the OOIP for 120-cp oil in Taber South (McInnis et al. 2013), 10% for 480-cp oil in Shuffield (Cenovus Energy. 2012), and 9% for 440-cp oil in Mooney (Delamaide 2017; Watson et al. 2014).

Reported issues of ASP flooding include insufficient injectivities caused by calcite and silica scales, which were attributed partly to the injected alkalis (Delamaide 2014; Hocine et al. 2014). For example, Alberta Energy Regulator (2012) reported the scale plugging and injectivity problems in the ASP flooding projects in Taber South (Husky) and Suffield (Cenovus). To avoid the problems of alkali injection, there have been a limited number of laboratory-scale experimental studies of SP flooding for heavy oil recovery (Feng et al. 2012; Hocine et al. 2014). They used self-assembled betaine surfactants (Feng et al. 2012) and a mixture of olefin sulfonates, alkyl aryl sulfonates, alkyl ether sulfates, and alkyl glyceryl ether sulfonates (Hocine et al. 2014) that created ultra-low IFT microemulsions with their heavy oil without using alkali.

ASP flooding may involve a large number of chemicals to be injected, which tends to make the implementation of ASP flooding more complicated and costly. Alkali-cosolvent-polymer (ACP) flooding has been recently studied as a simpler alternative for heavy oils, in which only alkali and cosolvent were injected with no synthetic surfactant (Aitkulov et al. 2017; Fortenberry et al. 2015; Sharma et al. 2018). They used iso-butanol (IBA), alkoxylated IBA (e.g. IBA-2EO, IBA-5EO, IBA-10EO, IBA-2PO), alkoxylated phenol (phenol-1PO-2EO) as cosolvents. Their results show ultra-low IFT microemulsions at experimental conditions and highly efficient corefloods.

Upamali et al. (2018) recently investigated the potential advantage of using short-hydrophobe cosolvents and surfactants. They used alkoxylated IBA (IBA-3EO, IBA-10EO, IBA-30EO, and IBA-1PO-2EO) and alkoxylated phenol (phenol-1PO-2EO, phenol-1PO-5EO, phenol-2EO, and phenol-4EO) as cosolvent for conventional surfactants, and achieved ultra-low IFT type III microemulsion phase behavior. They also used alkoxylated 2-ethylhexanol (2-EH-7PO-SO₄) as a surfactant along with a conventional surfactant to show ultra-low IFT type III microemulsion phase behavior. According to their study, the advantages of short-hydrophobe cosolvents and surfactants include short equilibrium time for microemulsion formation, low microemulsion viscosity, and low retention in cores.

Previous studies of short-hydrophobe cosolvents and surfactants were focused on ASP or alkali-cosolvent-polymer (ACP) flooding that achieves an ultra-low IFT between the displaced and displacing phases (Aitkulov et al. 2017; Fortenberry et al. 2015; Upamali et al. 2018; Sharma et al. 2018). Their aqueous formulations consisted of an alkali, one or more surfactants, and cosolvents for ASP flooding, and an alkali with one or more cosolvents for ACP flooding.

This example presents the first investigation into the application of ultra-short hydrophobe surface active agents as a sole chemical additive that improves the displacement efficiency of polymer flooding for heavy oil recovery. Use of ultra-short hydrophobe surface active agent with no alkali is not expected to achieve ultra-low IFT with heavy oil. Hence, the proposed method may be more properly denoted as “SANI-improved polymer flooding” than surfactant-polymer (SP) flooding which achieves ultra-low IFT between the displacing and displaced phases.

Described below are the materials used for this example. Also presented is the phase behavior of heavy-oil emulsification with new surface active agents. Results of oil-displacement experiments are presented herein.

Materials: This section describes the materials for two types of experiments: phase behavior and displacement experiments. Materials for phase behavior experiments include oil, brine, and surface active agent. In addition to these, a porous medium and polymer are explained for the displacement experiments.

Oil. Dehydrated Athabasca bitumen was used as the heavy oil in this research. The experiments were conducted at 368 K, at which the oil viscosity was measured to be 276 cp. The SARA composition is 24.5 wt % saturates, 36.6 wt % aromatics, 21.1 wt % resins, and 17.8 wt % asphaltenes (n-pentane insoluble). The acid number of bitumen was measured to be 3.56 mg-KOH/g-oil based on the method of Fan and Buckley (2007). More data of this oil sample can be found in Baek et al. (2018a).

Brine. The initial and injection water were 5 wt % NaCl and 0.1 wt % NaCl, respectively. The simple brine composition with no hardness allowed evaluating the effect of surface active agenton heavy oil recovery.

Surface active agent, surface active agent were made by alkoxylation of phenol; i.e. phenol-xPO-yEO, where x is the number of propylene oxide (PO) and y is the number of ethylene oxide (EO). In this example, x and y were set to be 4-7 and 5-40, respectively. Phenol-xPO-yEO surface active agent were provided by HARCROS Chemicals. Below is an explanation of the selection of this ultra-short hydrophobe surface active agent for this example.

Phenol was selected as the basis for the surface active agent's hydrophobicity. Its aromatic structure is known to be compatible with asphaltene-rich heavy oil because the steric effect of the benzene ring can reduce the size of asphaltic components' aggregation (Larichev et al. 2016). Larichev et al. (2016) presented that planar molecules (e.g., cyclic structures) could fit into the asphaltene structure and replace asphaltene molecules with relatively small hydrocarbons.

The alkoxylation of phenol causes surface active properties and aqueous stability. The PO and EO groups are related to hydrophobicity and aqueous stability of a surfactant, respectively. A larger number of PO results in a higher level of hydrophobicity. Depending on brine salinity, brine hardness, and temperature, EO number should be adjusted for aqueous stability. Chang et al. (2018) discussed details of alcohol alkoxylated and other surfactants along with cosolvents.

In this example, attempt to minimize the PO and EO numbers added to phenol to test ultra-short hydrophobe surface active agents for improved polymer flooding for heavy oil recovery was performed. Phenol-1PO-xEO studied by Upamali et al. (2018) and Sharma et al. (2018) did not give desirable emulsion phase behavior with the heavy oil studied in this research. It was found that four is the minimum PO number to create o/w emulsions with the heavy oil studied. Therefore, the PO numbers of 4 and 7 were investigated. Then, the EO numbers ranged from 5 to 30 for phenol-4PO-yEO and from 5 to 40 for phenol-7PO-yEO.

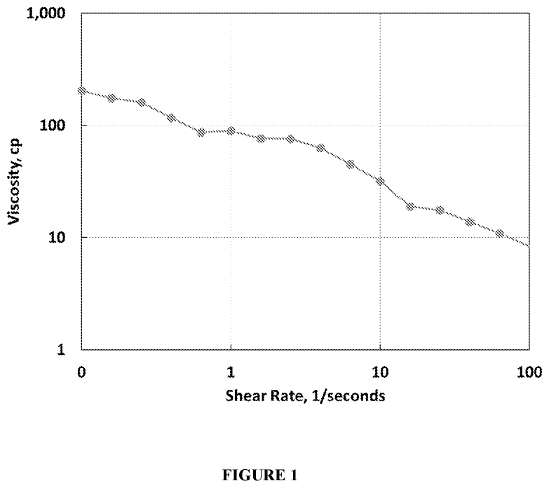

Polymer. Hydrolyzed polyacrylamide (HPAM) polymer, Flopaam 3630S, was used for polymer flooding and improved-polymer flooding with the glass-bead pack described below. The polymer concentration was 0.22 wt %, which gave the viscosity of approximately 70 cp at injection conditions, corresponding to the field conditions of interest (4 times less viscous than the displaced oil). FIG. 1 gives the measured viscosities of the polymer solution at different shear rates at 368 K.

Glass-Bead Pack. A cylinder was packed with glass beads as a porous medium. The cylinder is 50-cm long, and its internal volume is 8.2 ml. The porous medium contained particles with diameters ranging from 106 μm to 125 μm (sieve number 120). The porosity and permeability of the porous media were measured to be 34% and 9.5 Darcy, respectively, representing the clean-sand faces of a heavy oil reservoir in Alberta, Canada.

Phase-Behavior Experiments: An optimal surface active agent was selected among phenol-4PO-yEO (y=5, 10, 15, 20, 25, and 30) and phenol-7PO-yEO (y=5, 10, 15, 20, 30, and 40) by conducting aqueous stability tests first, and then emulsion phase behavior tests at 368 K. Phenol-4PO-20EO was eventually selected for the subsequent displacement experiments (Section 4). This section presents the main results in these screening steps.

The total of 12 surface active agents were subject to aqueous stability tests at 3 surface active agent concentrations (0.5, 1, and 2 wt %) in the injection brine (0.1 wt % NaCl). Samples were aged at 4 different temperatures (298, 313, 353, and 368 K) for 2 days. Aqueous stability was confirmed by visual observation as to whether the solution was clear or cloudy (opaque), and whether it showed any phase separation. Table 1 shows that 6 surface active agents passed the aqueous stability test at 368 K, the temperature for the subsequent displacement experiments. They are phenol-4PO-yEO (y=15, 20, 25, and 30) and phenol-7PO-yEO (y=30 and 40).

TABLE 1
Aqueous stability test of surface active non-ionic
(SANI) agents. Aqueous brine salinity was 0.1 wt %.

| | | | Stability: S (stable), C (cloudy), PS (phase separation) | | | |
|---|---|---|---|---|---|---|
| | SANI | | Temperature | | | |
| SANI | Concentration | | 298 K | 313 K | 353 K | 368 K |
| Phenol-4PO-5EO | 0.5 | wt % | S | S | C | C |
| | 1 | wt % | S | C | C | C |
| | 2 | wt % | S | C | C | PS |
| Phenol-4PO-10EO | 0.5 | wt % | S | S | S | C |
| | 1 | wt % | S | S | C | C |
| | 2 | wt % | S | S | C | C |
| Phenol-4PO-15EO | 0.5 | wt % | S | S | S | S |
| | 1 | wt % | S | S | S | C |
| | 2 | wt % | S | S | S | C |
| Phenol-4PO-20EO | 0.5 | wt % | S | S | S | S |
| | 1 | wt % | S | S | S | S |
| | 2 | wt % | S | S | S | S |
| Phenol-4PO-25EO | 0.5 | wt % | S | S | S | S |
| | 1 | wt % | S | S | S | S |
| | 2 | wt % | S | S | S | S |
| Phenol-4PO-30EO | 0.5 | wt % | S | S | S | S |
| | 1 | wt % | S | S | S | S |
| | 2 | wt % | S | S | S | S |
| Phenol-7PO-5EO | 0.5 | wt % | S | C | PS | PS |
| | 1 | wt % | C | C | PS | PS |
| | 2 | wt % | C | C | PS | PS |
| Phenol-7PO-10EO | 0.5 | wt % | S | S | PS | PS |
| | 1 | wt % | S | C | PS | PS |
| | 2 | wt % | S | S | PS | PS |
| Phenol-7PO-15EO | 0.5 | wt % | S | S | C | PS |
| | 1 | wt % | S | S | S | PS |
| | 2 | wt % | S | S | S | PS |
| Phenol-7PO-20EO | 0.5 | wt % | S | S | S | PS |
| | 1 | wt % | S | S | S | PS |
| | 2 | wt % | S | S | S | PS |
| Phenol-7PO-30EO | 0.5 | wt % | S | S | S | S |
| | 1 | wt % | S | S | S | S |
| | 2 | wt % | S | S | S | S |
| Phenol-7PO-40EO | 0.5 | wt % | S | S | S | S |
| | 1 | wt % | S | S | S | S |
| | 2 | wt % | S | S | S | S |

These surface active agents were subject to emulsion phase behavior tests with mixtures of oil/surface active agent/brine. The objective was to find low-IFT oil-in-water (o/w) emulsions at 365 K. For each sample, 4 ml of the solution was prepared in an 8-ml borosilicate test tube. Samples were prepared at 3 different surface active agent concentrations (0.5, 1, and 2 wt % in aqueous phase) with 6 different salinities (0, 0.1, 0.5, 1, 2, and 3 wt % NaCl). Water-oil-ratio (WOR) was fixed at 7:3 (i.e., 70 vol % aqueous phase and 30 vol % oil). Samples were aged at 368 K for 5 days before reporting the phase behavior.

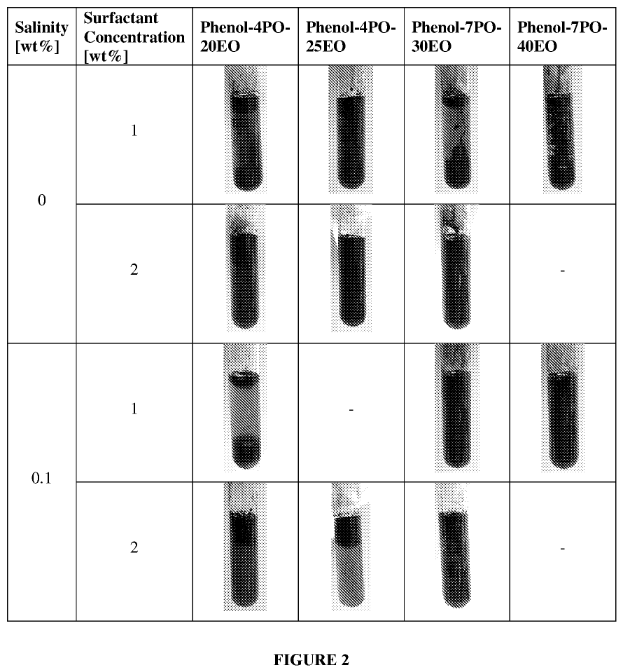

Table 2 presents that 13 samples with 4 surface active agent S resulted in low IFT o/w emulsions: phenol-4PO-yEO, where y=20 and 25, and phenol-7PO-yEO, where y=30 and 40. FIG. 2 shows these o/w emulsion samples. These samples were then evaluated by visual observation in terms of fluidity, color, and droplet size in the emulsion phase. It was determined that phenol-4PO-20EO and phenol-7PO-30EO were the most suitable surface active agents, but the former was selected for further analysis because of the shorter hydrophobe. The solution of 2 wt % phenol-4PO-20EO with 0.1 wt % NaCl brine was selected as the injection surface active agent solution viscosified by polymer for the subsequent displacement experiments.

TABLE 2
General phase behavior of oil emulsification with new surface active agents. Samples
were aged at 368 K. Only 4 surface active agentsresulted in low IFT o/w emulsion.

| Phenol-4PO-xEO | | | | | Phenol-7PO-xEO | | | | |
|---|---|---|---|---|---|---|---|---|---|
| | Salinity | SANI Concentration [wt %] | | | | Salinity | SANI Concentration [wt %] | | |
| EO # | [wt %] | 0.5 | 1.0 | 2.0 | EO# | [wt %] | 0.5 | 1.0 | 2.0 |
| 15 | 0 | | | | 30 | 0 | N | o/w | o/w |
| | 0.1 | | | | | 0.1 | N | o/w | o/w |
| | 0.5 | | | | | 0.5 | N | N | N |
| | 1 | | | | | 1 | N | N | N |
| | 2 | | | | | 2 | N | N | N |
| | 3 | | | | | 3 | N | N | N |
| 20 | 0 | N | o/w | o/w | 40 | 0 | N | o/w | o/w |
| | 0.1 | N | o/w | o/w | | 0.1 | N | N | N |
| | 0.5 | N | N | N | | 0.5 | N | N | N |
| | 1 | N | N | N | | 1 | N | N | N |
| | 2 | N | N | N | | 2 | N | N | N |
| | 3 | N | N | N | | 3 | N | N | N |

| | | | | |
|---|---|---|---|---|
| 25 | 0 | N | o/w | o/w |
| | 0.1 | N | N | o/w |
| | 0.5 | N | N | N |
| | 1 | N | N | N |
| | 2 | N | N | N |
| | 3 | N | N | N |
| 30 | 0 | N | N | N |
| | 0.1 | N | N | N |
| | 0.5 | N | N | N |
| | 1 | N | N | N |
| | 2 | N | N | N |
| | 3 | N | N | N |

(o/w = o/w emulsion/N = no emulsion/Blank = not tested)

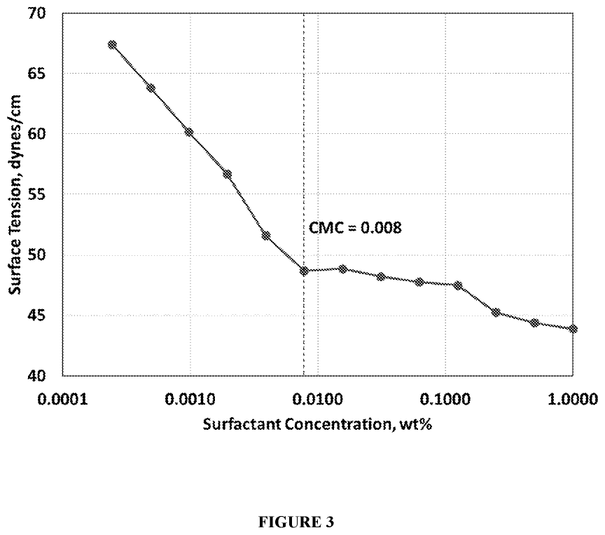

The critical micelle concentration (CMC) for phenol-4PO-20EO was measured to be 0.008 wt % by the pendant drop method, as shown in FIG. 3. The IFT between the selected surface active agent solution and oil were measured to be approximately 0.39 dynes/cm at 368 K by the spinning drop method. In comparison, the IFT between oil and 0.1 wt % NaCl brine at 368 K is approximately 11 dynes/cm (Isaacs and Smolek 1983). Although it is not ultra-low, the IFT value of 0.39 dynes/cm is much lower than when the surface active agent is not used. Indeed, it was observed that the emulsion and excess oil phases (FIG. 2) mixed quite easily when it was flowing. Based on the method introduced in Kumar et al. (2012), the excess oil phase in the sample was confirmed to be oil-external, because it dissolved in toluene, but not in water.

The oil concentration in the emulsion phase with 2 wt % phenol-4PO-20EO was measured to be less than 1 vol %. The emulsion phase was actually transparent, light brown liquid. It is likely that the viscosity of this emulsion is similar to the viscosity of the external phase (brine or polymer).

Oil-Displacement Experiments and Simulation: This section presents oil-displacement experiments with the polymer solution with 2 wt % phenol-4PO-20EO and 0.1 wt % NaCl brine at 368 K. Experimental results were matched by using the UTCHEM chemical flooding simulator.

Experimental Procedure: Water flooding, polymer flooding, and improved polymer flooding by adding phenol-4PO-20EO were conducted. With the objective of quantifying the incremental recoveries by polymer and by surface active agent-improved polymer, all displacements were conducted in the secondary-recovery mode. Table 3 lists the injection fluids for the three cases. The short-hydrophobe surface active agent was injected as part of two pore volumes of polymer solution for the surface active agent-improved polymer flooding in this experiment, but it would be a slug for oil-displacement fronts in field applications.

TABLE 3
Summary of oil-displacement experiments.

| | | | | Polymer | | SANI-Improved | |
|---|---|---|---|---|---|---|---|
| Experiment | | Water Flooding | | Flooding | | Polymer Flooding | |
| Glass-bead pack | Porosity | 35% | | 33% | | 33% | |
| | Permeability | 9.65 | Darcy | 9.49 | Darcy | 9.45 | Darcy |
| | Oil Viscosity at 368 K | 276 | cp | 276 | cp | 276 | cp |
| | Initial Brine Salinity | 5 | wt % NaCl | 5 | wt % NaCl | 5 | wt % NaCl |
| Injection Fluids | Brine | 0.1 | wt % NaCl | 0.1 | wt % NaCl | 0.1 | wt % NaCl |

| (Secondary | Polymer | N/A | 0.22 wt % | | 0.22 wt % | |
|---|---|---|---|---|---|---|
| Flooding) | | | Flopaam 3630S | | Flopaam 3630S | |
| | SANI | N/A | N/A | | 2 wt % Phenol- | |
| | | | | | 4PO-20EO | |
| | Viscosity at shear rate | N/A | 75 | cp | 75 | cp |
| | 2.5 seconds⁻¹ | | | | | |

| | | | | | | |
|---|---|---|---|---|---|---|
| Injection Rate | 0.2 | ml/hr | 0.2 | ml/hr | 0.2 | ml/hr |
| PV Injected | 2 | PVI | 2 | PVI | 2 | PVI |
| Water Breakthrough | 0.2 | PVI | 0.5 | PVI | 0.7 | PVI |

| | | | |
|---|---|---|---|
| Oil Recovery at 2 PVI | 30% | 62% | 84% |

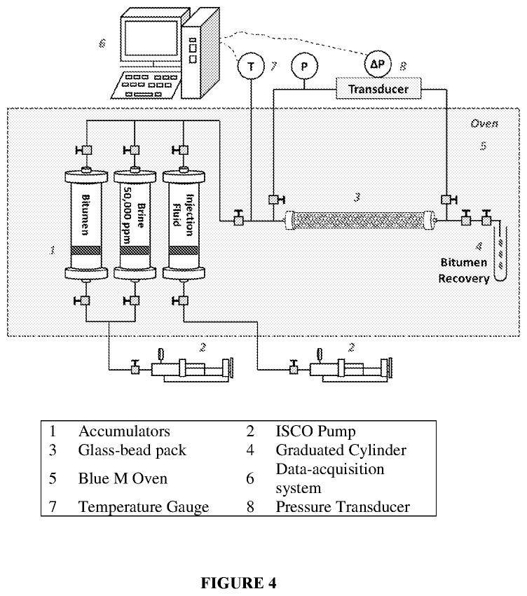

FIG. 4 shows a schematic of the experimental setup. There were three accumulators for oil, initial reservoir brine (5.0 wt % NaCl), and injection brine (0.1 wt % NaCl). Pressure and flow rate of these fluids were controlled by ISCO pumps. The system temperature was kept at 368 K in a Blue-M oven. System pressure and temperature were monitored and recorded by a data-acquisition system.

First, the porous medium and all flow-lines were cleaned with toluene and dried at 368 K for at least one day. After that, the system was evacuated for at least two hours. Then, the glass-bead pack was saturated with reservoir brine (5.0 wt % NaCl). Based on the volume injected, the pore volume of the glass-bead pack was measured. Reservoir brine was injected for several pore volumes to calculate the permeability of the glass-bead pack with Darcy's equation. Thereafter, the oil was injected. Reservoir brine was collected from the outlet during the oil injection. Oil breakthrough and water recovery were measured to determine the initial oil and water saturations for the subsequent oil-displacement experiment. Several pore volumes of oil were injected to estimate the end-point relative permeability to oil.

After the preparation, each oil-displacement experiment used a total of 2.0 pore volumes of injection fluid at an injection rate of 0.2 ml/hr, which corresponds to 1.0 ft/day in the porous medium. The corresponding shear rate in the porous medium was approximately 2.5 second⁻¹. Oil recovery was measured by a graduated cylinder at the effluent. After 2.0 pore volumes of injection (PVI), more than 200 ml of injection fluid was additionally injected to estimate the end-point relative permeability to the injection fluid.

Oil-Displacement Results: The two rows from the bottom in Table 3 give a summary of results from the oil displacements. FIG. 5 presents the cumulative oil recovery for each flooding experiment. The water flooding case defines the basis for evaluating the polymer flooding, which in turn gives the basis for evaluating the surface active agent-improved polymer flooding. The oil recovery at 2.0 PVI was 30% for the water flooding case, 62% for the polymer flooding case, and 84% for the surface active agent-improved polymer flooding. That is, the surface active agent added to the polymer solution yielded an incremental recovery of 22% in comparison to the polymer flooding case.

The water flooding showed the water breakthrough at 0.2 PVI, which resulted from the adverse effect of low-viscosity water on the efficiency of oil displacement by water. The polymer flooding case showed a delayed breakthrough around 0.5 PVI, which resulted in a twofold increase in oil recovery at 2.0 PVI in comparison to the water flooding case. The surface active agent-improved polymer flooding showed the breakthrough around 0.7 PVI resulting in the aforementioned increase in oil recovery by 22% in comparison to the polymer flooding. This improvement by the surface active agent addition to polymer was attributed to the lowered IFT (section 3) because that is the main difference from the polymer-alone injection. Note that the small amount of oil in the low-IFT o/w emulsions unlikely affected the viscosity (see section 3). The effect of lowered IFT on polymer flooding was confirmed by matching experimental results with an in-house simulator, UTCHEM (Delshad et al. 1996), as shown in FIG. 5.

The results in this example suggest a potential opportunity of enhanced heavy oil recovery by using a simple non-ionic surface active agent as a sole additive to widely-used polymer flooding. The proposed method relies on the effect of ultra-short hydrophobe surface active agents on oil displacement efficiency. The ultra-short hydrophobe surface active agents are designed to have multiple functions in one compound. That is, it has characters of cosolvent (i.e., phenol in this paper), and its PO and EO units respectively give the hydrophobicity and hydrophilicity. The aqueous stability of the surface active agent at the desired temperature and brine composition can be found by changing the EO number. As shown with phenol-xPO-yEO in this paper, the optimal selection of surface active agents for a given oil displacement can be done in a systematic manner.

Unlike the conventional SP and ASP flooding, the proposed method of enhanced heavy oil recovery does not achieve ultra-low IFT (e.g., 10⁻³ dynes/cm); however, the use of only one additive to traditional polymer flooding yields the simplicity of the method implementation. In general, ASP flooding requires more than four types of chemicals: alkali, polymer, surfactant, and cosolvent. The design and implementation become inevitably more complicated as the number of additives increases. Also, the ultra-short hydrophobe surface active agents are relatively less expensive than conventional surfactants; for example, the cost is expected to be about 1.25 USD/lb (100% active basis) because of the base solvent (e.g., phenol in this paper) is not expensive. Furthermore, the ultra-short hydrophobe surface active agents are expected to be less affected by surfactant loss due to the adsorption on rock surfaces (Fortenberry et al. 2015; Upamali et al. 2018). This would also contribute to simpler and less expensive implementation.

Summary: This paper presented an experimental study of phenol-xEO-yPO surface active agents as a sole additive to conventional polymer flooding for heavy oil recovery. Optimal EO and PO numbers were found in terms of emulsion phase behavior and aqueous stability at 368 K. Displacements of heavy oil (276 cp at 368 K) through a glass-bead pack were conducted by water flooding, polymer flooding, and surface active agent-improved polymer flooding. These oil displacements were compared to quantify the effect of the simple non-ionic surface active agents with the cosolvent character on heavy-oil displacement efficiency by polymer.

Phenol-4PO-20EO was selected as an optimal surface active agent for improved-polymer flooding at 368 K for the heavy oil studied in this research. The IFT between the selected surface active agent solution and heavy oil was measured to be 0.39 dynes/cm at 368 K. This is substantially lower than the value, 11 dynes/cm, for oil and 0.1 wt % NaCl brine at 368 K.

The selection of an optimal surface active agent can be done in a systematic manner as demonstrated with phenol-xPO-yEO in this example. This non-ionic surface active agent was made by the alkoxylation of phenol, a chemical that shows a high level of affinity for the heavy oil studied in this research. Then, the optimal ranges of EO and PO numbers were found at reservoir conditions in terms of temperature and brine salinity.

The improved polymer flooding resulted in 84% oil recovery after 2 PV injection. It was 54% more recovery than water flooding and 22% more recovery than polymer flooding. The polymer flooding improved the oil recovery efficiency by increasing the water viscosity. The polymer flooding was improved by the addition of 2 wt % phenol-4PO-20EO, which reduced the IFT between the displacing and the displaced phases.

The results suggest a new opportunity of enhanced heavy oil recovery by adding a slug of one multi-functional surface active agent with cosolvent character to conventional polymer flooding. The injection solution was composed of one non-ionic ultra-short hydrophobe surface active agent and one polymer without any alkali, surfactants, and cosolvents. Depending on the cost of the base solvent (e.g. phenol in this research), the cost of ultra-short hydrophobe surface active agents can be lower than conventionally used surfactants for ASP and SP. The ultra-short hydrophobe surface active agents may also be used as an additive that improves water flooding in low-permeability reservoirs.

Chemicals

2-EH=2-ethylhexanol; IBA=isobutanol; KOH=potassium hydroxide; NaCl=sodium chloride; HPAM=hydrolyzed polyacrylamide;

### Units

bbl=barrel; cp=centipoise; g=gram; K=Kelvin; lbm=pound-mass; USD=U.S. dollar; vol=volume; wt=weight

### Abbreviations

ACP=alkali-cosolvent-polymer; ASP=alkali-surfactant-polymer; CMC=critical micelle concentration; EO=ethylene oxide; IFT=interfacial tension; o/w=oil-in-water emulsions; OOIP=original oil in place; PO=propylene oxide; PVI=pore volumes of injection; SARA=saturates, aromatics, resins, and asphaltenes; SP=surfactant-polymer; WOR=water-oil-ratio.

### Example 2: Bitumen Emulsification with TETA-x[EO]-y[PO]

The phase behavior of triethylenetetramine (TETA) compounds including TETA, TETA-5[PO], TETA-7.5[PO], TETA-10[PO], TETA-10[EO]-10[PO], and TETA-10[EO]-15[PO] were studied: TETA-x[EO]-y[PO] compounds may exhibit three properties: alkali properties due to TETA, co-solvent properties due to [EO], and surfactant properties due to [PO].

Phase Behavior Studies: Compositions comprising the (TETA) compounds were prepared having a water to oil ratio of 7:3; sampling volume of 4 mL; NaCl brine; and aged at 95° C. as shown in Table 4 below. Bitumen emulsification properties were evaluated and results are shown in Table 4.

TABLE 4
Bitumen Emulsification with TETA-x[EO]-y[PO]

| Salinity | TETA (wt %) | | | TETA-5[PO] (wt %) | | | TETA-7.5[PO] (wt %) | | |
|---|---|---|---|---|---|---|---|---|---|
| (ppm) | 0.5 | 1 | 2 | 0.5 | 1 | 2 | 0.5 | 1 | 2 |
| 0 | o/w | o/w | | o/w | o/w | o/w | | | o/w |
| 1,000 | o/w | M | M | o/w | o/w | M | | o/w | o/w |
| 5,000 | o/w | o/w | o/w | o/w | o/w | M | o/w | M | M |
| 10,000 | | | | o/w | o/w | M | o/w | o/w | o/w |
| 20,000 | | | | | o/w | o/w | | | |
| 30,000 | | | | | | | | | |

| | | | | TETA-10[EO]-10[PO] | | | TETA-10[EO]-15[PO] | | |
|---|---|---|---|---|---|---|---|---|---|
| Salinity | TETA-5[PO] (wt %) | | | (wt %) | | | (wt %)\ | | |
| (ppm) | 0.5 | 1 | 2 | 0.5 | 1 | 2 | 0.5 | 1 | 2 |
| 0 | | o/w | o/w | | | | | | |
| 1,000 | | o/w | o/w | | | | | | |
| 5,000 | | o/w | o/w | | | | | | |
| 10,000 | | | o/w | | | o/w | | | |
| 20,000 | | | | | | | | | |
| 30,000 | | | | | | | | | |

o/w—oil in water emulsion
M—oil in water microemulsion

Na₂CO₃ as an additional alkali: Bitumen compositions comprising the (TETA) compounds and 1.0 wt % Na₂CO₃ were prepared having a water to oil ratio of 7:3; sampling volume of 4 mL; NaCl brine; and aged at 95° C. as shown in Table 5 below. Bitumen emulsification properties were evaluated and results are shown in Table 5.

TABLE 5
TETA-10[EO]-10[PO] with 1.0 wt % Na₂CO₃

| Salinity | 0.5 wt % TETA- | 1.0 wt % TETA- | 2.0 wt % TETA- |
|---|---|---|---|
| (ppm) | 10[EO]-10[PO] | 10[EO]-10[PO] | 10[EO]-10[PO] |
| 0 | M | M | M |
| 5,000 | M | M | M |
| 10,000 | o/w | o/w | M |
| 15,000 | o/w | o/w | o/w |
| 20,000 | o/w | o/w | o/w |

Na₂CO₃ had a positive effect on creating oil-in-water microemulsions. Oil-in-water emulsions were created even at higher salinities.

Aqueous Stability Tests (1000 and 10,000 ppm NaCl brine): Bitumen compositions comprising the (TETA) compounds and 1.0 wt % Na₂CO₃ at various salinity concentrations were prepared having a water to oil ratio of 7:3; sampling volume of 4 mL; NaCl brine; and aged at 95° C. as shown in Table 6 below. Bitumen emulsification properties were evaluated and results are shown in Table 6. The number of phases formed are indicated by 1 (single phase) or 2 (phase separation).

TABLE 6
TETA-x[EO]-y[PO] with 1.0 wt % Na₂CO₃

| | | 1,000 ppm | | | | | 10,000 ppm | | | | |
|---|---|---|---|---|---|---|---|---|---|---|---|
| Temperature | Salinity | 0.5 | 1.0 | 2.0 | 5.0 | 10.0 | 0.5 | 1.0 | 2.0 | 5.0 | 10.0 |

TETA-5[PO] (wt %)

| | | | | | | | | | | | |
|---|---|---|---|---|---|---|---|---|---|---|---|
| 55° C. | No. of phase | 1 | 1 | 1 | 1 | 1 | 1 | 1 | 1 | 1 | 1 |
| | Transparency | Yes | Yes | Yes | Yes | Yes | Yes | Yes | Yes | Yes | Yes |
| 80° C. | No. of phase | 1 | 1 | 1 | 1 | 1 | 1 | 1 | 1 | 1 | 1 |
| | Transparency | Yes | Yes | Yes | Yes | Yes | Yes | Yes | Yes | Yes | Yes |
| 95° C. | No. of phase | 1 | 1 | 1 | 1 | 1 | 1 | 1 | 1 | 1 | 1 |
| | Transparency | Yes | Yes | Yes | Yes | Yes | Yes | Yes | Yes | Yes | Yes |

TETA-10[PO] (wt %)

| | | | | | | | | | | | |
|---|---|---|---|---|---|---|---|---|---|---|---|
| 55° C. | No. of phase | 1 | 1 | 1 | 1 | 1 | 1 | 1 | 1 | 1 | 1 |
| | Transparency | Yes | Yes | Yes | No | No | Yes | Yes | Yes | No | No |
| 80° C. | No. of phase | 1 | 1 | 1 | 2 | 2 | 1 | 1 | 2 | 2 | 2 |
| | Transparency | Yes | Yes | No | Clear | Clear | Yes | Yes | No | Yes | Yes |
| 95° C. | No. of phase | 1 | 1 | 2 | 2 | 2 | 1 | 1 | 2 | 2 | 2 |
| | Transparency | Yes | No | No | Clear | Clear | Yes | No | No | Yes | Yes |

TETA-10[EO]-10[PO] (wt %)

| | | | | | | | | | | | |
|---|---|---|---|---|---|---|---|---|---|---|---|
| 55° C. | No. of phase | 1 | 1 | 1 | 1 | 1 | 1 | 1 | 1 | 1 | 1 |
| | Transparency | Yes | Yes | No | No | No | Yes | Yes | No | No | No |
| 80° C. | No. of phase | 1 | 1 | 1 | 1 | 2 | 1 | 1 | 1 | 1 | 2 |
| | Transparency | Yes | Yes | No | No | No | Yes | Yes | No | No | No |
| 95° C. | No. of phase | 1 | 1 | 1 | 1 | 1 | 1 | 1 | 1 | 1 | 1 |
| | Transparency | Yes | Yes | No | No | No | Yes | Yes | No | No | No |

TETA-10[EO]-15[PO] (wt %)

| | | | | | | | | | | | |
|---|---|---|---|---|---|---|---|---|---|---|---|
| 55° C. | No. of phase | 1 | 1 | 1 | 1 | 1 | 1 | 1 | 1 | 1 | 1 |
| | Transparency | Yes | Yes | No | No | No | Yes | Yes | No | No | No |
| 80° C. | No. of phase | 1 | 1 | 1 | 2 | 2 | 1 | 1 | 2 | 2 | 2 |
| | Transparency | Yes | Yes | No | Yes | Yes | Yes | Yes | No | Yes | Yes |
| 95° C. | No. of phase | 1 | 1 | 1 | 2 | 2 | 1 | 1 | 2 | 2 | 2 |
| | Transparency | Yes | Yes | No | Yes | Yes | Yes | Yes | Yes | Yes | Yes |

### Example 3: Bitumen Emulsification with Phenol-x[PO]-y[EO]

The phase behavior of several phenol compounds including Phenol-4[PO]-5 [EO] and Phenol-7[PO]-15[EO] was studied. Phenol-x[PO]-y[EO] compounds may exhibit two properties: co-solvent properties and surfactant properties.

Phase Behavior Studies: Bitumen compositions comprising the phenol compounds were prepared having a water to oil ratio of 7:3; sampling volume of 4 mL; NaCl brine; and aged at 95° C. as shown in Table 7 below. The pH measurement of 4 wt % Phenol-4[PO]-5[EO] in aqueous phase was determined to be 11.06 and the pH measurement of 4 wt % Phenol-7[PO]-15[EO] in aqueous phase was determined to be 9.83.

TABLE 7
Bitumen Emulsification with Phenol-x[PO]-y[EO]]

| | 0.5 wt % | 1.0 wt % | 2.0 wt % | 0.5 wt % | 1.0 wt % | 2.0 wt % |
|---|---|---|---|---|---|---|
| | Phenol- | Phenol- | Phenol- | Phenol- | Phenol- | Phenol- |
| Salinity | 4[PO]- | 4[PO]- | 4[PO]- | 7[PO]- | 7[PO]- | 7[PO]- |
| (ppm) | 5[EO] | 5[EO] | 5[EO] | 15[EO] | 15[EO] | 15[EO] |
| z | z | z | z | z | z | z |
| 0 | | | M | M | M | M |
| 1,000 | | | M | M | M | M |
| 5,000 | | | | o/w | o/w | o/w |
| 10,000 | | | | | | |
| 15,000 | | | | | | |
| 20,000 | | | | | | |

o/w—oil in water emulsion
M—oil in water microemulsion

Na₂CO₃ as an additional alkali: Bitumen compositions comprising the phenol compounds and Na₂CO₃ were prepared having a water to oil ratio of 7:3; sampling volume of 4 mL; and aged at 95° C. No brine was present in the mixture. Bitumen emulsification properties were evaluated and results are shown in Table 8 below.

TABLE 8
2.0 wt % Phenol-7[PO]-15[EO] with Na₂CO₃

| Na₂CO₃ (ppm) | 2.0 wt % Phenol-7[PO]-15[EO] |
|---|---|
| 0 | M |
| 1,000 | M |
| 5,000 | M |
| 10,000 | M |
| 20,000 | o/w |
| 30,000 | o/w |

o/w—oil in water emulsion
M—oil in water microemulsion

Na₂CO₃ had a positive effect on creating oil-in-water microemulsions. Oil-in-water emulsions were created even at higher salinities.

Effect of Ca2⁺ on phase behavior: Compositions comprising the phenol compounds, 0.3 wt % CaCl₂, and NaCl brine were prepared having a water to oil (bitumen) ratio of 7:3; sampling volume of 4 mL; and aged at 95° C. Bitumen emulsification properties were evaluated and results are shown in Table 9 below.

TABLE 9
Emulsification with Phenol-7[PO]-15[EO] with 0.3 wt % CaCl₂

| Salinity | 0.5 wt % Phenol- | 1.0 wt % Phenol- | 2.0 wt % Phenol- |
|---|---|---|---|
| (ppm) | 7[PO]-15[EO] | 7[PO]-15[EO] | 7[PO]-15[EO] |
| 0 | o/w | o/w | o/w |
| 1,000 | o/w | o/w | o/w |
| 5,000 | | | o/w |
| 10,000 | | | |
| 15,000 | | | |

o/w—oil in water emulsion
M—oil in water microemulsion

Ca²⁺ had a negative effect on creating oil-in-water microemulsions. Oil-in-water emulsions separated very quickly after adding CaCl₂.

Microemulsion Flow at 25° C. and 80° C.: Compositions comprising the phenol compounds were prepared and evaluated for microemulsion flow at various temperatures as follow. Two control compositions comprising water to oil ratio of 7:3 (water-bitumen) and 1,000 ppm NaCl brine were prepared. Two sample compositions comprising water to oil ratio of 7:3 (water-bitumen); 1,000 ppm NaCl brine; and 1.0 wt % Phenol-7[PO]-15[EO] were prepared.

Results: At 25° C., the oil viscosity of the control was 447,000 cp, which did not flow. At 80° C., the oil viscosity of the control was 690 cp, which also did not flow.

At 25° C. and 80° C., the sample compositions formed a single phase oil-in-water microemulsion formed. The oil-in-water emulsions flowed very well at room temperature and at 80° C.

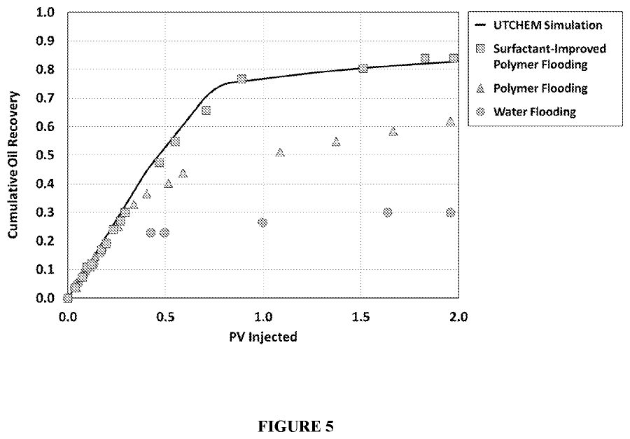

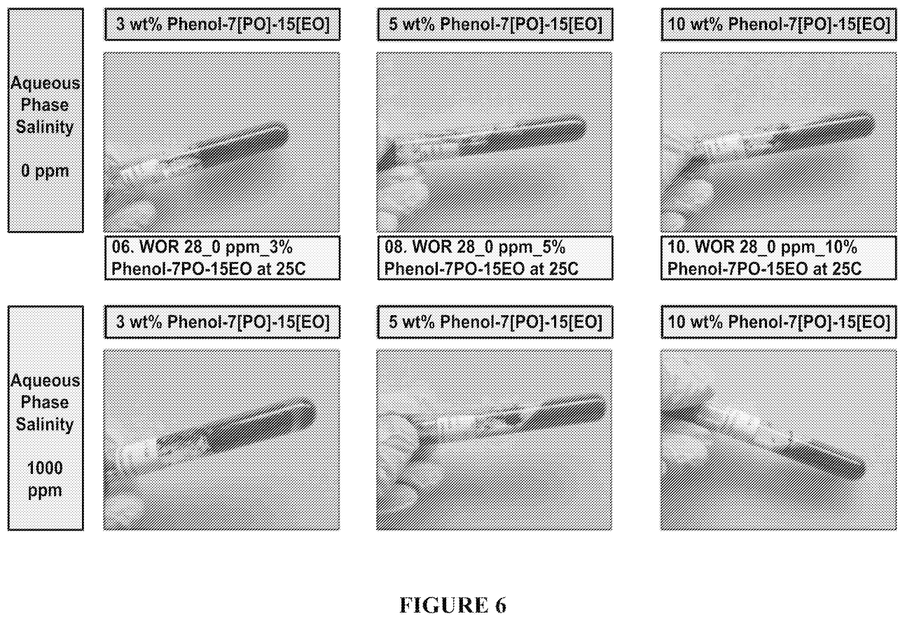

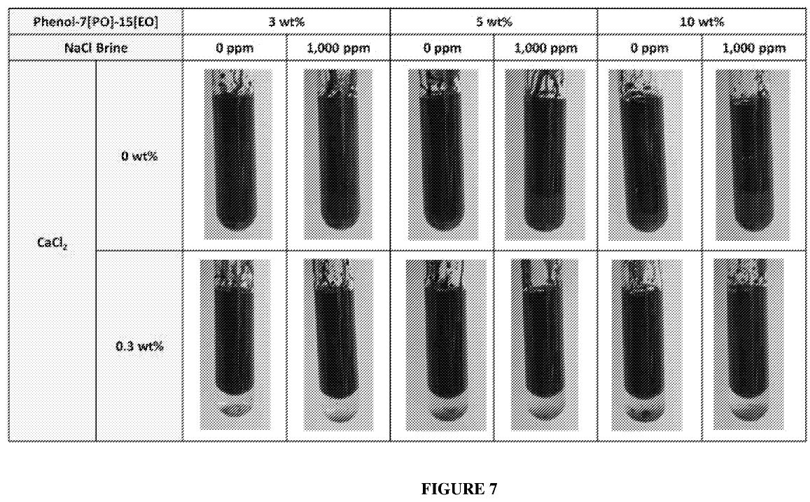

Bitumen Transport: The ability of the phenol compounds to effect faster bitumen transport in pipeline was investigated. Portions of aqueous solutions (phenol-7[PO]-15[EO] at 3 wt %, 5 wt %, and 10 wt %) were added to bitumen at a water to oil ratio of 2:8. Separation of the aqueous phase from bitumen was investigated by adding a small amount of CaCl₂. The results of bitumen transport are summarized in Table 10 below and FIGS. 6 and 7.

TABLE 10
Bitumen Transport

| | 3 wt % Phenol- | 5 wt % Phenol- | 10 wt % Phenol- |
|---|---|---|---|
| Salinity | 7[PO]-15[EO] | 7[PO]-15[EO] | 7[PO]-15[EO] |
| 0 | M | M | M |
| 1,000 | M | M | M |

o/w—oil in water emulsion
M—oil in water microemulsion

The aqueous solutions comprising phenol compounds may reduce the viscosity of bitumen and enhance bitumen transport in a pipeline. After bitumen transport, the aqueous phase can be effectively separated from bitumen by adding a small amount of CaCl₂.

Aqueous Stability Tests (1000 and 10,000 ppm NaCl brine): Compositions comprising the phenol-7[PO]-15[EO] compound at various salinity concentrations were prepared having a water to oil (bitumen) ratio of 7:3; sampling volume of 4 mL; NaCl brine; and aged at 95° C. Bitumen emulsification properties were evaluated and results are shown in Table 11. The number of phases formed are indicated by 1 (single phase) or 2 (phase separation).

TABLE 11
Phenol-7[PO]-15[EO]

| | Salinity | | | | | | | | | | |
|---|---|---|---|---|---|---|---|---|---|---|---|
| | Phenol-7[PO]- | 1,000 ppm NaCl | | | | | 10,000 ppm NaCl | | | | |
| Temperature | 15[EO] (wt %) | 0.5 | 1.0 | 2.0 | 5.0 | 10.0 | 0.5 | 1.0 | 2.0 | 5.0 | 10.0 |
| 55° C. | No. of phase | 1 | 1 | 1 | 1 | 1 | 1 | 1 | 1 | 1 | 1 |
| | Transparency | Yes | Yes | Yes | Yes | Yes | Yes | Yes | Yes | Yes | Yes |
| 80° C. | No. of phase | 1 | 1 | 1 | 1 | 1 | 2 | 2 | 2 | 2 | 2 |
| | Transparency | Yes | Yes | Yes | Yes | Yes | Yes | Yes | Yes | Yes | Yes |
| 95° C. | No. of phase | 2 | 2 | 2 | 2 | 2 | 2 | 2 | 2 | 2 | 2 |
| | Transparency | No | No | No | No | No | No | No | No | No | No |

### Example 4: Bitumen Emulsification with 2EH-x[PO]-y[EO]

Phase Behavior Studies: The phase behavior of ethylhexyl (EH) compounds including 2EH-2[PO]-5[EO] was studied. Compositions comprising 2EH-2[PO]-5[EO] were prepared having a water to oil (bitumen) ratio of 7:3; sampling volume of 4 mL; NaCl brine; and aged at 95° C. as shown in Table 12 below.

TABLE 12
Bitumen Emulsification with 2EH-2[PO]-5[EO]

| Salinity (ppm) | 2.0 wt % 2EH-2[PO]-5[EO] |
|---|---|
| 0 | M |
| 1,000 | M |

o/w—oil in water emulsion
M—oil in water microemulsion

### Example 5: Methods of Using Short Hydrophobe Surfactants and Surfactant Blends

Phase Behavior Studies: The phase behavior of short hydrophobe compounds were studied in various hydrocarbon mixtures. Compositions comprising the short hydrophobe compounds were prepared in hydrocarbon mixtures as shown in Table 13 below. The phase behavior results are reported in Table 13.

TABLE 13
Hydrocarbon Emulsification with short hydrophobe surfactants

| | Hydrocarbon | % of NaCl | | | | | | | | | |
|---|---|---|---|---|---|---|---|---|---|---|---|
| Hydrophobe | mixture | 1% | 2% | 3% | 4% | 5% | 6% | 7% | 8% | 9% | 10% |
| MeO-21PO- | Pentane | X | O | O | O | O | O | O | O | O | O |
| 10EO-SO₄ | Octane | X | X | X | X | O | O | O | O | O | O |
| | Tetradecane | O | O | X | X | X | O | O | O | O | O |
| Phenol- | Pentane | X | X | X | X | X | X | X | X | X | X |
| 30PO-20EO | Octane | X | X | X | X | X | X | X | X | X | X |
| | Tetradecane | X | X | X | X | X | X | O | O | O | O |
| 2EH-7PO- | Pentane | O | O | O | O | O | X | X | O | O | O |
| SO₄ | Octane | X | X | X | X | X | X | X | X | O | O |
| | Tetradecane | O | O | O | O | X | X | X | X | X | X |
| TDA-7PO- | Pentane | O | O | O | O | O | O | O | O | O | O |
| SO4 | Octane | X | X | X | X | O | O | O | O | O | O |
| | Tetradecane | O | O | O | O | O | O | O | X | X | O |
| C₁₈-7PO-SO₄ | Pentane | O | O | O | O | O | O | O | O | O | O |
| | Octane | O | O | O | O | O | O | O | O | O | O |
| | Tetradecane | O | O | O | O | O | X | O | O | O | O |
| C1₁₋₁₂-ABS | Pentane | O | O | O | O | O | O | O | O | O | O |
| | Octane | O | O | O | O | O | O | O | O | O | O |
| | Tetradecane | X | X | O | O | O | O | O | O | O | O |
| C₁₅₋₁₈-IOS | Pentane | O | O | O | O | O | O | O | O | O | O |
| | Octane | O | O | O | O | O | O | O | O | O | O |
| | Tetradecane | X | X | O | O | O | O | O | O | O | O |
| C₁₉₋₂₃-IOS | Pentane | O | O | O | O | O | O | O | O | O | O |
| | Octane | O | O | O | O | O | O | O | O | O | O |
| | Tetradecane | O | O | O | O | O | O | O | O | O | O |
| MeO-21PO- | C₅, C₆, C₇, C₈, | X | X | X | X | X | X | X | O | O | O |
| 10EO-SO₄ | C₁₀, C₁₂, C₁₄ | | | | | | | | | | |
| 2EH-7PO- | C₅, C₆, C₇, C₈, | X | X | X | X | X | X | X | X | O | O |
| SO₄ | C₁₀, C₁₂, C₁₄ | | | | | | | | | | |
| TDA-7PO- | C₅, C₆, C₇, C₈, | X | X | X | X | X | O | O | O | O | O |
| SO₄ | C₁₀, C₁₂, C₁₄ | | | | | | | | | | |
| C₁₈-7PO-SO₄ | C₅, C₆, C₇, C₈, | O | O | O | O | O | O | O | O | O | O |
| | C₁₀, C₁₂, C₁₄ | | | | | | | | | | |
| MeO-21PO- | C₅, C₆, C₇, C₈, | X | X | X | X | X | O | O | O | O | O |
| 10EO-SO₄ + | C₁₀, C₁₂, C₁₄ | | | | | | | | | | |
| TDA-7PO- | | | | | | | | | | | |
| SO₄ | | | | | | | | | | | |

C₁₈-7PO-SO₄—C18 stands for oleyl. X stands for good phase behavior (low to ultralow IFT). O stands for poor phase behavior.

Summary: The data surprisingly indicated that use of short hydrophobe surfactants demonstrated preferential interaction with lower hydrocarbons. This allows the surfactants disclosed herein to address components of the oil that were not able to be addressed by conventional hydrophobe surfactants. There may be a correlation between the carbon chain length of the surfactant and the hydrocarbon chain length, such that smaller carbon chain length surfactants can be used to address lower hydrocarbons in the oil, and longer carbon chain length surfactants can be used to address higher hydrocarbons in the oil. This would enable a surfactant blend, comprising surfactants of the invention and conventional surfactants, to be developed to address the specific hydrocarbon makeup of a target oil fraction.

In the attached data, C₁₋₈ stands for oleyl. Because of the bent double bond, it behaves as a >28 carbon hydrophobe.

### Example 6: Very Short Hydrophobe Surfactants and Surfactant Blends

Phase Behavior Studies: Very short hydrophobe C1-C8 surfactants were prepared. The surfactants had the formula C₁-C₈-xPO-yEO-z, wherein z is H, sulfate, or carboxylate. Other classes of surfactants prepared include amine polyalkoxylates (N(x(EO)/y(PO))₃); trimethylol propane alkoxylates (CH₃CH₂C(CH₂O-xPO/yEO)₃); and polyamine alkoxylates (e.g., TETA alkoxylates).

FIG. 8 shows a bulk foam study of a blend of 0.5% C₁₄-C₁₆ AOS and 0.5% CH₃O-60PO-20EO-SO₃Na prepared and mixed with crude oil. Bulk foam study was conducted at 60° C.

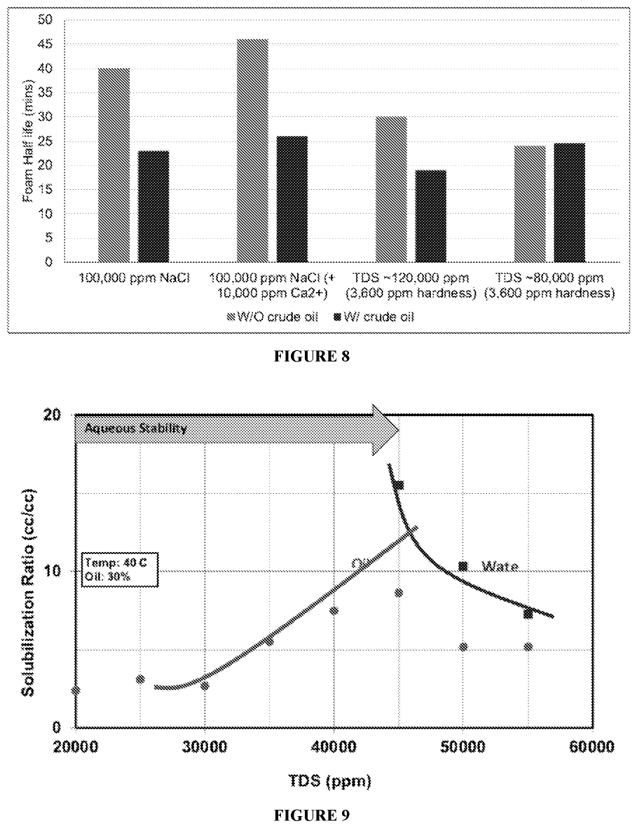

FIG. 9 shows a phase behavior of a blend of 0.5% C₁₉-C₂₃ IOS and 0.5% CH₃O-21PO-10EO-SO₃ prepared and mixed with 30% oil. Phase behavior study was conducted at 40° C.

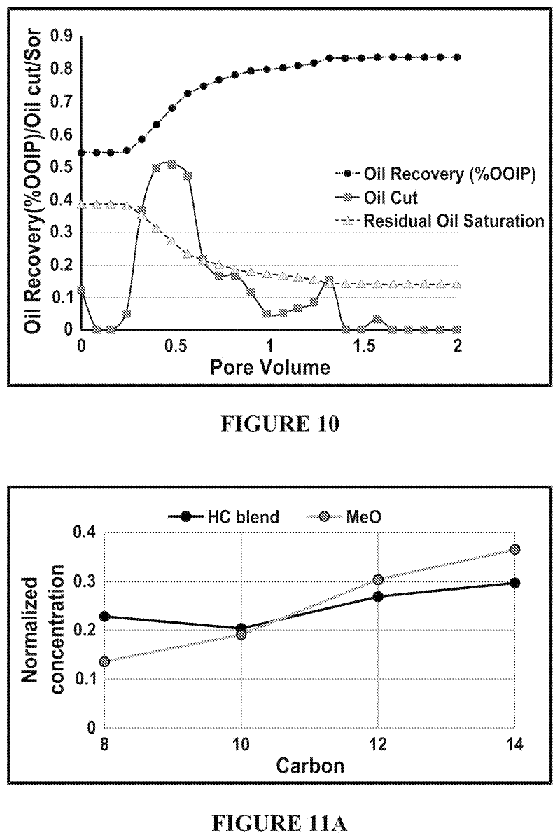

FIG. 10 shows a core flood study of a blend of 0.5% C₁₉-C₂₃ IOS and 0.5% CH₃O-21PO-10EO-SO₃ prepared and mixed with SP core flood. Slug Injection: SP/ASP slug comprised 0.3 pore volume of 0.5% C₁₉-C₂₃ IOS, 0.5% CH₃O-21PO-10EO-SO₃, 4.5 wt % NaCl, and 3500 ppm FP 330S. Polymer drive comprised of 2 pore volume 2.5 wt % NaCl and 3500 ppm FP 3330S. Core properties: SP coreflood; Berea Sandstone core; 3.7×29.6 length (cm); 21.0% porosity; 220 permeability (md).

FIGS. 11A-11C show GC-MS analysis of hydrocarbon fraction of surfactants or surfactant blends in brine and hydrocarbon blend at ambient temperature. The surfactants tested included C₁₃-7PO-SO⁻₃ (TDA), CH₃O-21PO-10EO-SO⁻₃ (MeO), and TDA+MeO in a 1:1 blend. The hydrocarbon blend composition comprised pf C₅, C₆, C₇, C₈, C₁₀, C₁₂, C₁₄ equimolar composition. Hydrocarbon blend samples were analyzed from the lowest tension tubes by GC-MS. C₅-C₇ GC-MS results were discarded as unreliable. Only C₈, C₁₀, C₁₂, C₁₄ data were analyzed.

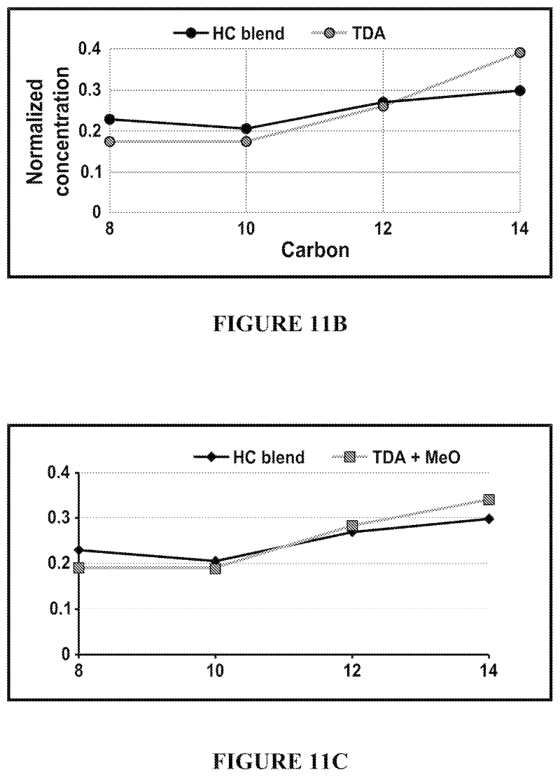

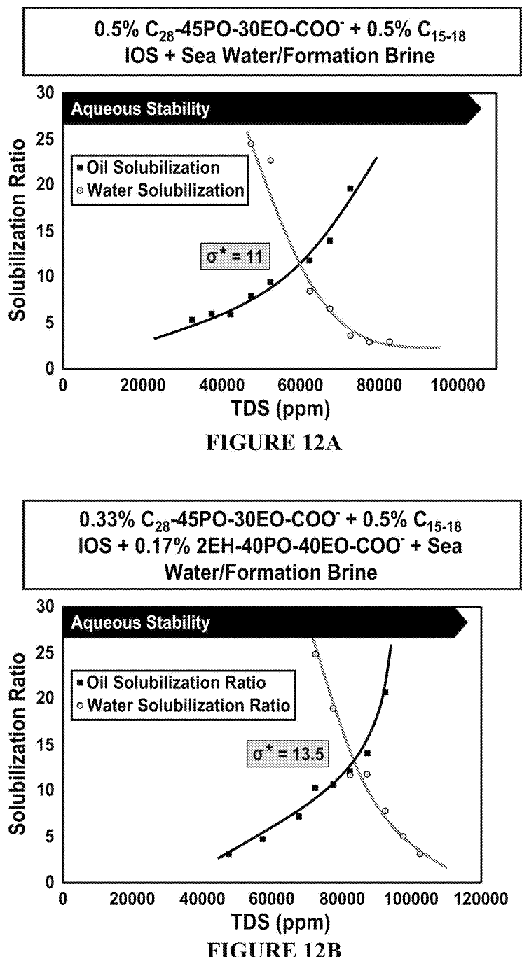

FIGS. 12A-12B show aqueous stability and phase behavior of a three component surfactant blend in hard brine at 80° C. FIG. 12A shows the aqueous stability of 0.5% C₁₅-C₁₈ IOS, 0.5% C₂₈-45PO-30EO-COO⁻ in sea water/formation brine. FIG. 12B shows the aqueous stability of 0.5% C₁₅-C₁₈ IOS, 0.33% C₂₈-45PO-30EO-COO⁻, and 0.17% 2EH-40PO-40EO-COO⁻ in sea water/formation brine.

Surfactant blends: sulfonates may be produced separately as IOS or ABS. Suitable sulfonates include C₈-C₃₀ for IOS and C₄-C₂₄ for ABS. The two alkoxy anionic compounds can be produced together with little streamlining of the PO and EO levels. Replacement of a large hydrophobe surfactant with a very short hydrophobe surfactant leads to a dual cost advantage (lower alcohol pricing and lower MW). Sulfonate and carboxylate are chemically stable functional groups. Sulfate functional groups can be chemically stabilized under the right conditions.

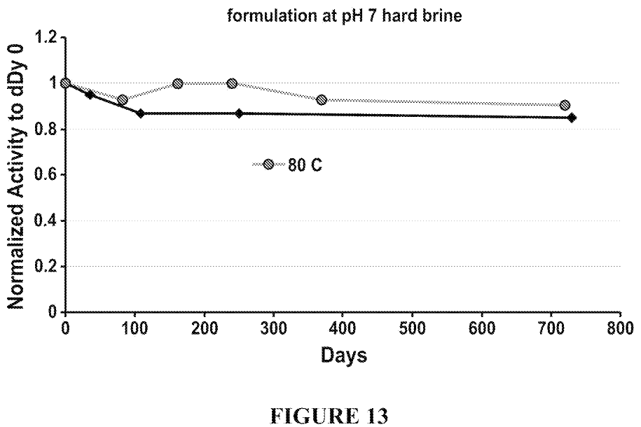

FIG. 13 shows stability formulations with hard brine. Formulation at 80° C. includes 0.3% C₁₅-C₁₈ IOS, 0.2% C₁₉-C₂₃IOS, 0.5% IBA-2EO, 0.5% C₁₈-35PO-30EO-SO₄ in brine (500 ppm Ca²⁺, 1250 ppm Mg²⁺, 58000 TDS. Formulation at 100° C. includes 0.5% C₁₉-C₂₃ IOS, 0.5% TDA-45PO-20EO-SO₄, 0.5% Phenol-2EO in brine (500 ppm Ca²⁺, 1250 ppm Mg²⁺, 28000 TDS.

### Example 7: Surfactants and Co-Solvents for Chemical Enhanced Oil Recovery

A large amount of oil is left unrecovered from oil reservoirs after primary and secondary floods due to various reasons. Among these factors, high capillary forces (between oil and water) are largely responsible for trapping of oil in the porous media. Surfactants that can lower the interfacial tension with oil have traditionally been studied to improve the oil recovery. Studies have shown that a significant improvement in oil recovery can be achieved by injecting suitable surfactants in the reservoir. However, traditionally used surfactants suffer from severe limitations due to their limited applicability in a high salinity/hardness and a high temperature environment. These surfactants tend to be unstable (not soluble) under these conditions and therefore cannot be used for improving the oil recovery. Novel surfactants that are stable under a high salinity/hardness/temperature environment would expand the applicability of surfactant EOR to such reservoirs. In addition to an ultralow interfacial tension, a favorable microemulsion rheology is critical in lowering the surfactant requirement. Co-solvents have shown to lower the microemulsion viscosity, lower surfactant retention and improve the oil recovery (Jang et al., 2016). Alkali co-solvent polymer (ACP) floods have been developed recently for acidic crude oils (Fortenberry, 2015), employing in-situ generated Naphthenic soap as the surfactant. Improved co-solvents are critical in the success of the above mentioned processes.

Background: A surfactant is a surface-active compound that can lower the interfacial tension between two phases by acting as the bridge between the interfaces. A surfactant consists of a hydrophilic head (which prefers the aqueous phase) and a lipophilic tail (which prefers an organic or gas phase). The hydrophilic-lipophilic balance (HLB) determines the solubility of surfactants in aqueous or organic phases. Anionic surfactants have been used for surfactant floods because these surfactants have shown to lower the interfacial tension with oil-brine system to ultralow values (10-3 dynes/cm). Traditionally used anionic surfactants include alkyl benzene sulfonates (ABS), alpha olefin sulfonates (AOS), internal olefin sulfonates (IOS) and alcohol sulfates. These surfactants show limited stability at high temperature/salinity/hardness environment. In addition, these surfactants are not suitable for crude oils with high equivalent alkane carbon numbers (EACN). Large hydrophobe alcohol alkoxy carboxylates and alcohol alkoxy sulfates, having a large degree of ethoxylation and propoxylation, were therefore developed (Adkins et al., 2012; Lu, 2013). Co-solvents are low molecular weight alcohols and ethoxylates (typically C3 to C6) that are used for improving the surfactant phase behavior by lowering the equilibration time and microemulsion viscosity. Commonly used co-solvents include isobutyl alcohol (IBA), isopropyl alcohol (IPA), triethylene glycol monobutyl ether (TEGBE). Co-solvents containing ethylene oxide (EO) and propylene oxide (PO) have recently been developed (Upamali et al., 2016).

The surfactants and co-solvents described above are obtained from alcohols containing C3-C32 carbon chain (see appendix for structures). Since the alcohol is a key component of these compounds, their production is limited by the availability of such alcohols as raw materials. In addition, these alcohols add to the production cost of surfactants and co-solvents.

In this example, describe are classes of surfactants and co-solvents which do not require these alcohols as a raw material. We instead use methanol, a much cheaper and versatile alcohol. The surfactants and co-solvents of the invention do not contain a ‘hard’ hydrophobe, unlike the previously developed compounds, and are therefore likely to show lower retention in the porous media during oil recovery floods.

These surfactants and co-solvents do not contain a “hard” hydrophobe. “Hard” hydrophobe is defined here as a compound that show no compatibility with water. An example of such a hydrophobe include CH₃(CH₂)ₙOH where n is generally >9. The new compounds are instead derived from methanol and have a large degree of propoxylation and ethoxylation. PO chain is very compatible with oil and somewhat compatible with water. EO chain is very compatible with water and somewhat compatible with oil. Moreover, since the “hard” hydrophobe is missing in these compounds they are likely to show lower surfactant adsorption on rock surfaces compared to traditional surfactants. The structures of surfactants and co-solvents developed in this invention are given below. When the compounds have fewer PO units, the compound acts as a solvent. In these structures, preferably x=1-100, preferably 1-5 when acting as a solvent, and preferably y=0-250.

CH₃O-xPO-yEO-Y (where Y=H, Sulfate, Carboxylate); CH₃N (xPO-yEO)₂; (CH₃)₂N(xPOyEO); (CH₃)₃N(+)(xPO-yEO)Z(−) where Z=Cl(−) as in Cationics, CH₂CO₂ (−) as in Zwitterionics (Betaine), CH₂CHOHCH₂SO₃ (−) as in Zwitter ionic Hydroxy Sultaines or Sultaines

CH₃CH₂C(CH₂O-xPOyEO)₃ from TMP(Trimethylol Propane) as Polyol Alkoxylates, Sulfates (preferably formed from SO3, Chlorosulfonic or Sulfamic acid), carboxylates (preferably formed from alkali and Na Chloroacetate).

PPG(Polypropyleneglycols) or hydrophobic Pluronics (and reverse Pluronics) mono- and/or difunctionalized into sulfates/carboxylates

N(xPO-yEO)₃, CH₃N(xPO-yEO)₂, (CH₃)₂N(xPO-yEO)(as in Amine polyalkoxylates, Cationics, Betaines, Sultaines, Switchable surfactants(SS) via Protonation)

NH₂CH₂CH₂NHCH₂CH₂NHCH₂CH₂NH₂(TETA) Alkoxylates, Cationics, Betaines, Sultaines, Switchable Surfactants(SS)

PO can be replaced in part or fully by Butylene Oxide(BO) in any structure

Many, if not all, of these molecules can be used in by themselves or in conjunction with other detergent type surfactants in different cleaning applications which include detergency, industrial cleaning, foaming, hard surface cleaning, hard water applications, etc.

Extensions: Polyhydroxy molecules such as alkyl polyglucosides (Butyl, for example), starches (for example CMC), cyclodextrins, etc. can be included in the transformations of the present example. Alkyl group can vary from one carbon to five carbons, in addition to Phenyl groups. Positive interactions with acrylamide polymers and co-polymers should be envisaged. The amine based surfactants could be buffered to a pH of 10 or less for hard brine environments to prevent divalent ion precipitation as Hydroxides. In soft brine, the pH >11 of the amine functionality can be used advantageously in alkaline formulations. The polyhydroxy molecules should interact positively with Bio-polymers based on Poly saccharides.

Applications: CEOR applications as in alkali surfactant polymer (ASP) floods, alkali co-solvent polymer (ACP) floods, surfactant polymer(SP) floods, Wettability alteration, Foam Applications, Steam Assisted Gravity Drainage (SAGD), hot water injection, Low Salinity floods, Injectivity enhancement, Emulsion Breakers, Formulations without polymers for low permeability rocks, foam applications (including using CO₂ as gas) for Switchable Surfactants(SS), shale, lower surfactant rock adsorption, Water-in-gas (including CO₂) emulsions, enhanced imbibition.

Results:

(a) CH₃-x(PO)-y(EO)-Surfactants and Co-Solvents

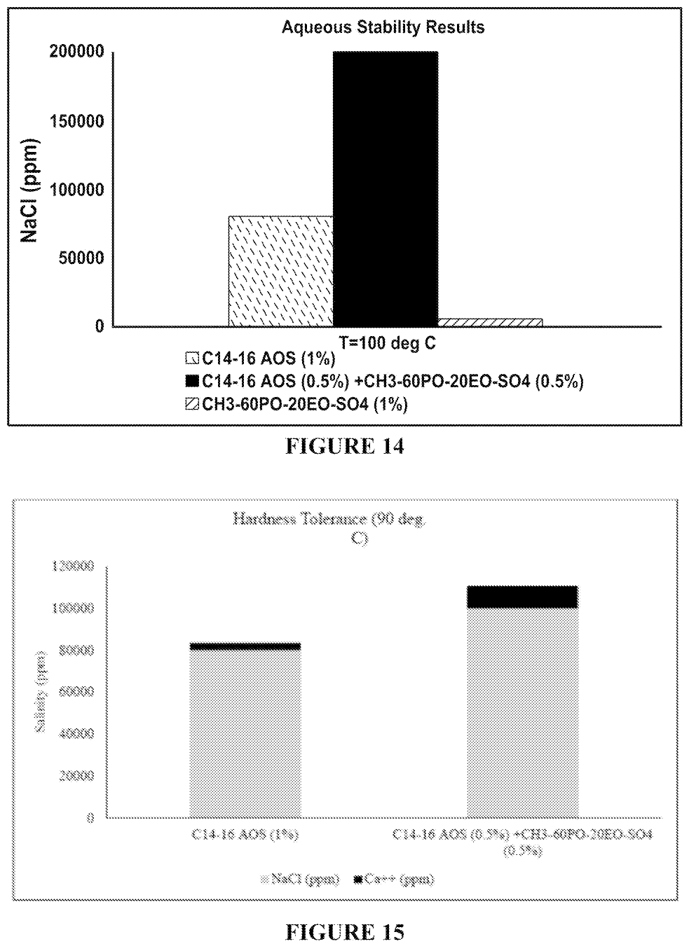

Aqueous Stability Results: The aqueous stability results using CH₃-60PO-15EO-SO₄ and CH₃-60PO-20EO-SO₄ are presented in this section. The surfactant CH₃-60PO-20EO-SO₄ of a lower solubility in water by itself. However, synergy with internal olefin sulfonate (IOS) and alpha olefin sulfonate (AOS) surfactants have been observed. FIG. 14 shows the synergistic effect of C14-16 AOS (C14-16 AOS) with CH₃-60PO-20EOSO₄ on aqueous stability. The blend of C14-16 AOS with CH₃-60PO-20EO-SO₄ showed much higher aqueous stability compared to the aqueous stabilities of the individual surfactants. Similar results were obtained for the mixture of CH₃-x(PO)-y(EO)-SO₄ surfactants with IOS/AOS surfactants. FIG. 15 shows the hardness tolerance for different surfactant blends with the novel surfactants. On addition of these surfactants to C14-16 AOS, significant increase in hardness tolerance was observed, thus more suitable for application at harsh reservoir conditions. C14-16 AOS by itself was stable up to 3600 ppm calcium. The blend of C14-16 AOS with CH₃-60PO-20EO-SO₄ was stable up to a calcium concentration of 10,800 ppm.

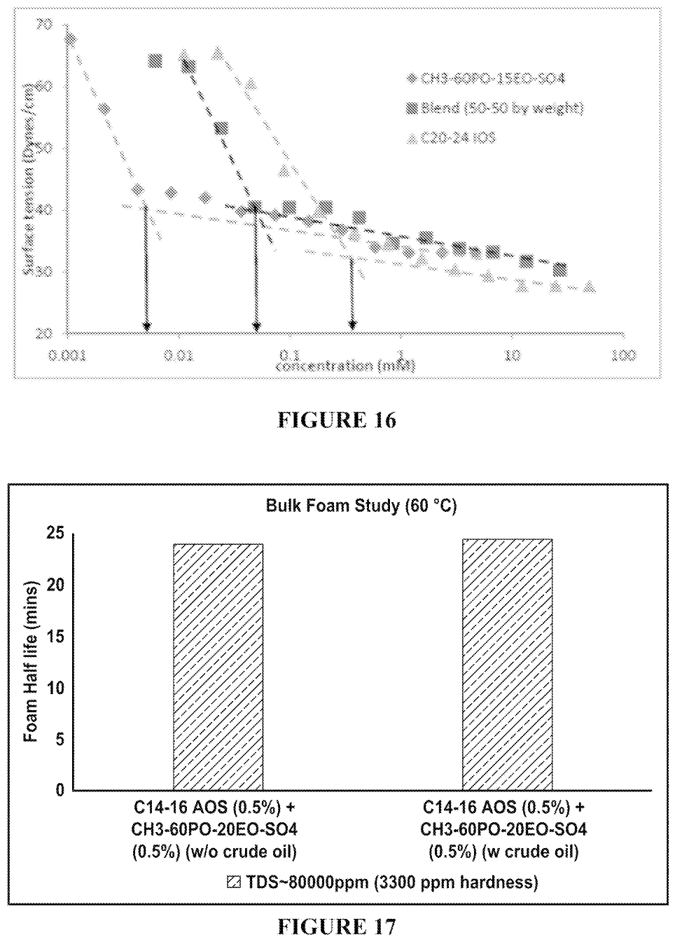

Surface tension measurements: Surface tension of CH₃-x(PO)-y(EO)-SO₄ surfactants were measured. The results of CH₃-60PO-15EO-SO₄, C20-24 IOS and the blend of two surfactants (equal amounts in mass) are shown in FIG. 16. A lowering of surface tension was observed in the presence of CH₃-60PO-15EO-SO₄. The critical micelle concentration (CMC) of about 0.008 mM was obtained for this surfactant and the surface tension was lowered to about 30 dynes/cm. C20-24 IOS, on the other hand, gave a CMC value of about 0.4 mM and lowered the surface tension to about 27 dynes/cm. The blend of two surfactants showed a much lower CMC than C20-24 IOS and lowered the surface tension to about 30 dynes/cm.

Bulk Foam Stability Results: C14-16 AOS, a commonly used foaming surfactant, showed good foaming up to the salinity of 80,000 ppm at 100 deg C. However, poor aqueous stability was observed above 80,000 ppm and therefore this surfactant cannot be used at higher salinities at 100 C.

For foam applications, bulk foam studies were performed to qualitatively estimate the foaming ability and foam stability of the different surfactant formulations. Equal amounts of oil and aqueous solutions were used. Results showed that at reduced salinity levels (<80000 ppm) C14-16 AOS is a good foaming surfactant but showed significant reduction in foam half-life in presence of crude oil. At elevated salinities (>=100000 ppm), C14-16 AOS in synergy with CH₃-x(PO)-y(EO)-SO₄ surfactants showed good foaming abilities and aqueous stability. We also noticed no negative impact of crude oil on foam half-life with surfactants containing CH₃-x(PO)-y(EO)-SO₄ which shows that this surfactant blend has better compatibility with crude oil compared to C14-16 AOS by itself. FIG. 17 shows the summary of bulk foam stability tests performed at 60 C.

Studies have shown detrimental impact of crude oil on foam half-life at varying salinity conditions and varying temperatures. But the above results show that the half-life remains the same with and without crude oil. We also found that the CH₃-x(PO)-y(EO)-SO₄ surfactants do not show a negative impact on foam stability on increasing hardness. Foam half-life in presence of hardness seems to be almost similar to the ones without hardness (Calcium, Magnesium ions). This is very promising for foam application in brines containing high levels of hardness. The hardness tolerance for C14-16 AOS was found to be significantly lower than the blend containing CH₃-x(PO)-y(EO)-SO₄.

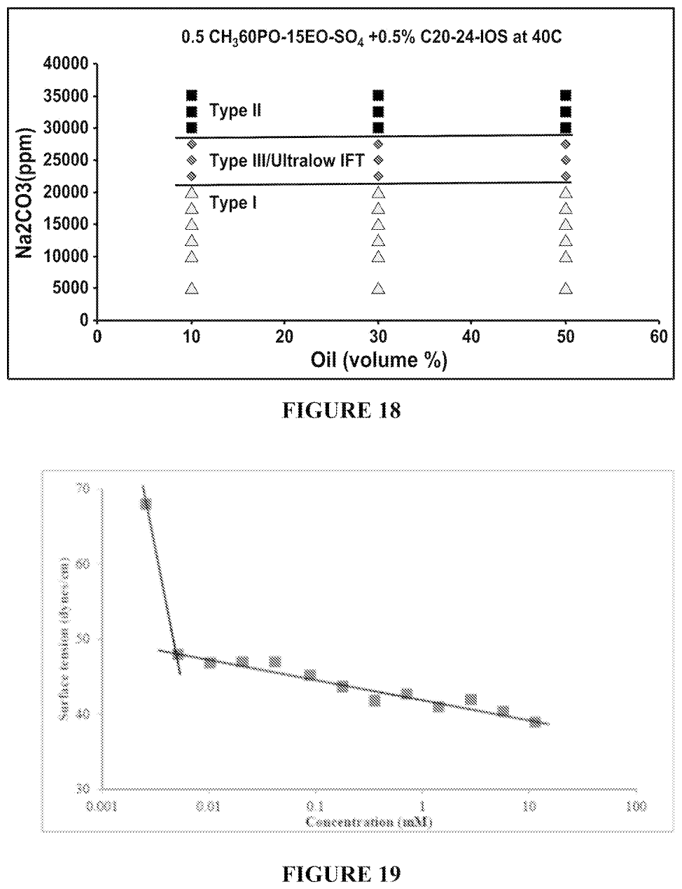

Alkali surfactant phase (ASP) behavior with inactive crude oil(no in-situ soap generation): Surfactant phase behavior experiments were performed for developing ASP floods using the blend of CH₃-x(PO)-y(EO)-SO₄ surfactant with IOS surfactants. The results shown below were obtained with a blend of 0.5% CH₃-60(PO)-15(EO)-SO₄ and 0.5% C20-24 IOS, and an inactive crude oil of 5 cP at 40 C. Sodium carbonate was used as the alkali in these scans. FIG. 18 shows the ultralow IFT region using this formulation for 10%, 30% and 50% oil (by volume). Ultralow IFT was observed between 2.25-2.75% NaCO₃ in these formulations. The formulation was found to be aqueous stable at these conditions. A typical Winsor type phase behavior can be observed from the surfactant phase behavior tubes. Surfactant polymer (SP) formulation was similarly developed for the same crude oil using the same surfactant blend. The optimum salinity for this formulation was found to be about 2.5% NaCl. Alkali co-solvent polymer (ACP) formulations were also developed using CH₃-2(PO) and an acidic crude oil (total acid number ˜2.0 mg/g oil) at 40 C. A salinity scan from 0-4% was performed using sodium carbonate and the oil volume fraction was fixed to 30%. Ultralow IFT region was observed between 1-1.5% Na₂CO₃.

(b) Amino-n(PO) Surfactants/Co-Solvents

Aqueous stability: Aqueous stability experiments were performed for Amino-n(PO) surfactants. 1 wt % surfactant was added to DI water and equilibrated at various temperatures. The surfactant solution was found to be aqueous stable up to 30 POs at room temperature. However, in acidic conditions, the surfactant solutions containing up to 75 POs were found to be aqueous stable in DI water.

Surface tension measurement: Surface tension measurements were performed by using up to 2 wt % Amino-30PO surfactant. The results, FIG. 19, shows the lowering of surface tension of water using this surfactant. The CMC for the surfactant was found to be about 0.008 mM, and the surface tension lowered to about 38 dynes/cm.

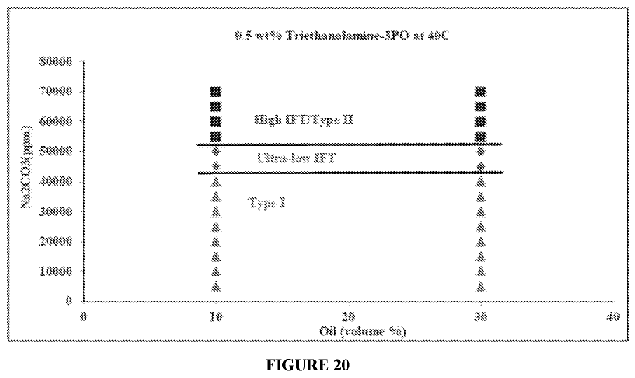

Alkali co-solvent phase behavior with acidic crude oil: ACP formulations were developed using Amino-3(PO) co-solvent and an acidic crude oil at 40 C. In these experiments, the co-solvent concentration was fixed to 1 wt % and salinity scan was performed using sodium carbonate. The oil-to-water ratio was changed from 10% to 30%. The phase behavior results are shown in FIG. 20. Ultralow IFT was observed between 4.5-5% Na₂CO₃ using this co-solvent. These results are favorable because a steep positive slope is usually observed if a suitable co-solvent is not added. A less steep or flat slope is favorable because it helps in effectively designing an ACP flood. In addition, a low microemulsion viscosity was observed in these formulations.

Similar experiments were performed with TETA-5PO and TMP-3PO as co-solvents. The ultralow IFT regions for the respective co-solvents were found to be between 1-1.5% Na₂CO₃ and about 2% Na₂CO₃.

High salinity high temperature foam applications: crude oil has destabilizing effect on foam and significantly reduces the effectiveness of the process. Decreased efficiency of foam floods in an oil wet or intermediate wet porous media have been observed compared to a water wet media due to foam oil interactions.

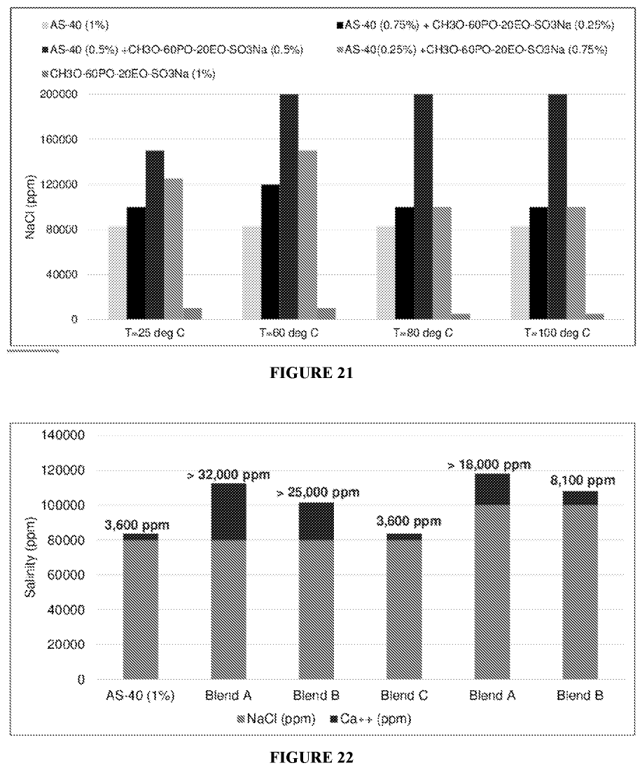

FIG. 21 shows aqueous stability results in foam applications using the blends of CH₃-x(PO)-y(EO)-SO₄ surfactant with AOS surfactants. Good synergy between the AOS and CH₃-x(PO)-y(EO)-SO₄ surfactants were observed. Enhanced solubility at high temperatures was also observed. Table 14 shows the surfactant formulations.

TABLE 14
Surfactant formulation

| | | | Viscosity (cp) at |
|---|---|---|---|
| Surfactant | Formulation | HLB | 25° C. |
| Blend A | 0.5% C₁₄-C₁₆ AOS + 0.5% | 6.714 | 1.12 |
| | CH₃O-60PO-20EO-SO₃Na | | |
| Blend A | 0.5% C₁₄-C₁₆ AOS + 0.5% | 6.655 | 1.15 |
| | CH₃O-60PO-15EO-SO₃Na | | |
| Blend A | 0.5% C₁₄-C₁₆ AOS + 0.5% | 5.921 | 1.25 |
| | CH₃O-21PO-SO₃Na | | |
| AS-40 | 1% C₁₄-C₁₆ AOS | 6.867 | 2.0 |

FIG. 22 shows the hardness tolerance of blends of CH₃-x(PO)-y(EO)-SO₄ surfactant with AOS surfactants at 90° C. Lower critical hardness was observed foR AS-40. Increased critical hardness was observed Blends A and B.

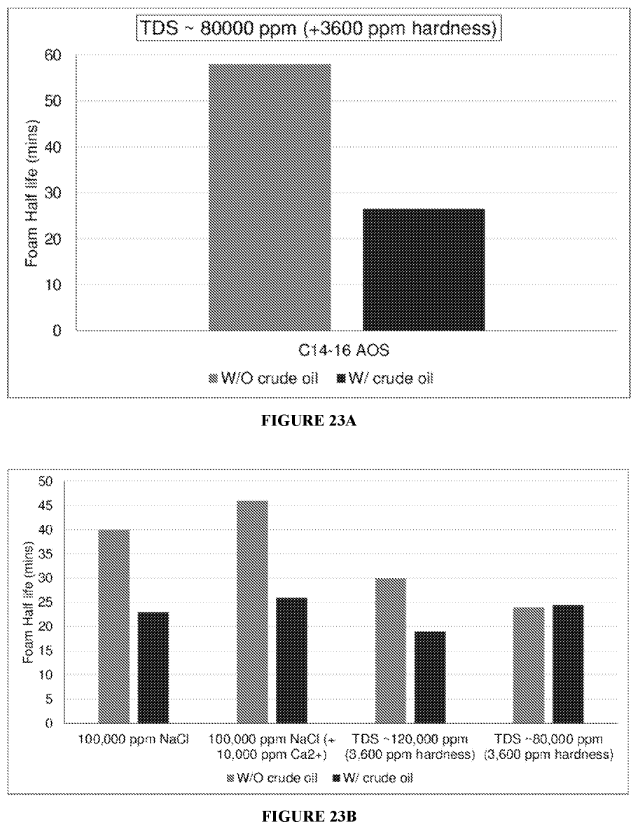

FIGS. 23A and 23B show bulk foam study of blends of CH₃-x(PO)-y(EO)-SO₄ surfactant with AOS surfactants at 90° C. Higher critical salinity was observed for Blend A. Detromental effect on foam half-life at high salinity observed for AS-40.

Phase Behavior Procedures

Phase Behavior Screening: Phase behavior studies have been used to characterize chemicals for EOR. There are many benefits in using phase behavior as a screening method. Phase Behavior studies are used to determine, measure or observe characteristics related to chemical performance such as the following examples but are not limited to these examples: (1) the effect of electrolytes; (2) oil solubilization and IFT reduction, (3) microemulsion densities; (4) microemulsion viscosities; (5) coalescence times; (6) optimal surfactant-cosolvent formulations; and/or (7) optimal properties for recovering oil from cores and reservoirs.

Thermodynamically stable phases can form with oil, water and surfactant mixtures. Surfactants form micellar structures at concentrations at or above the critical micelle concentration (CMC). The emulsion coalesces into a separate phase at the oil-water interface and is referred to as a microemulsion. A microemulsion is a surfactant-rich distinct phase consisting of surfactant, oil and water and possibly cosolvents and other components. This phase is thermodynamically stable in the sense that it will return to the same phase volume at a given temperature. Some workers in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (surfactant, alcohol, electrolyte), oil, which is sometimes characterized by its equivalent alkane carbon number (EACN), and surfactant structure, which is sometimes characterized by its hydrophilic-lipophilic balance (HLB). The phase transition was first characterized by Winsor (1954) into three regions: Type I-excess oleic phase, Type III-aqueous, microemulsion and oleic phases, and the Type II-excess aqueous phase. The phase transition boundaries and some common terminology are described as follows: Type I to III-lower critical salinity, Type III to II-upper critical salinity, oil solubilization ratio (V_{O}/V_{S}), water solubilization ratio (V_{W}/V_{S}), the solubilization value where the oil and water solubilization ratios are equal is called the Optimum Solubilization Ratio (σ*), and the electrolyte concentration where the optimum solubilization ratio occurs is referred to as the Optimal Salinity (S*).

Determining Interfacial Tension

Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization as shown by the Chun Huh theory. This is equated to an interfacial tension through the Chun Huh equation, where IFT varies with the inverse square of the solubilization ratio:

$$γ = \frac{C}{{σ}^{2}}$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult and time consuming to measure and is subject to larger errors, so using the phase behavior approach to screen hundreds of combinations of surfactants, surfactants, cosolvents, electrolytes, oil, and so forth is not only simpler and faster, but avoids the measurement problems and errors associated with measuring IFT especially of combinations that show complex behavior (gels and so forth) and will be screened out anyway. Once a good formulation has been identified, then it is still a good idea to measure IFT.

Equipment

Phase behavior experiments are created with the following materials and equipment.

Mass Balance: Mass balances are used to measure chemicals for mixtures and determine initial saturation values of cores.

Water Deionizer: Deionized (DI) water is prepared for use with all the experimental solutions using a Nanopure™ filter system. This filter uses a recirculation pump and monitors the water resistivity to indicate when the ions have been removed. Water is passed through a 0.45 micron filter to eliminate undesired particles and microorganisms prior to use.

Borosilicate Pipettes: Standard 5 mL borosilicate pipettes with 0.1 mL markings are used to create phase behavior scans as well as run dilution experiments with aqueous solutions. Ends are sealed using a propane and oxygen flame.

Pipette Repeater: An Eppendorf Repeater Plus™ instrument is used for most of the pipetting. This is a handheld dispenser calibrated to deliver between 25 microliter and 1 ml increments. Disposable tips are used to avoid contamination between stocks and allow for ease of operation and consistency.

Propane-oxygen Torch: A mixture of propane and oxygen gas is directed through a Bemz-O— Matic flame nozzle to create a hot flame about ½ inch long. This torch is used to flame-seal the glass pipettes used in phase behavior experiments.

Convection Ovens: Several convection ovens are used to incubate the phase behaviors and core flood experiments at the reservoir temperatures. The phase behavior pipettes are primarily kept in Blue M and Memmert ovens that are monitored with mercury thermometers and oven temperature gauges to ensure temperature fluctuations are kept at a minimal between recordings. A large custom built flow oven was used to house most of the core flood experiments and enabled fluid injection and collection to be done at reservoir temperature.

pH Meter: An ORION research model 701/digital ion analyzer with a pH electrode is used to measure the pH of most aqueous samples to obtain more accurate readings. This is calibrated with 4.0, 7.0 and 10.0 pH solutions. For rough measurements of pH, indicator papers are used with several drops of the sampled fluid.

Phase Behavior Calculations

The oil and water solubilization ratios are calculated from interface measurements taken from phase behavior pipettes. These interfaces are recorded over time as the mixtures approached equilibrium and the volume of any macroemulsions that initially formed decreased or disappeared.

Phase Behavior Methodology

The methods for creating, measuring and recording observations are described in this section. Scans are made using a variety of electrolyte mixtures described below. Oil is added to most aqueous surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples. Phase behavior samples are made by first preparing surfactant stock solutions and combining them with brine stock solutions in order to observe the behavior of the mixtures over a range of salinities. All the experiments are created at or above 0.1 wt % active surfactant concentration, which is above the typical CMC of the surfactant.

Solution Preparation. Surfactant stocks are based on active weight-percent surfactant (and surfactant when incorporated). The masses of surfactant, surfactant, cosolvent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Surfactant Stock. The chemicals being tested are first mixed in a concentrated stock solution that usually consisted of a primary surfactant, cosolvent and/or surfactant along with de-ionized water. The quantity of chemical added is calculated based on activity and measured by weight percent of total solution. Initial experiments are at about 1-3% active surfactant so that the volume of the middle microemulsion phase would be large enough for accurate measurements assuming a solubilization ratio of at least 10 at optimum salinity.

Polymer Stock. Often these stocks were quite viscous and made pipetting difficult so they are diluted with de-ionized water accordingly to improve ease of handling. Mixtures with polymer are made only for those surfactant formulations that showed good behavior and merited additional study for possible testing in core floods. Consequently, scans including polymer are limited since they are done only as a final evaluation of compatibility with the surfactant.

Pipetting Procedure. Phase behavior components are added volumetrically into 5 ml pipettes using an Eppendorf Repeater Plus or similar pipetting instrument. Surfactant and brine stocks are mixed with DI water into labeled pipettes and brought to temperature before agitation. Almost all of the phase behavior experiments are initially created with a water oil ratio (WOR) of 1:1, which involves mixing 2 ml of the aqueous phase with 2 ml of the evaluated crude oil or hydrocarbon, and different WOR experiments are mixed accordingly. The typical phase behavior scan consisted of 10-pipettes, each pipette being recognized as a data point in the series.

Order of Addition. Consideration must be given to the addition of the components since the concentrations are often several folds greater than the final concentration. Therefore, an order is established to prevent any adverse effects resulting from surfactant or polymer coming into direct contact with the concentrated electrolytes. The desired sample compositions are made by combining the stocks in the following order: (1) Electrolyte stock(s); (2) De-ionized water; (3) Surfactant stock; (4) Polymer stock; and (5) Crude oil or hydrocarbon. Any air bubbles trapped in the bottom of the pipettes are tapped out (prior to the addition of surfactant to avoid bubbles from forming).

Initial Observations. Once the components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing. The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times to provide adequate mixing. Tubes are observed for low tension upon mixing by looking at droplet size and how uniform the mixture appeared. Then the solutions are allowed to equilibrate over time and interface levels are recorded to determine equilibration time and surfactant performance.

Measurements and Observations. Phase behavior experiments are allowed to equilibrate in an oven that is set to the reservoir temperature for the crude oil being tested. The fluid levels in the pipettes are recorded periodically and the trend in the phase behavior observed over time. Equilibrium behavior is assumed when fluid levels ceased to change within the margin of error for reading the samples.

Fluid Interfaces. The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly. Measurements are taken thereafter at increasing time intervals (for example, one day, four days, one week, two weeks, one month and so on) until equilibrium is reached or the experiment is deemed unessential or uninteresting for continued observation.

### APPENDICES

Using the general methods described above, the phase behavior of several EOR formulations containing compounds of Formula I, II, VIII, or IX with bitumen were determined. The resulting phase behavior of the compounds with bitumen are shown in Appendices I through III.

These results demonstrate that the compounds of Formula I, II, VIII, or IX can be used in EOR formulations to impart many beneficial properties generally afforded by surfactants, cosolvents, and/or alkali agents. For example, the compounds of Formula I, II, VIII, or IX can impart lower microemulsion viscosity while also decreasing interfacial tension. Thus, the compounds of Formula I, II, VIII, or IX described herein can be incorporated into EOR formulations to improve equilibration, increase solubilization ratio, provide a broad low interfacial tension region, decrease microemulsion viscosity, and combinations thereof. As the compounds described herein can perform the various roles of surfactant, cosolvent, and/or alkali agent in EOR formulations, the compounds described herein can be used to prepare EOR formulations with lower amounts of surfactant, cosolvent, or alkali agent (or even EOR formulations that are substantially free from surfactant, cosolvent, or alkali agent).

The compounds, compositions, and methods of the appended claims are not limited in scope by the specific compounds, compositions, and methods described herein, which are intended as illustrations of a few aspects of the claims. Any compounds, compositions, and methods that are functionally equivalent are intended to fall within the scope of the claims. Various modifications of the compounds, compositions, and methods in addition to those shown and described herein are intended to fall within the scope of the appended claims. Further, while only certain representative compounds, compositions, and method steps disclosed herein are specifically described, other combinations of the compounds, compositions, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

1. An aqueous composition comprising a compound having a structure of Formula I, 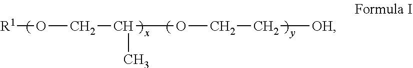
wherein
R¹ is unsubstituted C₆-C₁₀ alkyl or unsubstituted phenyl;
x is an integer from 2 to 10;
y is an integer from 3 to 60.

2. The composition of claim 1, wherein R¹ is branched or linear unsubstituted C₆-C₁₀ alkyl.

3. The composition of claim 1, wherein R¹ is branched unsubstituted C₈ alkyl.

4. The composition of claim 2, wherein x is from 2 to 7.

5. The composition of claim 2, wherein y is from 3 to 30.

6. The composition of claim 1, wherein R¹ is unsubstituted phenyl.

7. The composition of claim 6, wherein x is from 2 to 8.

8. The composition of claim 6, wherein y is from 5 to 20.

9. The composition of claim 1, wherein y is greater than x.

10. The composition of claim 1, wherein the sum of x and y (x+y) is from 5 to 30.

11. An aqueous composition comprising a compound having a structure of Formula II, 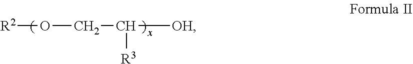
wherein
R² is a substituted or unsubstituted C₄-C₂₀ polyalkylamine,
R³, for each occurrence, is independently hydrogen or methyl; and
n is an integer from 2 to 60.

12. The composition of claim 11, wherein the compound of Formula II has a structure of Formula IIa, 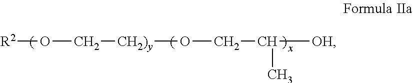
wherein
R² is a substituted or unsubstituted C₄-C₂₀ polyalkylamine;
x is an integer from 2 to 20;
y is an integer from 0 to 15; and
wherein x is greater than y.

13. The composition of claim 11, wherein R² is unsubstituted C₄-C₁₆ polyalkylamine selected from a C₄-C₁₆ polyalkylenediamine, a C₄-C₁₆ polyalkylenetriamine, a C₄-C₁₆ polyalkylenetetramine, or a C₄-C₁₆ polyalkylenepentamine, preferably a diisopropylamine, di-ethylenetriamine, tri-ethylenetetramine, tetra-ethylenepentamine, di-propylenetriamine, tri-propylenetetramine, or tetra-propylenepentamine.

14. (canceled)

15. (canceled)

16. (canceled)

17. (canceled)

18. The composition of claim 11, x and y are in a ratio of from 1.5:1 to 5:1.

19. The composition of claim 11, wherein the sum of x and y (x+y) is from 2 to 35.

20. The composition of claim 1, wherein the compound is present in the composition in an amount of from 0.05% to 6% by weight, based on the total weight of the composition.

21. (canceled)

22. (canceled)

23. The composition of claim 1, wherein the composition comprises an anionic surfactant selected from the group consisting of branched alcohol ethoxylates and/or propoxylates, capped alcohol ethoxylates and/or propoxylates, branched Guerbet alcohol comprising ethoxylate and/or propoxylate groups, alkoxy carboxylate surfactants, alkoxy sulfate surfactants, alkoxy sulfonate surfactants, alkyl sulfonate surfactants, aryl sulfonate surfactants, olefin sulfonate surfactants, and combinations thereof.

24. The composition of claim 23, wherein the surfactant is present in the composition in an amount of from 0.05% to 2% by weight, based on the total weight of the composition.

25. The composition of claim 1, wherein the composition comprises a surfactant selected from a C₁₀-C₃₀ internal olefin sulfonate (IOS), a C₁₀-C₃₀ alpha olefin sulfonate (AOS), or a C₈-C₃₀ alkyl benzene sulfonate (ABS),
an alkoxy carboxylate surfactant defined by Formula II or Formula III 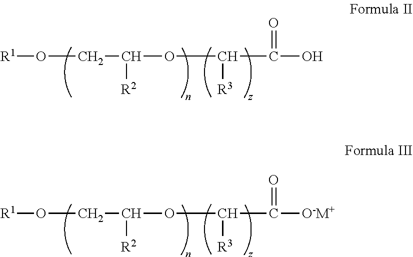
wherein
R¹ substituted or unsubstituted C₈-C₁₅₀ alkyl or substituted or unsubstituted aryl;
R² is independently hydrogen or unsubstituted C₁-C₆ alkyl;
R³ is independently hydrogen or unsubstituted C₁-C₆ alkyl;
n is an integer from 2 to 210;
z is an integer from 1 to 6; and
M⁺ is a cation,
an alkoxy sulfate surfactant defined by the formula below 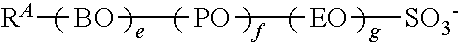
or acid or salt thereof, wherein
R^{A} is C₈-C₃₆ alkyl group;
BO represents —CH₂—CH(ethyl)-O—;
PO represents —CH₂—CH(methyl)-O—;
EO represents —CH₂—CH₂—O—; and
e, f and g are each independently integers from 0 to 50, with the proviso that at least one of e, f and g is not zero, or
an alkoxy sulfate surfactant defined Formula V 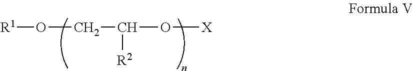
wherein
R¹ is an R⁴-substituted or unsubstituted C₈-C₂₀ alkyl group, an R³-substituted or unsubstituted aryl group, or an R³-substituted or unsubstituted cycloalkyl group;
R² is independently hydrogen or methyl;
R³ is independently an R⁴-substituted or unsubstituted C₁-C₁₅ alkyl, an R⁴-substituted or unsubstituted aryl group, or an R⁴-substituted or unsubstituted cycloalkyl group;
R⁴ is independently an unsubstituted aryl group or an unsubstituted cycloalkyl group;
n is an integer from 25 to 115;
X is —CH₂C(O)O⁻M⁺, —CH₂C(O)OH; and
M⁺ is a cation.

26. (canceled)

27. (canceled)

28. (canceled)

29. The composition of claim 1, wherein the composition further comprises a cosolvent, an alkali agent, a viscosity enhancing polymer, a gas or a foam, a chelating agent, or a combination thereof.

30. (canceled)

31. (canceled)

32. (canceled)

33. (canceled)

34. (canceled)

35. (canceled)

36. (canceled)

37. The composition of claim 1, wherein the composition has a pH of from 9 to 12.

38. An emulsion composition comprising a hydrocarbon material and a composition of claim 1.

39. The emulsion composition of claim 38, wherein the emulsion comprises a microemulsion.

40. The emulsion composition of claim 38, wherein the hydrocarbon material is unrefined petroleum in a petroleum reservoir, heavy crude oil, bitumen, or nonactive oil.

41. (canceled)

42. (canceled)

43. (canceled)

44. The emulsion composition of claim 38, wherein the hydrocarbon material has a viscosity of 500 cp or greater.

45. The emulsion composition of claim 38, wherein the hydrocarbon material has a viscosity of 1,000 cp or less.

46. The emulsion composition of claim 38, wherein the hydrocarbon material has an acid number from 2 to 10 mg-KOH/g-oil.

47. The emulsion composition of claim 38, wherein the hydrocarbon material has a density of 750 kg/m³ or greater or an API gravity of 20° or less.

48. (canceled)
